(19) United States
(12) Patent Application Publication
(10) Pub. No.: US 2009/0228301 A1
(43) Pub. Date: Sep. 10, 2009

(54) Insurance plan design, reporting and analysis of healthcare data using global filters

(76) Inventors: Ernest T. Youngblood, Knoxville, TN (US); Kathleen O. Youngblood, Knoxville, TN (US); Jeffrey D. Miller, Knoxville, TN (US); James D. Miller, Knoxville, TN (US)

Correspondence Address: LUEDEKA, NEELY & GRAHAM, P.C., P O BOX 1871, KNOXVILLE, TN, 37901, US

(21) Appl. No.: 12/321,986

(22) Filed: Jan. 28, 2009

Related U.S. Application Data
(60) Provisional application No. 61/024,107, filed on Jan. 28, 2008.
(60) Provisional application No. 61/092,945, filed on Aug. 29, 2008.

(51) Int. Cl. G06Q 50/00

(52) U.S. Cl. 705/3

(57) ABSTRACT

The present disclosure provides a health care data analysis apparatus for accessing, analyzing, planning, and filtering health care data of a population of people to be covered by an insurance plan, said data including claims and enrollment data, for applying one or more health care plans to the data and for generating reports via a report generator indicating the effects of the one or more health care plans based on the data.

### CROSS REFERENCE TO RELATED APPLICATIONS

This application claims priority to U.S. Provisional Application No. 61/024,107, filed Jan. 28, 2008, and U.S. Provisional Application No. 61/092,945, filed Jan. 29, 2008.

### FIELD OF THE INVENTION

The field of invention relates to healthcare insurance, and particularly to designing and comparing different insurance plans and providing analysis of the plans.

### Computer Program Listing Appendix

The present disclosure also includes as an appendix two (2) copies of a CD-ROM containing computer executable object code listings for the discrete program modules of the apparatus described herein. The two CD-ROMs are exactly the same, and are finalized so that no further writing is possible. The CD-ROMs are compatible with IBM PC/XT/AT-compatible computers running the Windows Operating System. Both CD-ROMs contain the following files:

| Filename | Size (Bytes) | Date Created |
|---|---|---|
| DevExpress.BonusSkins.v8.3.dll.txt | 16,155,200 | 1/28/2009 10:15 |
| DevExpress.Charts.v8.3.Core.dll.txt | 233,600 | 1/28/2009 10:15 |
| DevExpress.Data.v8.3.dll.txt | 2,036,800 | 1/28/2009 10:15 |
| DevExpress.OfficeSkins.v8.3.dll.txt | 5,768,000 | 1/28/2009 10:15 |
| DevExpress.Utils.v8.3.dll.txt | 12,496,000 | 1/28/2009 10:15 |
| DevExpress.Wpf.Carousel.v8.3.dll.VisualStudio.Design.dll.txt | 16,000 | 1/28/2009 10:15 |
| DevExpress.Wpf.Charts.v8.3.dll.VisualStudio.Design.dll.txt | 16,000 | 1/28/2009 10:15 |
| DevExpress.Wpf.Grid.v8.3.dll.VisualStudio.Design.dll.txt | 16,000 | 1/28/2009 10:15 |
| DevExpress.Wpf.NavBar.v8.3.dll.VisualStudio.Design.dll.txt | 16,000 | 1/28/2009 10:15 |
| DevExpress.XmasSkins.dll.txt | 1,932,800 | 1/28/2009 10:15 |
| DevExpress.XtraBars.v8.3.dll.txt | 5,179,200 | 1/28/2009 10:15 |
| DevExpress.XtraCharts.v8.3.dll.txt | 18,380,800 | 1/28/2009 10:15 |
| DevExpress.XtraEditors.v8.3.dll.txt | 4,713,600 | 1/28/2009 10:15 |
| DevExpress.XtraGrid.v8.3.dll.txt | 5,017,600 | 1/28/2009 10:15 |
| DevExpress.XtraLayout.v8.3.dll.txt | 2,036,800 | 1/28/2009 10:15 |
| DevExpress.XtraNavBar.v8.3.dll.txt | 902,400 | 1/28/2009 10:15 |
| DevExpress.XtraPivotGrid.v8.3.Core.dll.txt | 1,360,000 | 1/28/2009 10:15 |
| DevExpress.XtraPivotGrid.v8.3.dll.txt | 1,153,600 | 1/28/2009 10:15 |
| DevExpress.XtraPrinting.v8.3.dll.txt | 4,724,800 | 1/28/2009 10:15 |
| DevExpress.XtraReports.v8.3.dll.txt | 8,750,400 | 1/28/2009 10:15 |
| DevExpress.XtraTreeList.v8.3.dll.txt | 1,801,600 | 1/28/2009 10:15 |
| edtFTPnetEx.dll.txt | 1,996,800 | 1/28/2009 10:15 |
| mia.lib.txt | 1,809,862 | 1/28/2009 10:15 |
| Microsoft.ApplicationBlocks.ExceptionManagement.dll.txt | 128,000 | 1/28/2009 10:15 |
| Microsoft.ApplicationBlocks.ExceptionManagement.Interfaces.dll.txt | 20,800 | 1/28/2009 10:15 |
| Microsoft.Practices.CompositeUl.dll.txt | 592,374 | 1/28/2009 10:15 |
| Microsoft.Practices.CompositeUl.WinForms.dll.txt | 233,974 | 1/28/2009 10:15 |
| Microsoft.Practices.ObjectBuilder.dll.txt | 201,100 | 1/28/2009 10:15 |
| Microsoft.SqlServer.BatchParser.dll.txt | 1,135,550 | 1/28/2009 10:15 |
| Microsoft.SqlServer.ConnectionInfo.dll.txt | 464,074 | 1/28/2009 10:16 |
| Microsoft.SqlServer.Management.Sdk.Sfc.dll.txt | 1,270,474 | 1/28/2009 10:16 |
| Microsoft.SqlServer.Replication.dll.txt | 5,082,750 | 1/28/2009 10:16 |
| Microsoft.SqlServer.Smo.dll.txt | 8,950,474 | 1/28/2009 10:16 |
| Microsoft.SqlServer.SqlClrProvider.dll.txt | 105,674 | 1/28/2009 10:16 |
| Microsoft.SqlServer.SqlEnum.dll.txt | 3,331,274 | 1/28/2009 10:16 |
| Microsoft.SqlServer.SqlWmiManagement.dll.txt | 528,074 | 1/28/2009 10:16 |
| Microsoft.SqlServer.WmiEnum.dll.txt | 156,874 | 1/28/2009 10:16 |
| NavigatorMD Setup.exe.txt | 7,878,842 | 1/28/2009 10:16 |
| NavigatorMD Setup.msi.txt | 1,544,000 | 1/28/2009 10:16 |
| NavigatorMS Setup.res.txt | 10,169,992 | 1/28/2009 10:16 |
| NavigatorMD.Common.BLL.dll.txt | 44,800 | 1/28/2009 10:16 |
| NavigatorMD.Common.Dal.dll.txt | 169,600 | 1/28/2009 10:16 |
| NavigatorMD.Common.dll.txt | 2,513,600 | 1/28/2009 10:16 |
| NavigatorMD.Common.WinUl.Controls.dll.txt | 478,400 | 1/28/2009 10:16 |
| NavigatorMD.Common.WinUl.Forms.dll.txt | 320,000 | 1/28/2009 10:16 |
| NavigatorMD.Connectivity.dll.txt | 38,400 | 1/28/2009 10:16 |
| NavigatorMD.Core.dll.txt | 913,600 | 1/28/2009 10:16 |
| NavigatorMD.DatabaseLogistics.dll.txt | 222,400 | 1/28/2009 10:16 |
| NavigatorMD.exe.txt | 489,600 | 1/28/2009 10:16 |
| NavigatorMD.Filter.asm.txt | 729,600 | 1/28/2009 10:16 |
| NavigatorMD.Filter.dll.txt | 729,600 | 1/28/2009 10:16 |
| NavigatorMD.PivotViews.dll.txt | 118,400 | 1/28/2009 10:16 |
| NavigatorMD.PlanModeler.dll.txt | 1,145,600 | 1/28/2009 10:16 |
| NavigatorMD.ProductRegistration.dl.txt | 200,000 | 1/28/2009 10:16 |
| NavigatorMD.ProductUpdate.dll.txt | 36,800 | 1/28/2009 10:16 |
| NavigatorMD.Reports.dll.txt | 464,000 | 1/28/2009 10:16 |
| NavigatorMD.Views.dll.txt | 758,400 | 1/28/2009 10:16 |
| nsoftware.IPWorksZip.dll.txt | 740,024 | 1/28/2009 10:16 |
| Updater.Common.dll.txt | 155,200 | 1/28/2009 10:16 |
| Updater.Component.dll.txt | 41,600 | 1/28/2009 10:16 |

The computer executable object code listings submitted herewith on the CD-ROMs are incorporated by reference herein.

### BACKGROUND AND SUMMARY

Computer programs are available for generating healthcare insurance plans and testing them on a population of individuals, hypothetical or real, which are often called insurance planning programs or insurance plan design programs.

Also, various programs have been developed to analyze healthcare data in a variety of ways. However, these two types of programs (insurance design programs and health data analysis programs) have typically been separate programs and the capability of one is not found in the other. In the embodiment described below, an apparatus for the design, analysis, and reporting of health care plans is disclosed that includes a health plan data analyzer that has capabilities that are beyond the capabilities found in known insurance plan design programs. In particular, the embodiment disclosed below includes the capability of creating or designing an insurance plan, then testing and reporting its effect on an overall population. Then it may filter the population from within the plan designer to create a sub-population, and recalculate the effects of the plan on the filtered subpopulation. It can repetitively change the filter to change the population on which an insurance plan is tested.

In one embodiment of the present disclosure, an apparatus for analyzing digital health care data and designing and testing health care plans and generating reports based on the digital health care data is provided. The apparatus may include a digital data processor that includes at least one processor, at least one display device, at least one input device, at least one data storage device, and computer memory.

The apparatus may also include digital data stored on a computer readable media, the data being accessed by the data storage device and transmitted between the data processor and the data storage device. The data may include at least one health care data set comprising a member population and including at least patient identification information and corresponding health care diagnoses, health care services for each patient, payments by the plan for health care services for each patient and payments by each patient for health care services, and/or one or more health care plans. Each health care plan may have operating parameters including at least (1) coverage definitions defining conditions that are covered by the health care plan, (2) benefits definitions defining treatments that are provided under the health care plan, and (3) co-pay and deductible amounts, if any, defining payments that must be made by the person covered by a health care plan.

The apparatus may also include an input device for receiving user input, a global filter implemented in the data processor for filtering the health care data set in response to a filter-on command, said filtering being based on filtering stipulations input by a user via the input device to produce a data sub-set that includes at least a portion of the health care data set, which may include a health care data subset, a healthcare data analyzer integrated with the global filter and implemented in the data processor for transmitting data to and communicating with at least one global filter and a report generator for generating reports in response to a report command, the reports being based on the data-set and providing information as to the health care received by the entire population covered by the health care plan including cost information, and for generating reports based on at least a portion of the data set, the reports thereby providing information as to the health care provided to a sub-set of the member population including cost information.

The apparatus further includes a health plan designer integrated with the global filter and implemented in the data processor, the plan designer being responsive to user inputs to produce hypothetical health care plan data provided by a hypothetical company, the hypothetical health care plan data having at least coverage definitions, co-pay amounts and deductible definitions. The plan designer operates to transmit the hypothetical health care plan data to the health care data analyzer, and the analyzer may optionally apply one or more filters, and the analyzer may further transmit the health care plan data to the report generator. The report generator generates a report based on the filtered and analyzed data. The report indicates the health care services that would have been covered in the entire population by the hypothetical health care plan and the cost of health care services to the patients and the hypothetical company.

The plan designer also operates to transmit health care plan data to the health care data analyzer, wherein the health care data analyzer analyzes a sub-set of the member population provided by the global filter, and transmits the analyzed data to the report generator. The report generator generates a report based on the data sub-set. The report indicates health care services that would have been covered within the data subset and an estimated cost of health care service to the patients and to the hypothetical company.

For example, a health insurance plan may first be devised and then tested on an overall population. Then, a filter may be turned on to select only those members of the population who are diabetic. When the filter is turned on, the plan can be immediately applied to the subpopulation of the diabetics and the effects of the plan on that subpopulation may be observed.

Similarly, the filter may be used in ways that does not create a distinct sub-population. For example, the filter may be turned on to select a particular type of claim. This type of filtering does not create a unique population because some of the population will have the selected claim and will have other claims. Thus, such person would be both inside and outside of the data set because such person has claims inside and outside of the filter parameters. However, filtering on a parameter such as claims or a particular group of claims is useful in analyzing a particular insurance plan.

A member filter is used to filter sub-populations based on user defined or pre-set stipulations. These subpopulations are filtered into the entire reporting and health plan designer sections of NavigatorMD, which means that both reports and health plan designs may use the filters seamlessly. Once the filters have been selected or created, reports may be generated based on the filters and immediately before or after the generation of the report, a plan design may be generated using the same filters without having to change anything in the filters or do anything to generate the filtered data.

Additional aspects and advantages of the disclosure will be set forth in part in the description which follows, and/or can be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

In this discussion, the term insurance is being used in a very broad sense. It is intended to cover such things as fully insured health insurance policies, but it is also intended to cover such things as self insurance plans typically created by employers. Insurance is further intended to cover agreements that create health care networks, associations or organizations that are often created by healthcare providers such as hospitals or groups of hospitals or hospital holding companies. Furthermore, the term insurance as used herein could cover government sponsored plans. One feature of insurance is that one party is receiving healthcare and another party is directly or indirectly paying for all or a portion of the cost associated with the healthcare.

### BRIEF DESCRIPTION OF THE DRAWINGS

The embodiment described below may be best understood with reference to the attached figures in which:

FIG. 1 is a simplified block diagram of an embodiment of an apparatus for analyzing health care data, designing, testing, and reporting health care plans based on health care data.

FIG. 2 shows the opening screen of a program operating within the apparatus and having the capability of analyzing and reporting healthcare data and designing healthcare insurance plans, as well as applying filters to the report generator and the plan designer sections of the program;

FIG. 3 is a close-up view of the top line of FIG. 2 showing the left and right sides;

FIG. 4 is a close-up view of the opening screen of the program showing the insurance plan design menu;

FIG. 5 is a menu that has been called from the reporting program allowing the user to design a series of reports;

FIGS. 6, 7 and 8 represent a report generated by the program illustrating the cost results of a particular healthcare insurance plan within a user-defined date range;

FIG. 9 is a view of the plan re-calculation module that is called from the plan design menu in which the user can design a plan and compare it to a benchmark plan;

FIG. 10 is a close-up view of the left hand side (new plan design) of FIG. 9;

FIG. 11 is a close-up view of the right hand side (benchmarked plan design) of FIG. 9;

FIG. 12 is a view of the plan recalculation module showing the configuration of both the new plan design and the benchmark and the run model button has been activated;

FIG. 13 shows an example report that is generated and output when the run model plan is activated;

FIG. 14 is a report showing one effect of the plan changes relative to the design;

FIG. 15 again shows the plan re-calculation module and referring to the right hand side of the figure, the filter is off, but the filter button has been selected;

FIG. 16 shows the global filter menu created by clicking the filter button;

FIG. 17 shows an example filter (using diabetic claims) created by a user;

FIG. 18 shows the plan re-calculation module with the filter on;

FIG. 19 shows a report reflecting the effect of the new plan as compared to the benchmark when only applied to the subpopulation created by the filter;

FIG. 20 shows the plan re-calculation module with the global filter menu superimposed on it resulting from a click of the filter button;

FIG. 21 shows the plan as it is being applied to the filter set in FIG. 20;

FIG. 22 shows the effect of the plan on the group of claims that were in network claims as specified by the filter shown in FIG. 20. This result affects 935 members but the 935 members are not a unique population because such members may have claims both in the network and outside the network;

FIG. 23 shows the plan re-calculation module with the filter on and selections to include prescription and in network only claims;

FIG. 24 illustrates the global filter menu illustrating how different groups of the population may be selected;

FIG. 25 shows the global filter menu illustrating that a number of different plans are included within the population and different combinations of the plans may be chosen to be within the filter;

FIG. 26 illustrates the global filter and shows that the benefits can be individually selected so that only selected benefits are included in the report;

FIG. 27 illustrates that the global filter may filter on locations of the population;

FIG. 28 shows the global filter menu illustrating that the global filter may do aggregate filtering on claimant cost, family cost or claim cost;

FIGS. 29, 30, 31, 32 and 33 illustrate various user defined stipulations that create user defined filters for application to a defined set of data; and

FIGS. 34-71 illustrate further and more detailed examples of global filter output and plan designer and analyzer output.

FIGS. 72-97 illustrate a global member filter used in both analysis and design.

### DETAILED DESCRIPTION

The present disclosure will now be described in the more limited aspects of preferred embodiments thereof, including various examples and illustrations of the formulation and use of the present disclosure. It will be understood that these embodiments are presented solely for the purpose of illustrating the invention and shall not be considered as a limitation upon the scope thereof.

Other embodiments of the present disclosure will be apparent to those skilled in the art from consideration of the specification and practice of the embodiments disclosed herein. As used throughout the specification and claims, “a” and/or “an” may refer to one or more than one.

It is intended that the specification and examples be considered as exemplary only, with a true scope and spirit of the invention being indicated by the claims appended hereto.

In one embodiment of the present disclosure, an apparatus is provided for designing, filtering, analyzing, and generating reports based on a set of health care data and input provided by a user. The apparatus and its use are described in further detail below.

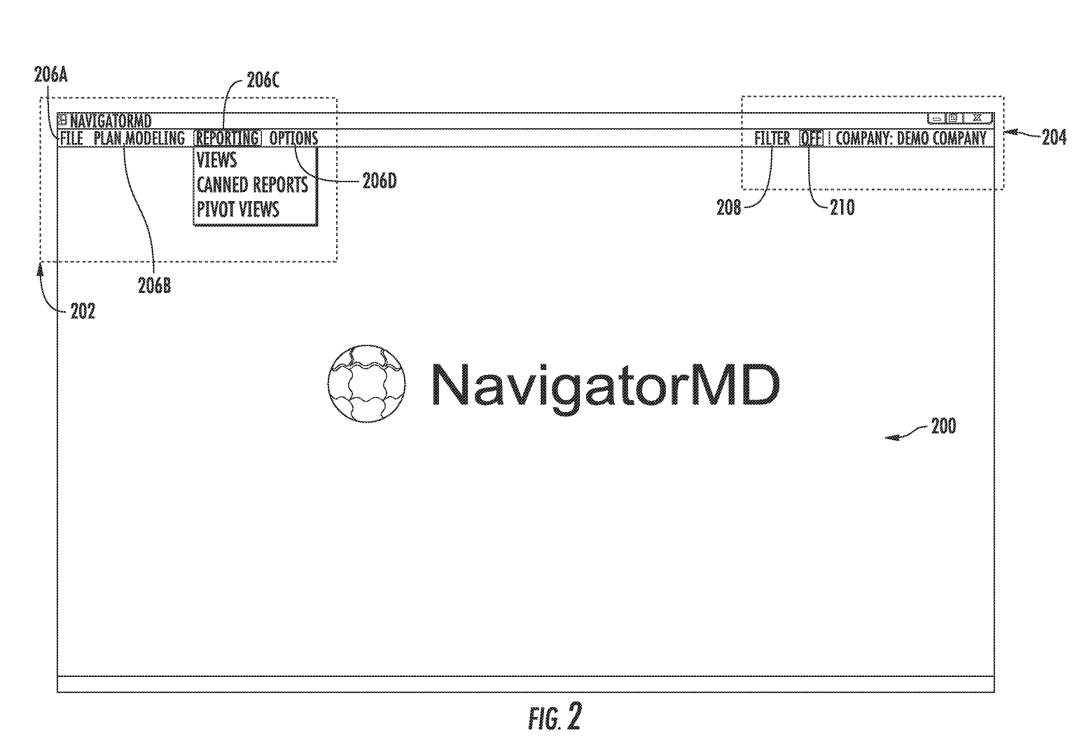

The apparatus may include a program called “NavigatorMD,” the opening screen thereof being shown in FIG. 2. For the purposes of this disclosure, the terms “the program” and “NavigatorMD” are synonymous and may be used interchangeably throughout the specification, unless otherwise explicitly stated. The program includes one or more discrete modules that may be machine executable code residing on a computer readable medium that performs the functions described herein upon execution by the machine. Alternatively, the discrete modules of the program may also be embodied as discrete electronic hardware containing the machine-executable code.

Within the context of the present disclosure, the term “data processor” means any programmable or hard wired computing device configured to implement the program, apparatus and/or one or more methods disclosed herein, including a general purpose computer. When a general purpose computer or data processor accesses and executes the program code of the present disclosure, stored on computer readable media, the software-configurable circuits of the general purpose computer are transformed into a specific machine that analyzes and/or filters health care data, as described further herein.

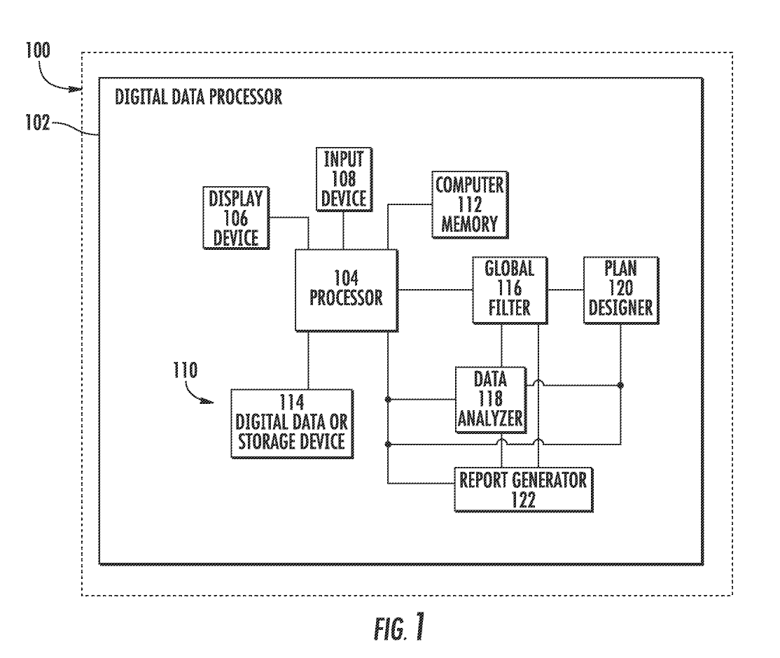

Referring now to FIG. 1, a simplified block diagram of one embodiment of the present disclosure is illustrated, for the purposes of demonstrating the connections and interactions among the various components of the present disclosure. An apparatus 100 for analyzing health care data and designing and testing health care plans based on the health care data includes a digital data processor 102 having at least one processor 104, at least one display device 106, at least one input device 108, at least one digital data storage device 110, and computer memory 112.

For the purposes of this application, the term “display device” is intended to mean a device capable of the displaying output from the data processor, and may include such devices as a computer monitor or a printer. Unless otherwise indicated, the term “screen” is intended to include output displayed on the display device, for example a window, dialog, menu, report, graphical display, or the like.

The apparatus includes digital data 114 stored in a computer readable form which may be present on the digital data storage device 110. The digital data storage device 110 may be integrated into the apparatus 100, or it may be removable. The processor 104 of the digital data processor 102 may coordinate access to the digital data 114 stored on the digital data storage device 110, including operations of reading and writing the digital data to and from the storage device 110.

The digital data 114 may include at least one health care data set including at least patient identification information and corresponding health care diagnoses, health care services for each patient, payments by the plan for health care services for each patient and payments by each patient for health care services, and/or one or more health care plans each health care plan having operating parameters including at least (1) coverage definitions defining conditions that are covered by the health care plan, (2) benefits definitions defining treatments that are provided under the health care plan, and (3) co-pay and deductible amounts, if any, defining payments that must be made by the person covered by a health care plan.

The apparatus further includes an input device 108 for receiving user input including filtering criteria, plan modification commands, filter-on commands, and a report command. The input device may be a keyboard, a mouse, a touch-screen, or equivalent devices.

The apparatus of the present disclosure also includes one or more discrete computer executable program modules, which may be stored in a computer readable and executable form on a digital data storage device, or embodied as hard-wired dedicated circuits within the data processor 102. For example, the program may be stored on ROM chips within the data processor 102. When the apparatus is turned on, the processor 104 of the data processor 102 accesses and executes the program modules and coordinates data communication among the modules, the computer memory 112, the digital data storage device 114, the display device 106, and the input device 108.

Although in the following discussion the interactivity of the modules is described as though the modules communicate directly with one another, it should be understood that the discrete program modules may communicate indirectly with one another, with all user-input commands, operations, data communication, and calculations coordinated and executed by the processor 104. The data communication between the processor 104 and other components of the apparatus 100, including the modules, may be full duplex or half duplex. That is, data transmission may occur bidirectionally or unidirectionally, and in series or parallel.

A user-configurable global filter 116 is implemented in the data processor 102, in one embodiment as a discrete software module. The global filter 116 is accessed by the data processor 102 and filters the health care data set in response to a user-issued filter-on command. The filtering may be based on filtering criteria provided by a user through the input device 102, thus providing one or more data sub-sets that may include at least a portion of the health care data set. The global filter 116 may include one or more sub-filters and/or user-configurable filters.

The apparatus has a data analyzer 118, which may also be embodied as a discrete program module within the data processor 102. The data analyzer 118 may be integrated with the global filter 116 and implemented in the data processor for transmitting data to and communicating with the global filter 116, a health plan designer 120, and a report generator 122 for generating reports in response to a user-issued report command. The reports may be based on at least a portion of the health care data-set and may include information as to the health care received by the entire population covered by the health care plan including cost information. The reports may also be generated based on a filtered subset of the health care data, as provided by the global filter 116, with the reports including information as to the health care provided to a sub-group of the population including cost information.

The data analyzer 118 may act as a substantially user-transparent health plan data calculator for calculating and comparing a filtered or unfiltered data set with one or more hypothetical user-designed health plans. The data analyzer 118 may receive and transmit data to and from the plan designer 120 and the global filter 116, and also may transmit the analyzed data to the report generator 122.

A further constituent of the apparatus is the health plan designer 120, which may be embodied as a discrete program module within the data analyzer 102. The health plan designer 120 may be integrated with the global filter 116 and the data analyzer 118. The plan designer 120 is responsive to user input from the input device 108 to produce a hypothetical health care plan provided by a hypothetical company, the hypothetical health care plan having at least coverage definitions, co-pay amounts and deductible definitions. The plan designer 120 transmits the hypothetical health care plan based on at least a portion of the health care data set, which may or may not have been provided by the global filter 116, to the data analyzer 118. The data analyzer 118 analyzes the hypothetical health care plan dataset and transmits the analyzed data to the report generator 122.

The report generator 122 receives at least a portion of the filtered and analyzed health plan data set from the analyzer 118 and generates a report (not shown). The report indicates the health care services that would have been covered in the entire population by the hypothetical health care plan and the cost of health care services to the patients and the hypothetical company.

In one embodiment, the data analyzer 118 may also transmit at least a portion of the health care data set (i.e. a data subset), as provided by the global filter 116, to the report generator 122 for generating a report based on the data sub-set. The report may indicate health care services that would have been covered within the data subset and an estimated cost of health care service to the patients and to hypothetical company. The report generator 122 may format and transmit report data to the processor 104 for display on one or more display devices 106, such as a computer monitor and/or a printer.

The display device 106 may also be used for providing access to a user interface that facilitates interaction between the user and the apparatus 100, for example the user interface may prompt the user to provide input via the input device 108, and the display device 106 may display output based on the input received, in accordance with the execution of the program modules. The user interface may be embodied as one or more screens, as previously defined herein.

With reference now to FIG. 2, on the top left 202 and top right hand 204 of the screen 200, drop-down menus 206a-d and a filter menu 208 are provided. Referring to the left side of the screen 202, four drop down menus 206a-d are available. The second and third drop down menus are the health plan design menu 206b and the report generator menu 206c. In this embodiment, the filter menu 208 is positioned at the top right hand of the screen 200.

The report generator menu (also referred to herein as the “reporting menu”) 206c is a user interface that permits the processor 104 to access the report generator 122. The report generator 122 allows a user to analyze and display healthcare data, such as claims data, based on a variety of user-input or pre-programmed filters, stipulations, and/or parameters.

Continuing reference to the left side of the screen 202, the health plan design menu 206b is a user interface that permits the user and the processor 104 to access the health plan designer 120. Using the health plan designer 120, a user may design an insurance plan and then activate the health plan data analyzer 118 to test the user-designed plan on a population to determine its cost and other effects.

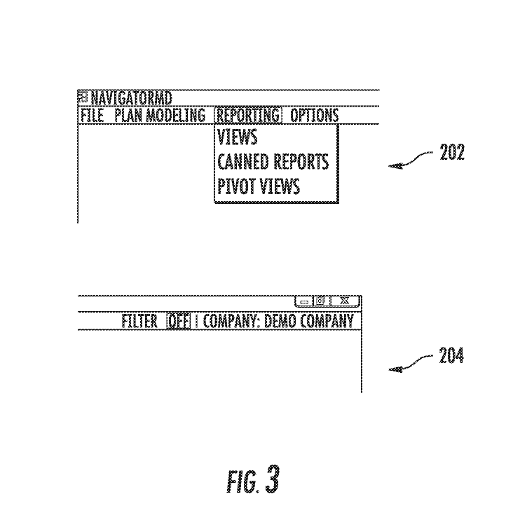

Referring now to the right-hand side of the screen, there is a filter button 208 and an on/off indicator 210. By clicking on the filter button 208, the user can cause the processor 104 to access one or more filters of the global filter 116. The global filter 116 may filter data for use by either the report generator 122 or the health plan data analyzer 118. The filter may be either on or off, and in FIG. 2 it is shown in the off position. The left and right hand sides 202 and 204 of the program, as displayed on the screen 200, are shown in close up view in FIG. 3.

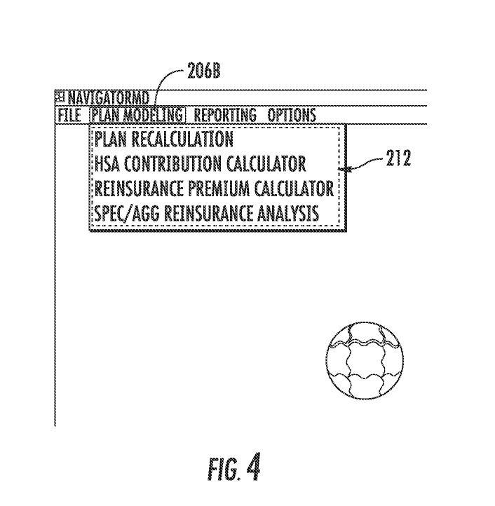

In FIG. 4, the health plan data analyzer 118 has been accessed via menu 206b, and four options 212 are shown. The user may select any of these four options 212 via the input device 108, for example by using a mouse to point and click on a desired option 212. In other embodiments of the present disclosure, there may be more or less than four options provided.

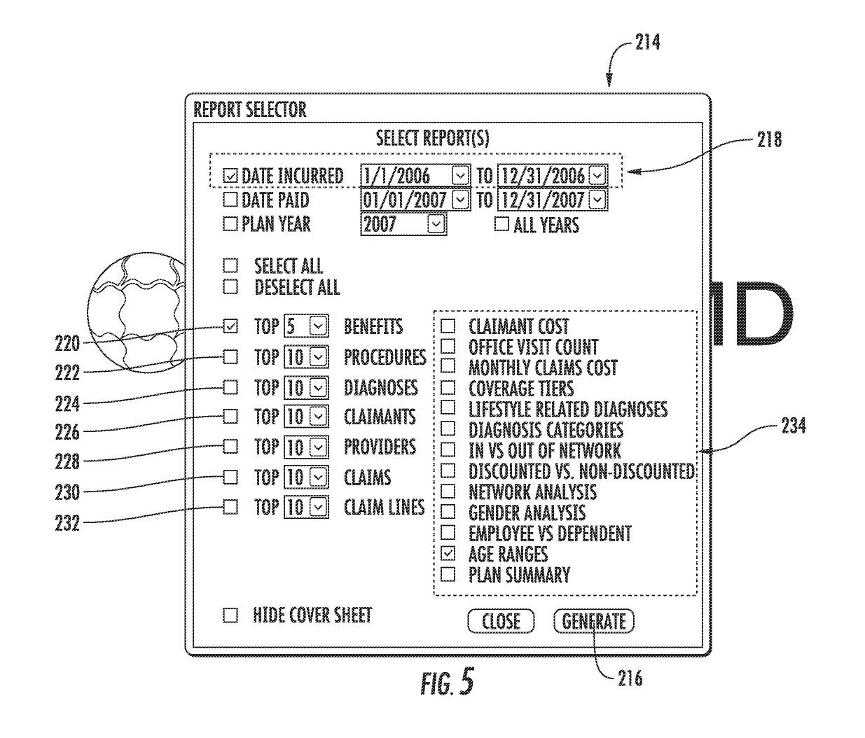

When the reporting menu 206c is clicked, the report generator 122 is accessed and a report selection menu 214 as shown in FIG. 5 is presented to the user. Using this report selection menu 214 and the input device 108, the user may select the type of report he or she desires. When the user activates the “generate” button 216, the report generator 122 will receive health plan data from the data analyzer 118 and/or the global filter 116 and formats the data for output according to the parameters set by the user. The report generator 122 transmits the formatted output (i.e. a report) to one or more display devices 106. The report generator 122 may also store the formatted output on the storage device 110 for later recall.

At the top of the report selection menu 214, the first choice that the user must make is a desired date range 218. The user may choose either the date that a claim was incurred or the date that the claim was paid. In this example, the date incurred is checked and the entire year of 2006 is selected. A single plan year or all years may also be specified using this menu. In the lower portion of the select reports menu, various parameters are provided that may be used to modify the type of report that is being requested.

Referring to the left-hand side of the page, the user may specify the top X number of benefits 220, procedures 222, diagnosis 224, claimants 226, providers 228, claims 230, and claim lines 232 that are desired to be included in the report, wherein X is an integer greater than zero, for example five or ten. On the right hand side of the page the user is able to select additional types of reports that are desired to be displayed, via a report selection menu 234. In this particular example, the top five benefits have been selected and age ranges have been selected as parameters, also referred to herein as “stipulations”, for display.

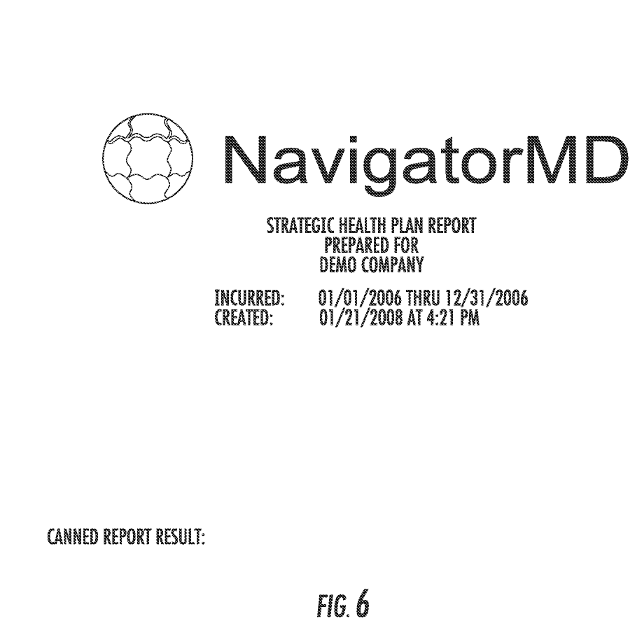

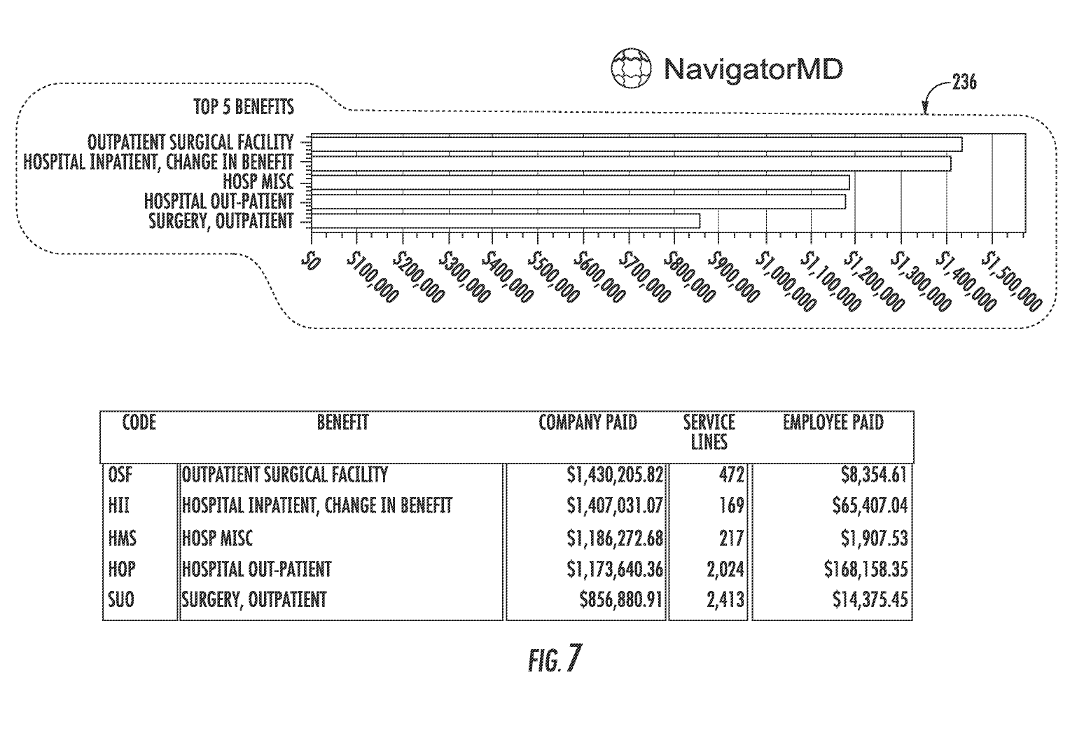

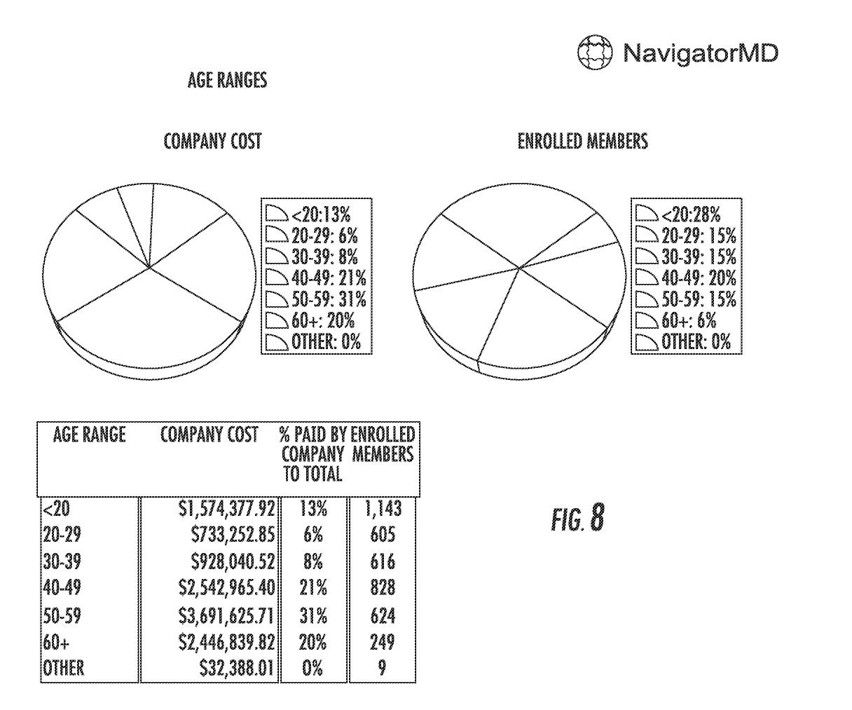

Referring to FIGS. 6, 7, and 8, an example report is shown. In FIG. 7, the report is a top benefit report 236 that shows the top five benefits based on the amount paid by the company. In FIG. 8, those benefits are broken down based on the age ranges of the enrolled members. This is the type of report that may typically be used for analysis and comparison of health care data, particularly insurance claims data.

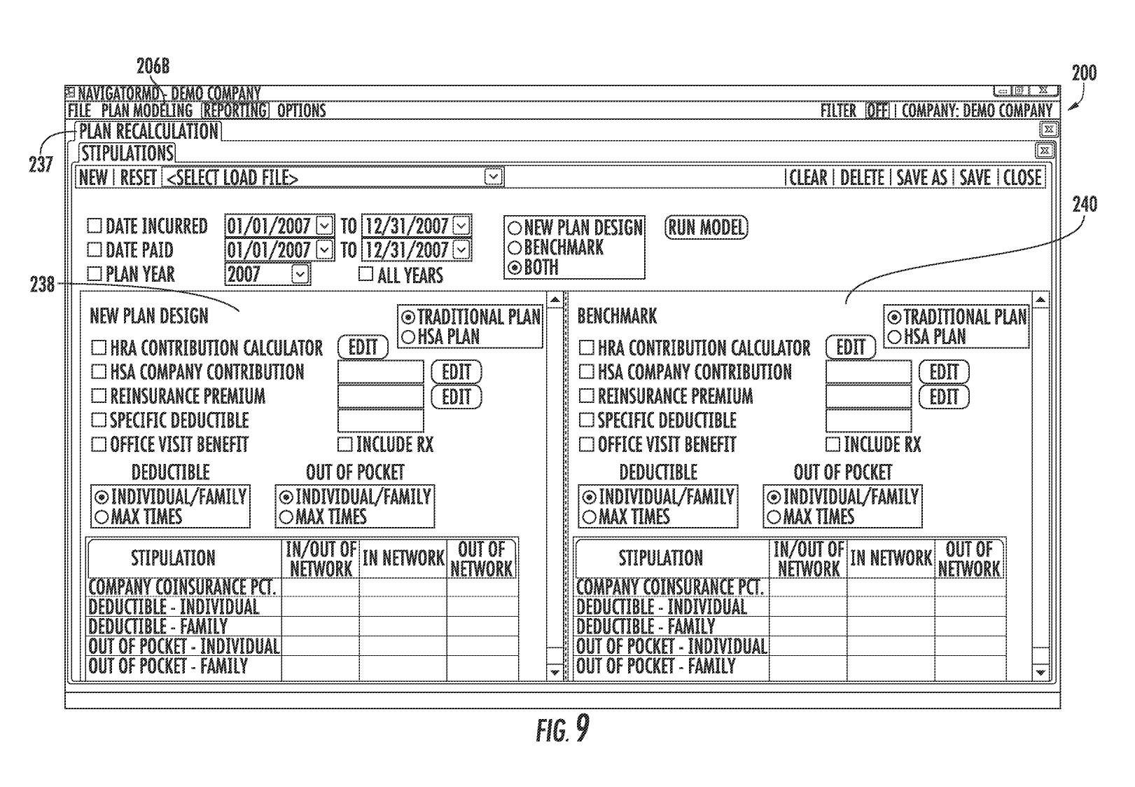

Referring now to FIG. 9, a screen 200 is shown that the user may access by selecting “plan recalculation” under the health plan design menu 206b, also referred to within the context of the program as a “plan modeling” menu. The plan design menu 206b may be used to access a plan recalculation menu 237. In the particular example shown in FIG. 9, a user defined hypothetical demo company new plan 238 is presented along with a pre-defined benchmark plan 240. The benchmark plans may be pre-defined or user-defined. The benchmark plan 240 is shown on the right-hand side of the screen 200 and the new plan design 238 is shown on the left.

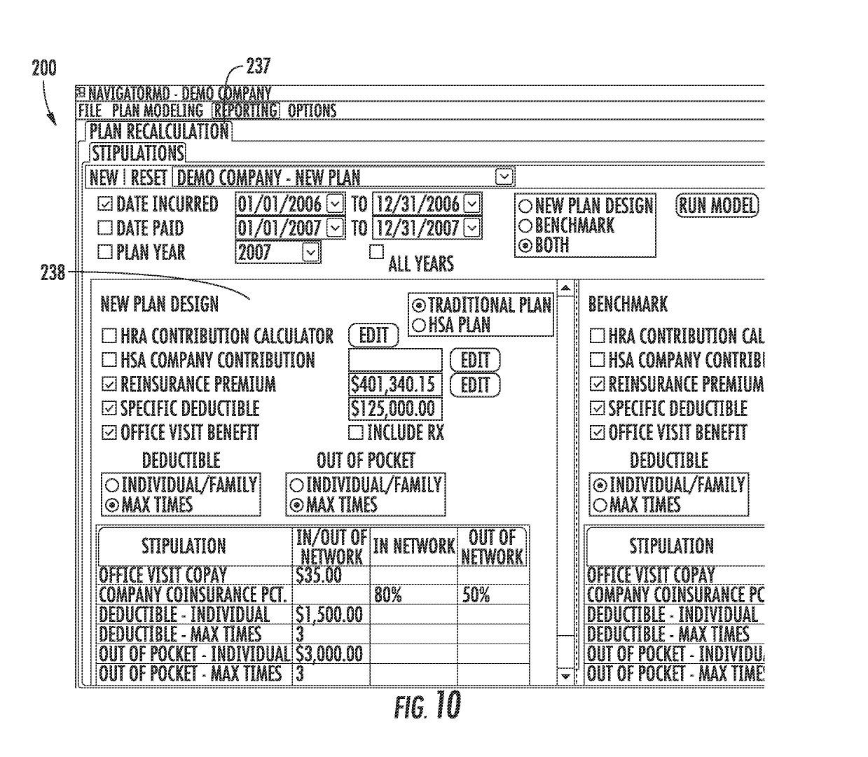

Referring to FIG. 10, a close-up view of the left side 202 of the screen 200 is shown illustrating the new plan 238. In this case, the new plan 238 is being tested against 2006 data. The plan design is a traditional plan that shows the reinsurance premium and the specific deductible. The reinsurance premium is the amount that the company must pay to underwrite a specific portion of the insurance with an insurance underwriter. The specific deductible is the amount of money that a company must pay for a member before the reinsurance company will cover their remaining claims until the end of the reinsurance contract. In this particular example, the plan design includes office visits but not prescriptions and the family deductible and out of pocket is based on a maximum of 3 members reaching the individual deductible or out of pocket. The office visit co-pay is $35; the company co-insurance percentage is 80% in network, meaning doctors within a particular network, and 50% for use of doctors or facilities outside of a network. An individual deductible is $1,500. The out of pocket limit for an individual is $3,000.

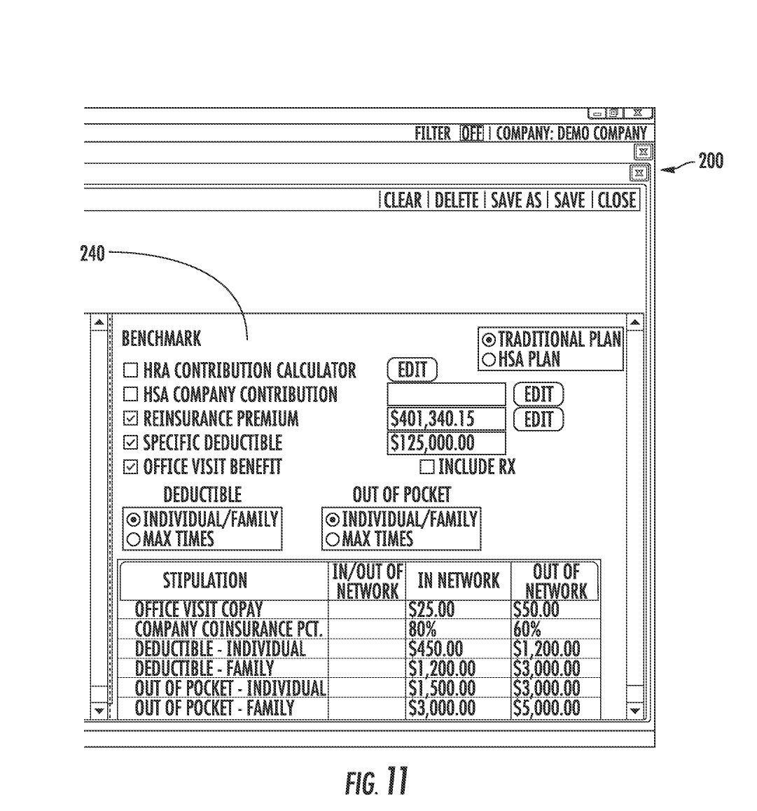

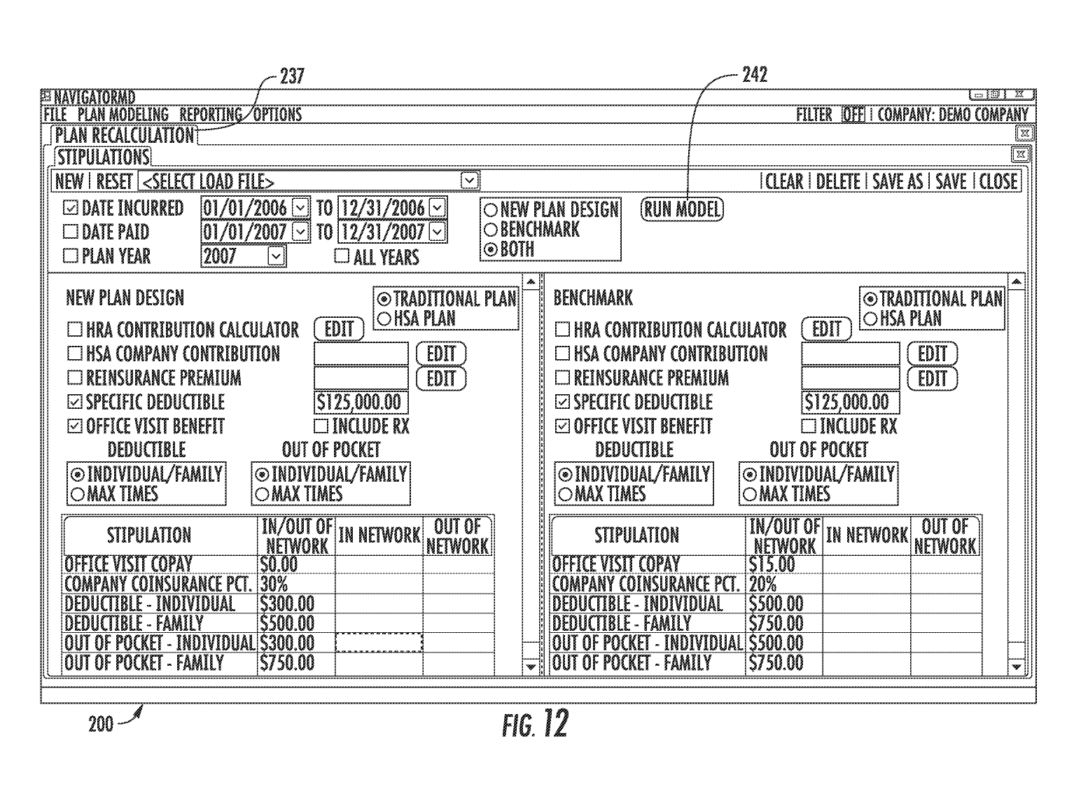

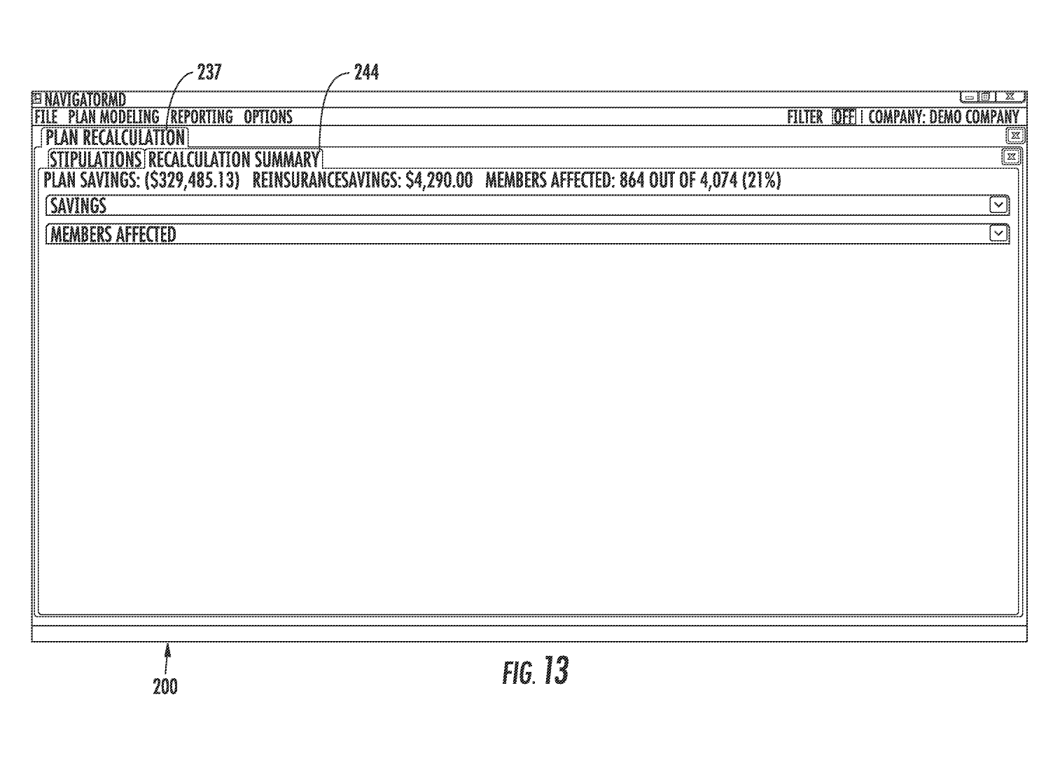

Referring to FIG. 11, a close-up view of screen 200 showing a benchmark insurance plan 240 is shown. The same types of parameters have been chosen, but they are different. Once the user devises the new plan 238 and selects the benchmark plan 240 using this menu, the user may activate the run model button 242, which is shown in FIG. 12. In response, the health care data analyzer 118 receives the parameters of the new plan 238 and the benchmark plan 240 and analyzes the health care data based on each plan. The data analyzer may utilize filtered health care data provided by the global filter 116 if desired. The data analyzer 118 may provide recalculation summary data based on each plan, and transmit the recalculation summary data to the report generator 122. The report generator 122 generates, formats, and outputs a recalculation summary report, as shown in FIG. 13.

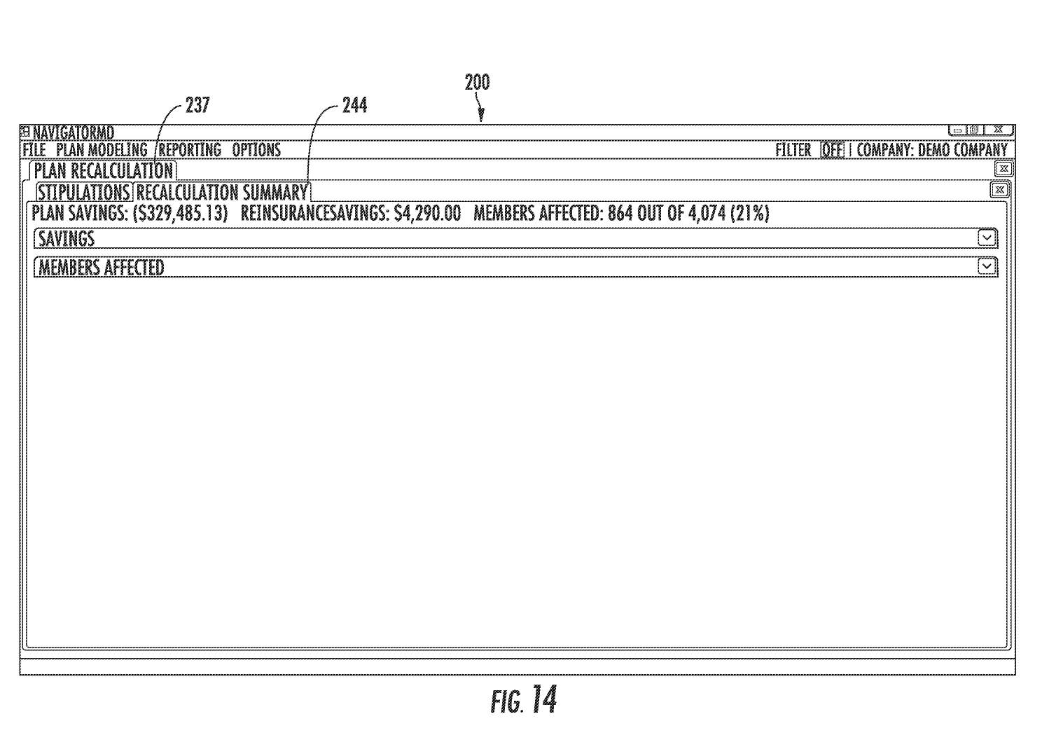

In response to the activation of the run model button 242, the recalculation summary report is shown as a screen 200 output on the display device 106, as illustrated in FIG. 14. This shows an additional plan cost $329,485.00, a reinsurance savings of $4,290.00 and it also shows that 864 out of 4,074 members are affected by changing to the new plan as compared to the benchmark.

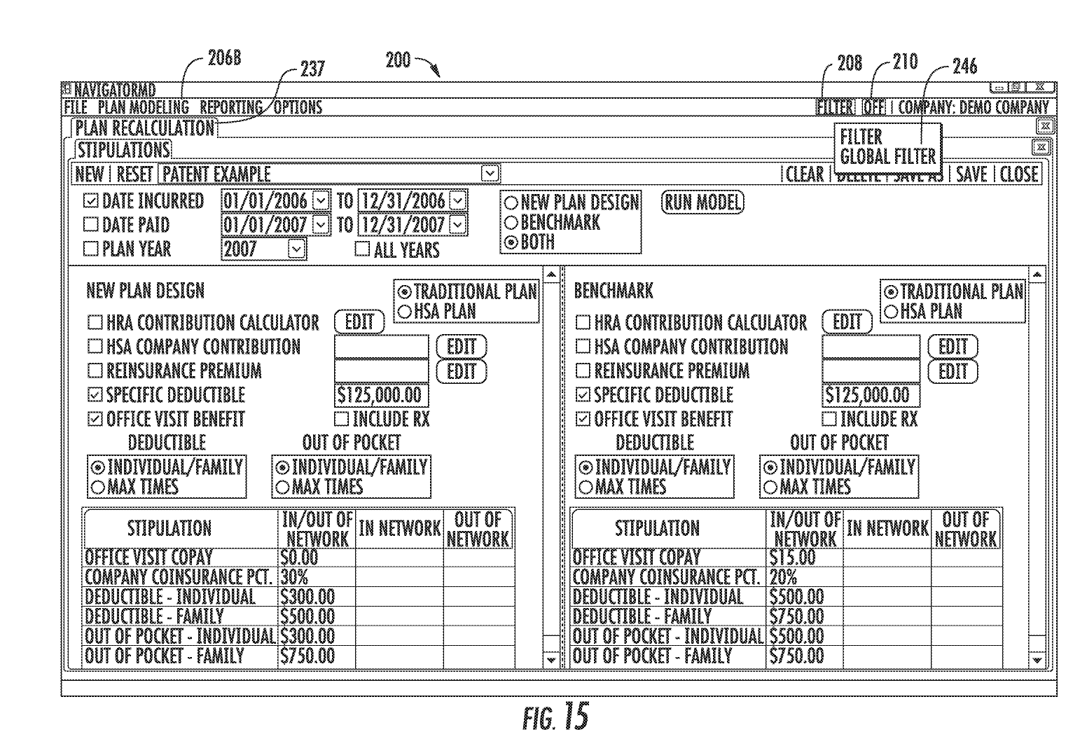

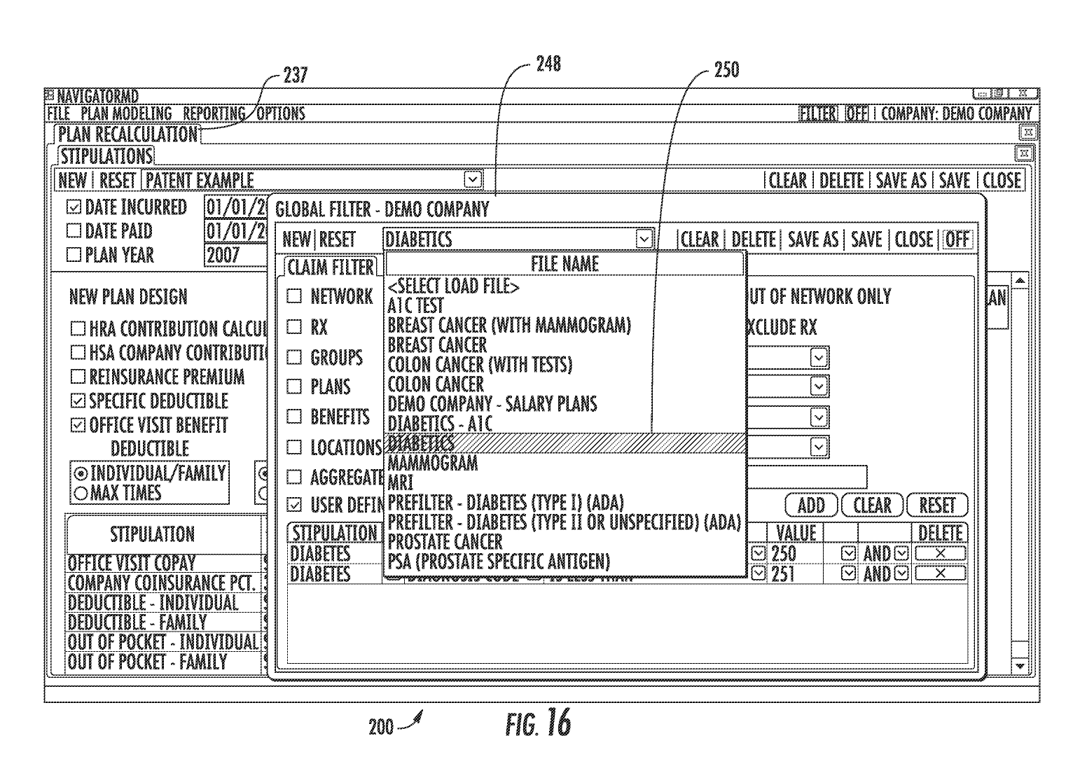

To begin further analysis of the new plan, the user may return to the main health plan design menu 206b as shown in FIG. 15. The filter indicator 210 shows the filter to be off. The user then selects the filter menu by clicking on “filter” 208, then “global filter” 246. The menu 248 shown in FIG. 16 is then displayed. In this case the user selects a pre-defined filter 250 called “diabetics”, and this filter will operate on the data to select only claims related to diabetics, to provide a subset of the health care data.

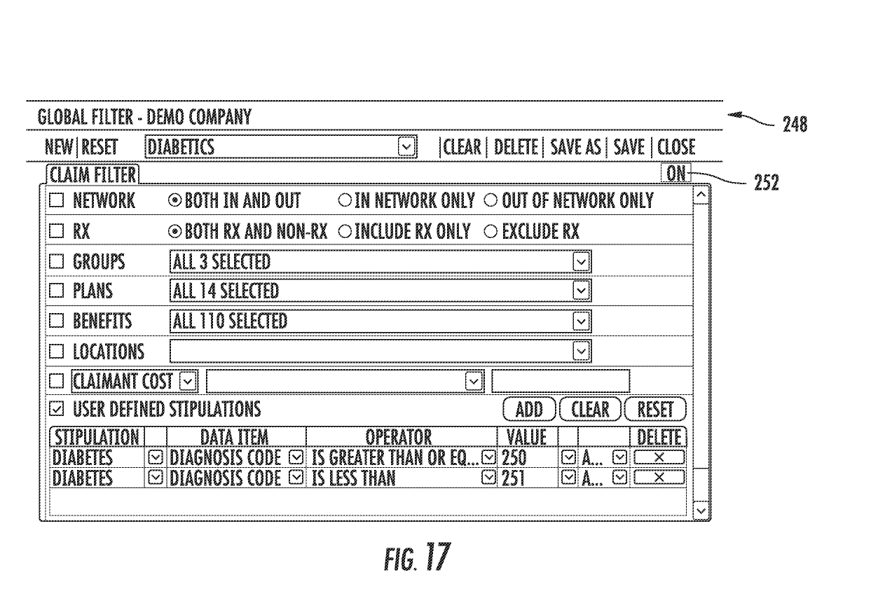

FIG. 17 shows a close up of the menu of FIG. 16, after selection of the pre-defined “diabetics” claims filter 250. Available options are shown, and the user may optionally enter or select additional stipulations for the diabetic filter 250. The user may then activate the diabetic filter 250 by selecting the “filter on” 252 button, which calls the global filter 118 to process (i.e. filter) the health care data based on the parameters and stipulations selected by the user to provide a data subset. The global filter 118 may then transmit the data subset to the health plan analyzer 118 and/or the report generator 122.

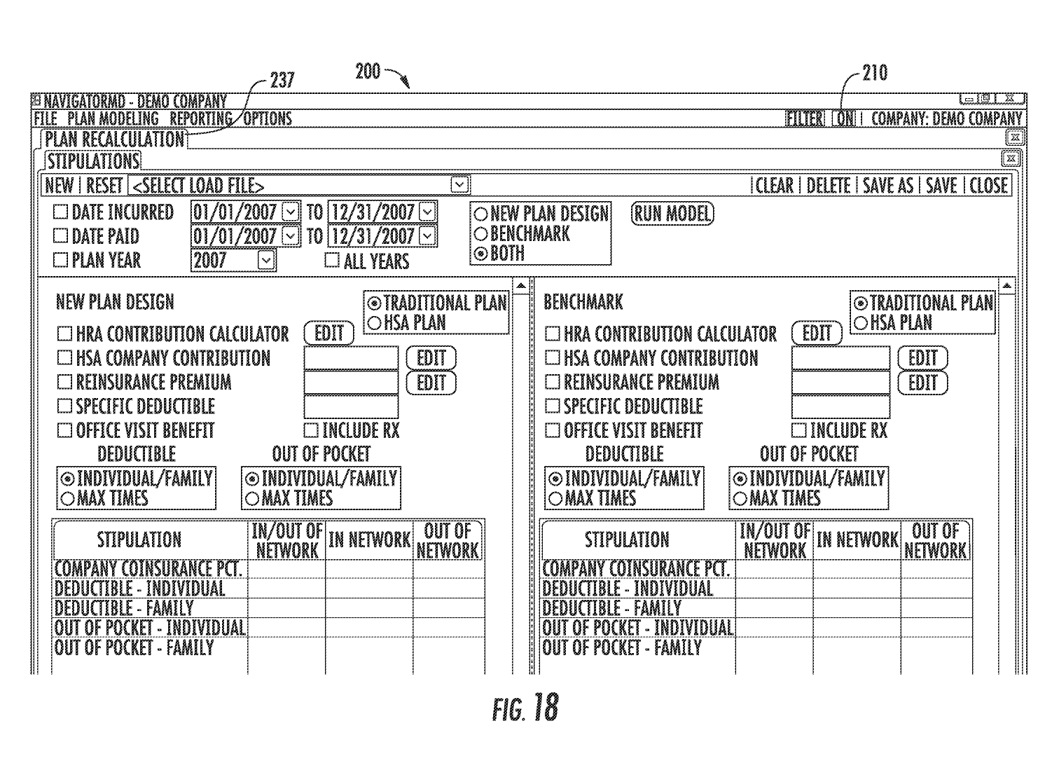

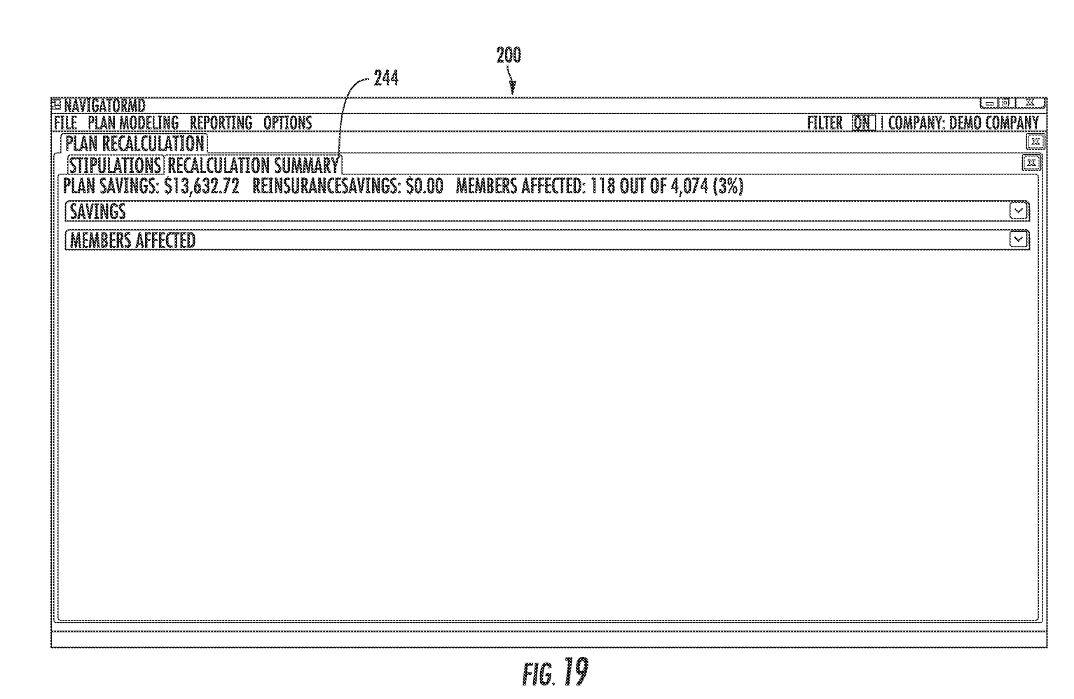

In FIG. 18, the plan recalculation menu 237 is again shown, but in this view, the filter has been turned on as indicated by the “filter on” indicator 210, so that the data analyzer 118 is provided with a subset of the health care data. With the filter on, the results of the plan are recalculated as previously described, and a recalculation summary 244 output screen is shown in FIG. 19. It will be appreciated that in this particular case, the number of members affected is 118 out of 4,074. Thus, the apparatus 100 has analyzed a filtered subpopulation of diabetic plan members using the data processor 102, and has provided the desired output for the user.

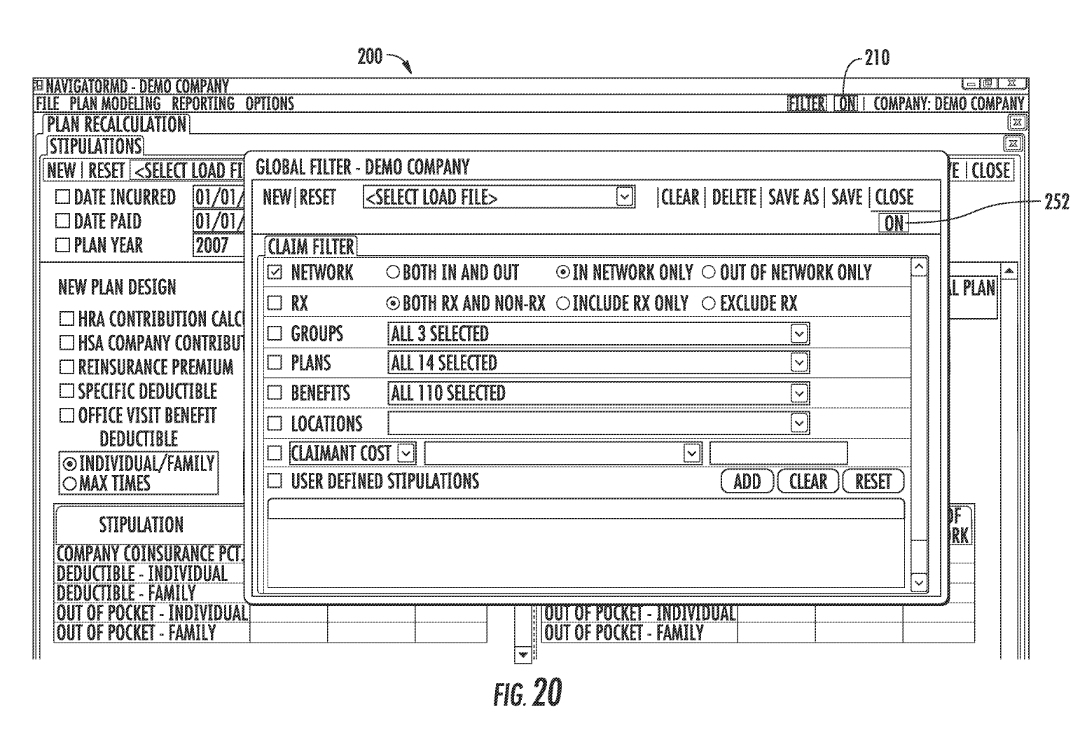

Referring to FIG. 20, the filter button 252 has been activated and the filter is indicated as being on by the filter on/off indicator 210. In this case, a global filter menu 248 is displayed so that the user may select one or more types of filter for the global filter 116 to apply to the entire population. In this case, as an example, only in network claims are included. In other words, any out-of-network claims are excluded from the report while in-network claims are included. It will be understood that this type of filter is not generating a unique subpopulation of members because a particular member could have both in-network and out-of-network claims. In fact, in many plans it will be anticipated that a relatively large percentage of the population of members will have both types of claims, in-network and out-of-network. Thus, a unique subpopulation is not selected by this type of filter and it is a claim specific type of filter.

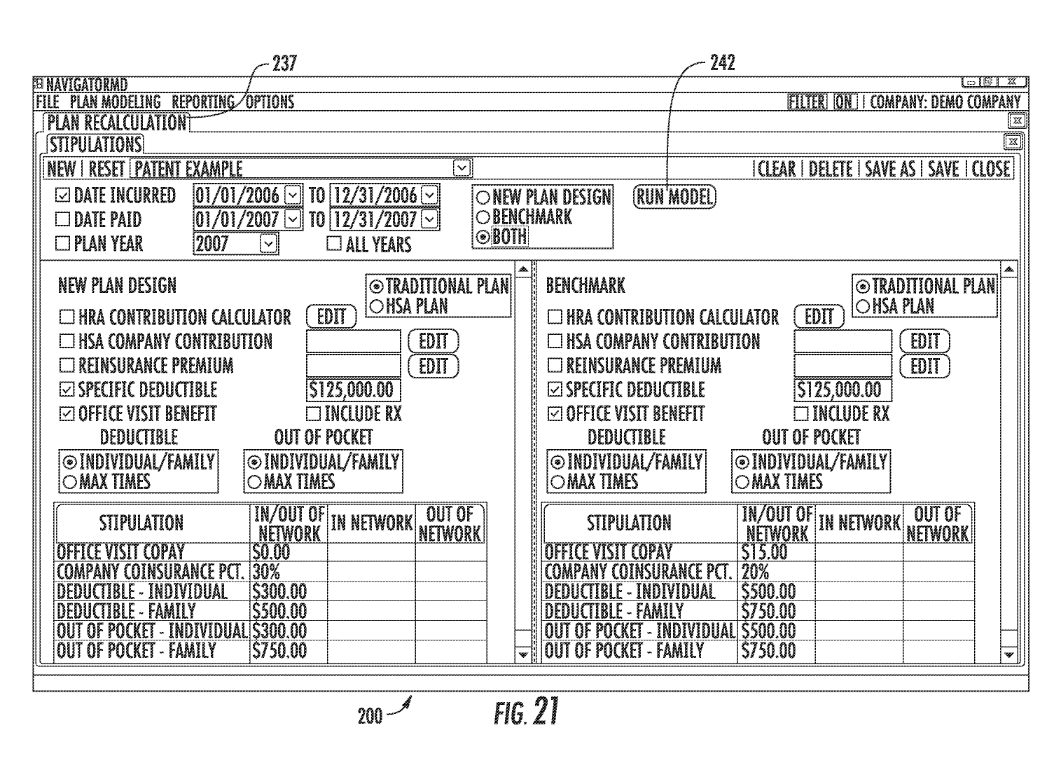

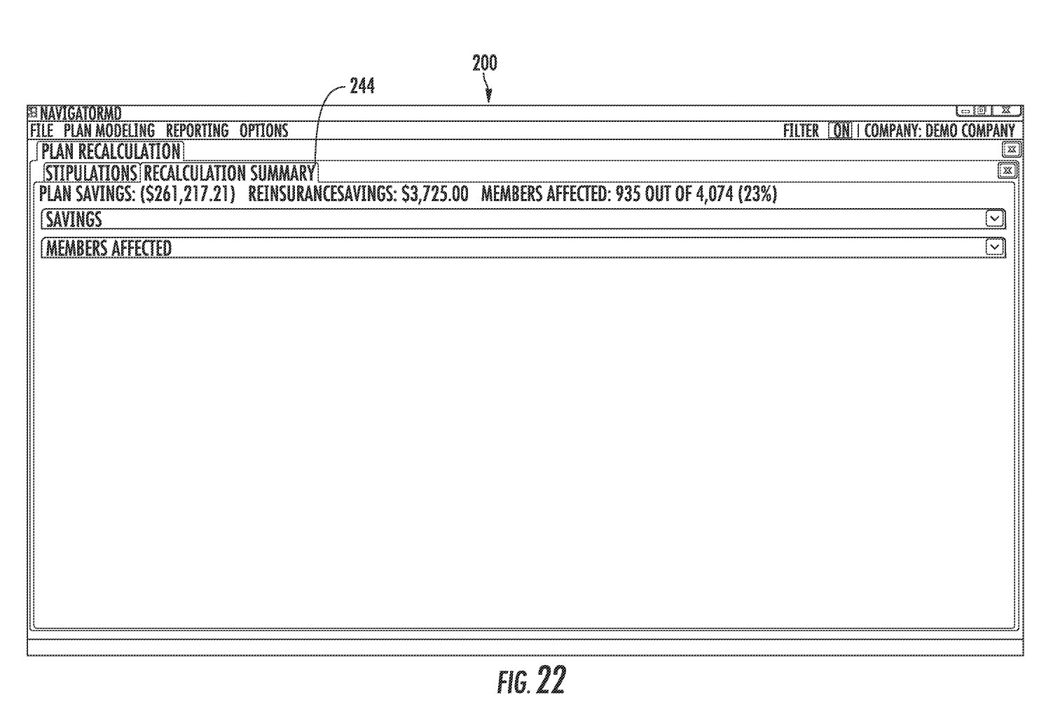

After the filter has been turned on and set as shown in FIG. 20, the user may close the filter and return to the plan designer as shown in FIG. 21. At this point, the plan is recalculated by activating the run model button 242 which is shown in FIG. 21. In response, the apparatus 100 analyzes the new plan and generates a recalculation summary report 244 as selected by the user. In this case, it generates FIG. 22 which shows that the new plan has an additional plan cost of $261,271.21, a reinsurance savings of $3,725.00, and the sub-population of members affected by the new plan is 735 members out of 4,074.

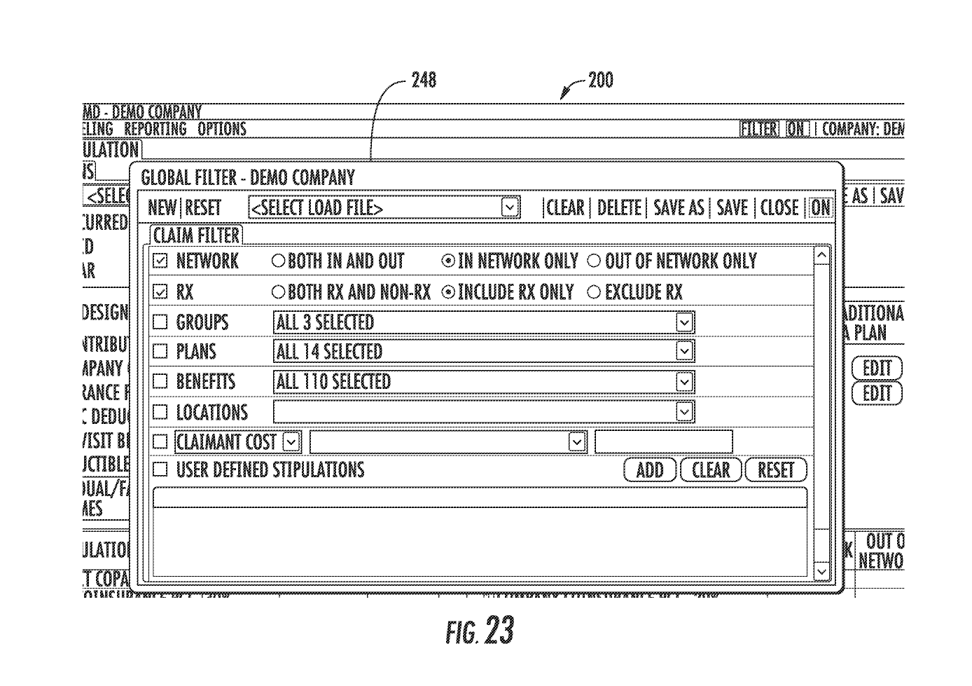

Returning now to FIG. 23, global filter menu 248, which allows a user to provide filter information to the global filter 116, will be described in more detail. In the previous example, the only filter applied to the population was the network filter. In FIG. 23, it is illustrated that a prescription filter could be applied to the selected population as well, by checking the “Rx” checkbox on the global filter menu. The user may select prescription and non-prescription claims, just prescription claims, just non-prescription claims, or some combination thereof, via the prescription filter.

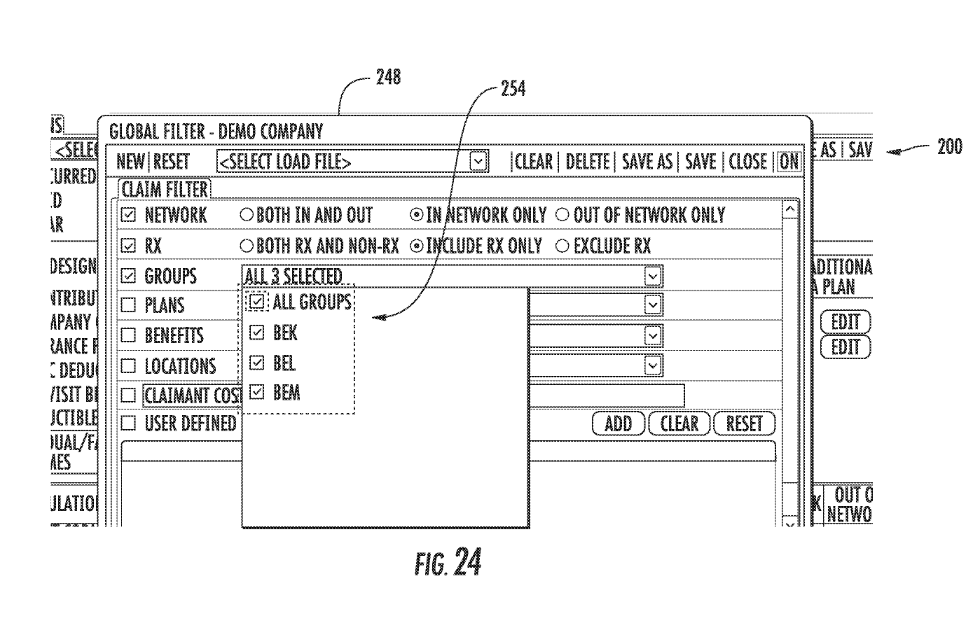

FIG. 24 illustrates a feature of the global filter menu 248 where different groups 254 of health care data may be selected for use by the global filter 116. In this case, a simplified example, it is shown that all groups 254 may be selected or one or more of three groups 254 may be selected. In this example, BEK, BEL and BEM may represent three different unique groups 254 within a larger population. For example, in a company these groups 254 may represent employees in particular cities or plant locations.

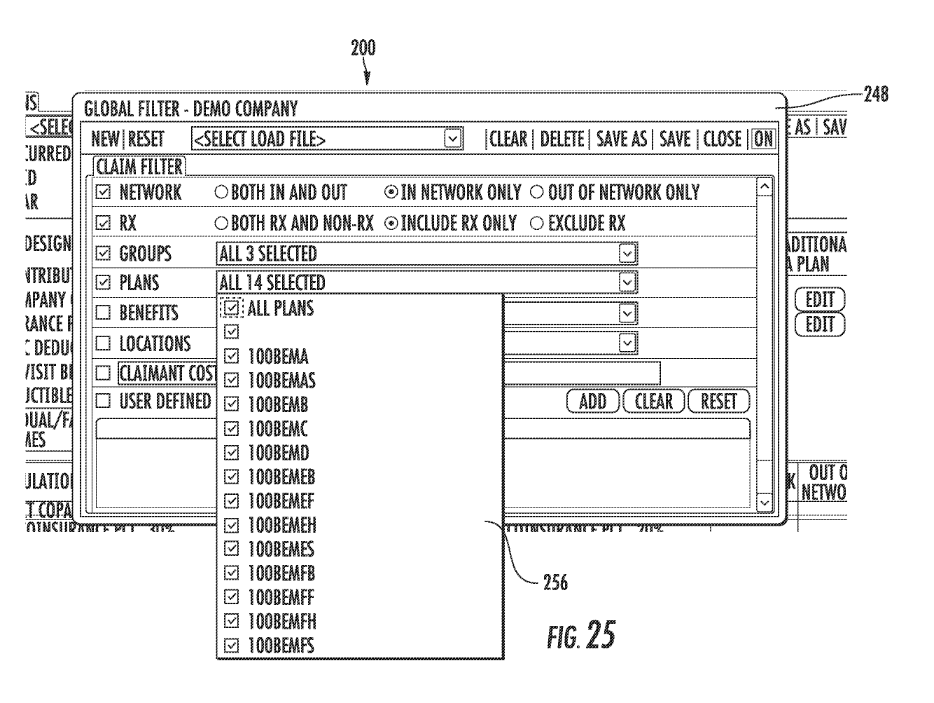

In FIG. 25, a plan selection menu 256 portion of the global filter menu 248 is shown. In most large insurance plans, the employees or other members are given the opportunity to select between different plans. In this case, the plan selection menu 256 may be used to select all fourteen plans or the user may select individual ones of the various listed plans by placing a checkmark beside the plan via the input device 108. In this case, all plans have been selected, but obviously, one, two, three or more individual plans could be selected for filtering purposes. In this manner, the user may configure the apparatus 100 to compare one plan against another plan or one group of plans against another group of plans.

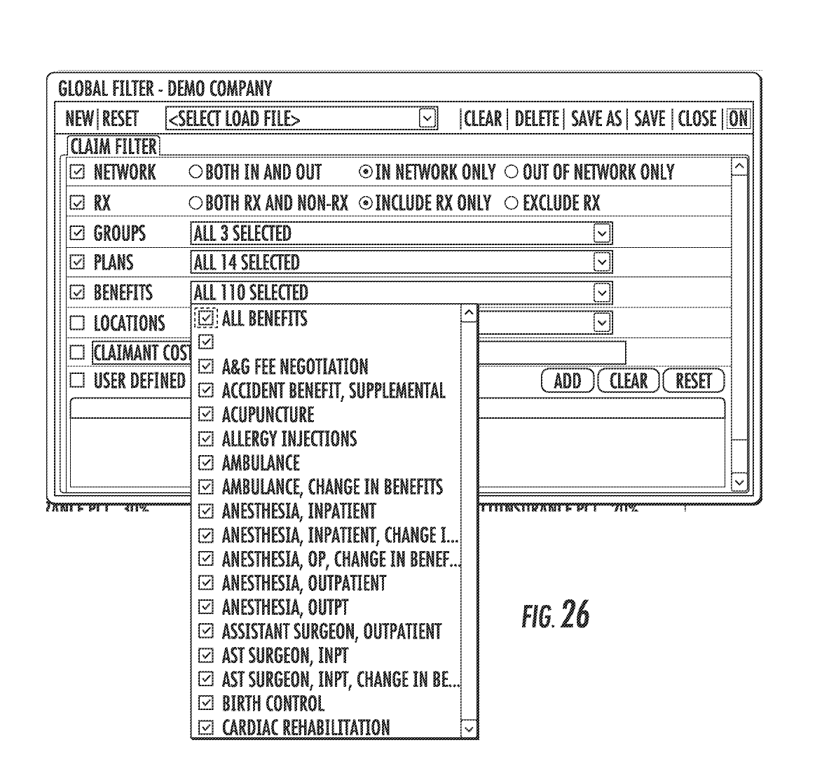

FIG. 26 illustrates that filters can be also modified to select various benefits. In this case, all one hundred and ten benefits are selected. However, if desired, the user may select one or more of the individual benefits and the filter 116 will provide the analyzer 118 with only those claims that fit within the selected benefit category or categories. The data analyzer 118 may then transmit the desired filtered and analyzed health care data to the report generator 122, which may then format and output the desired report to the display device 106.

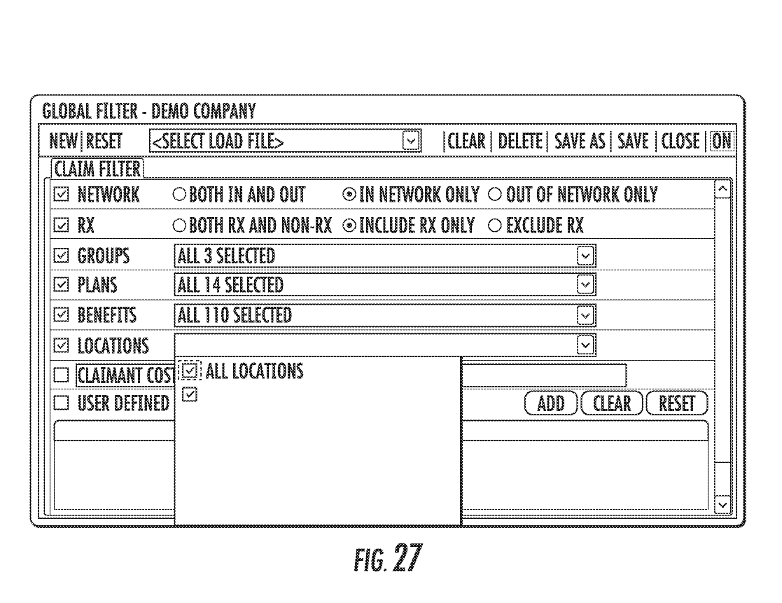

Referring to FIG. 27, it is shown that the filter is capable of filtering on the location of the individual patients or claimants. In this example, however, there is only one location or no separate locations are reported. Thus, it would not be possible to filter on particular locations. However, in other health plan databases, a company may have employees in numerous different cities and these locations could be recorded in the healthcare data and filtered upon using this particular feature of the filter.

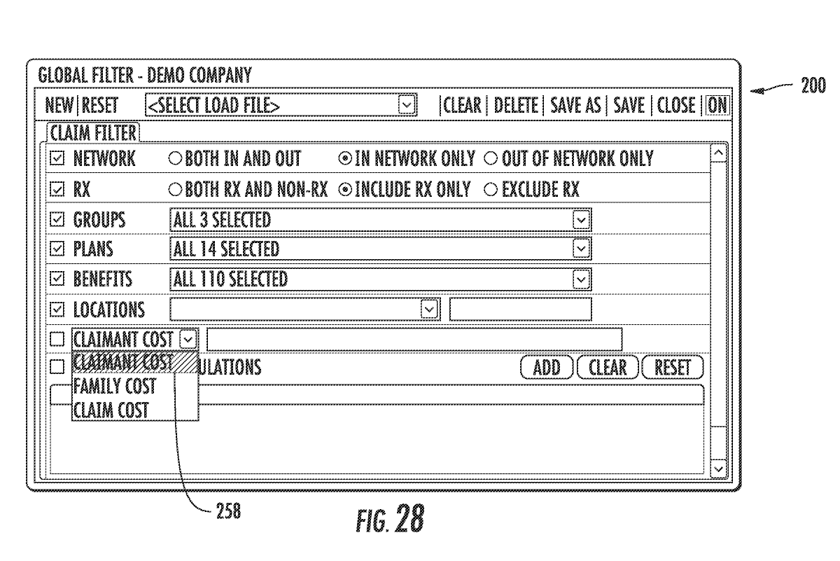

The aggregate cost filter 258 as shown in FIG. 28 is a somewhat different type of filter than those described above. In this case, the aggregate filter 258 can be used to aggregate cost in groups according to the cost for a particular claimant, the cost for a particular family, or the cost for a particular type of claim. This ability to aggregate is not only an important tool in analyzing data, but also an important tool in designing insurance plans and is therefore very useful in conjunction with the analysis capabilities of the present data processor 102.

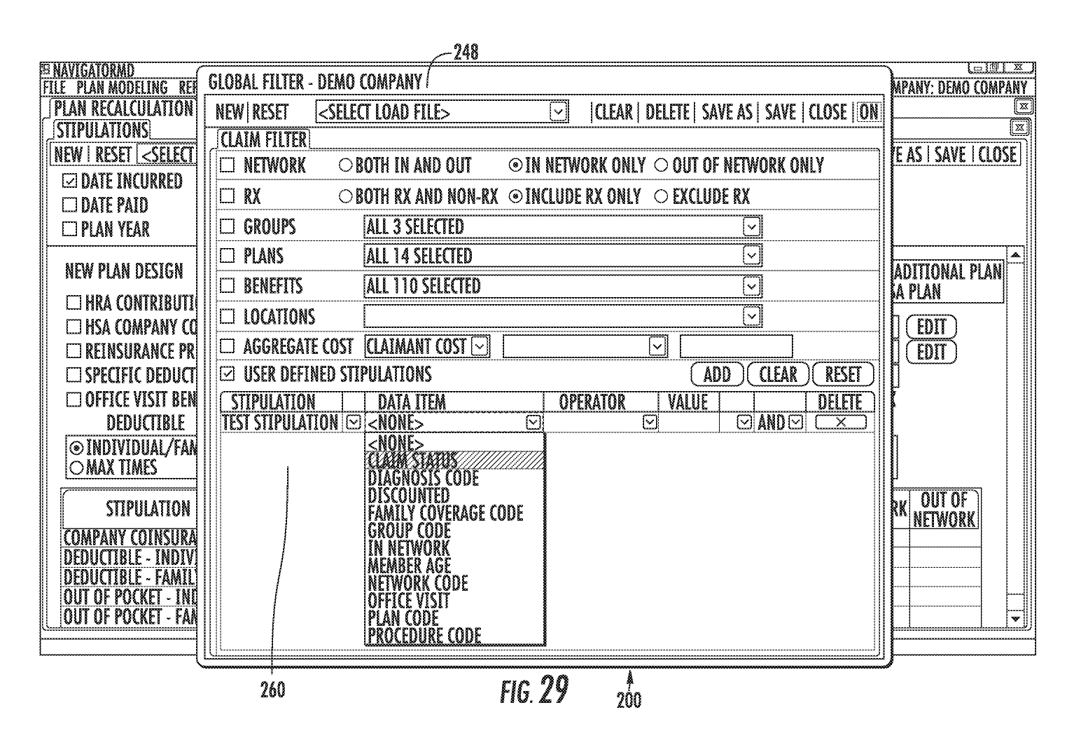

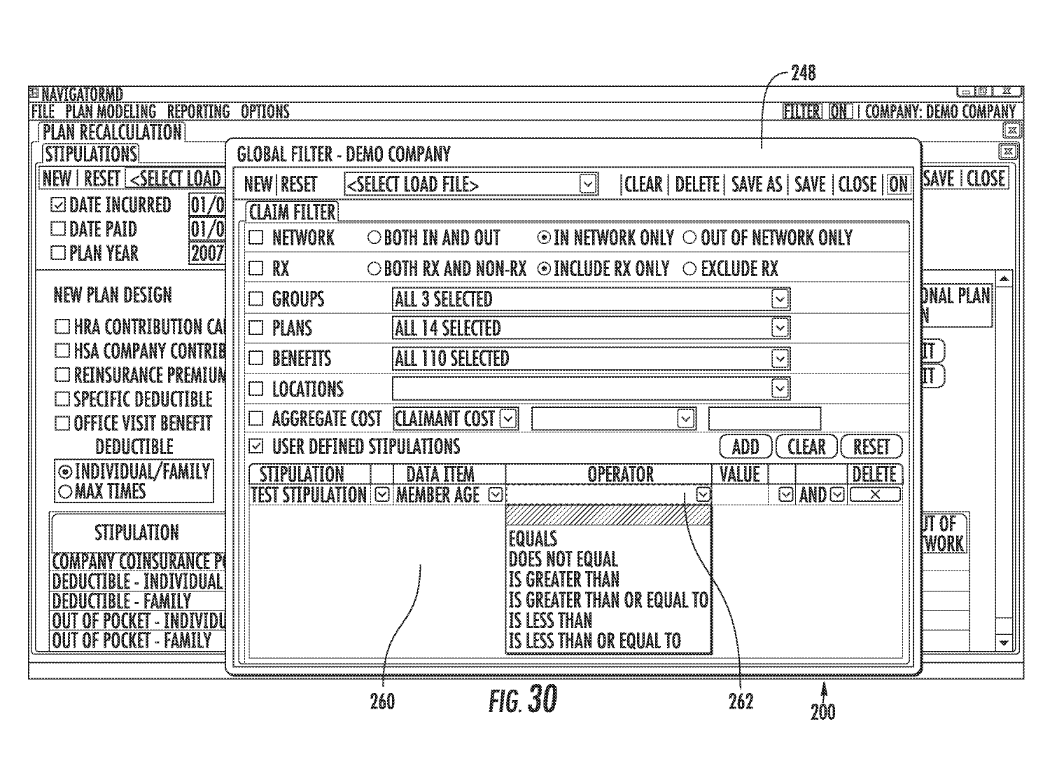

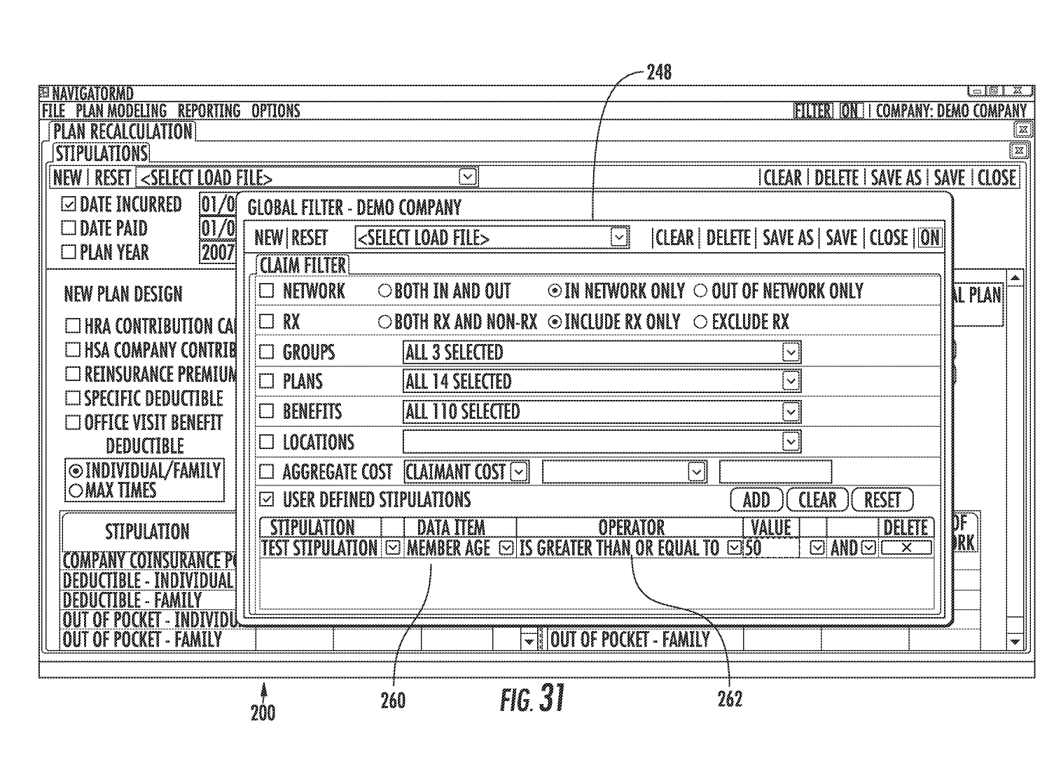

Referring to FIG. 29, it is shown that global filter menu 248 may also allow the user to define stipulations via a user-defined stipulation menu 260 and thereby create a particular type of filter. The user-defined stipulation menu 260 may interface with the global filter 116 to provide one or more specific stipulations to the global filter 116. The stipulations may include one or more particular data items as illustrated in FIG. 29. The user may select an operator 262 on the data item as illustrated in FIG. 30, and the user may further select a value for the operator 262 as illustrated in FIG. 31. In this particular example, the stipulation requires a member having an age that is greater than or equal to 50. Thus, the global filter 116 will only provide health care data on members having an age greater than or equal to 50 years to the analyzer 118 and/or the report generator 122. To clarify, the user input stipulation is age 50, and the operator is the greater than or equal to operator.

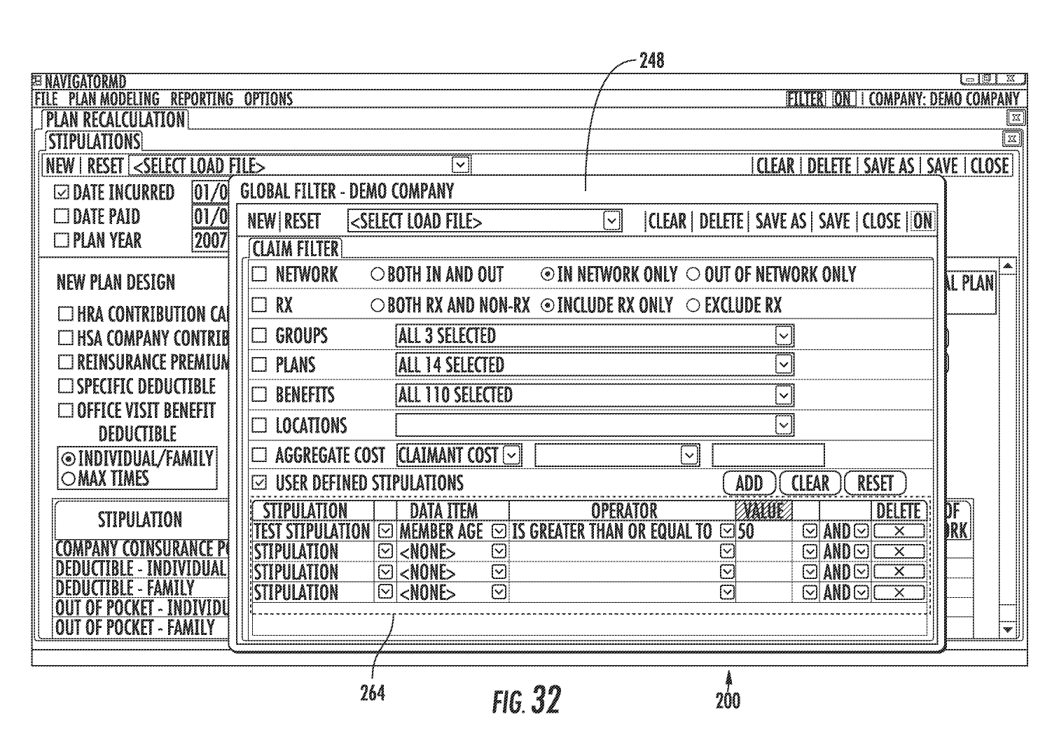

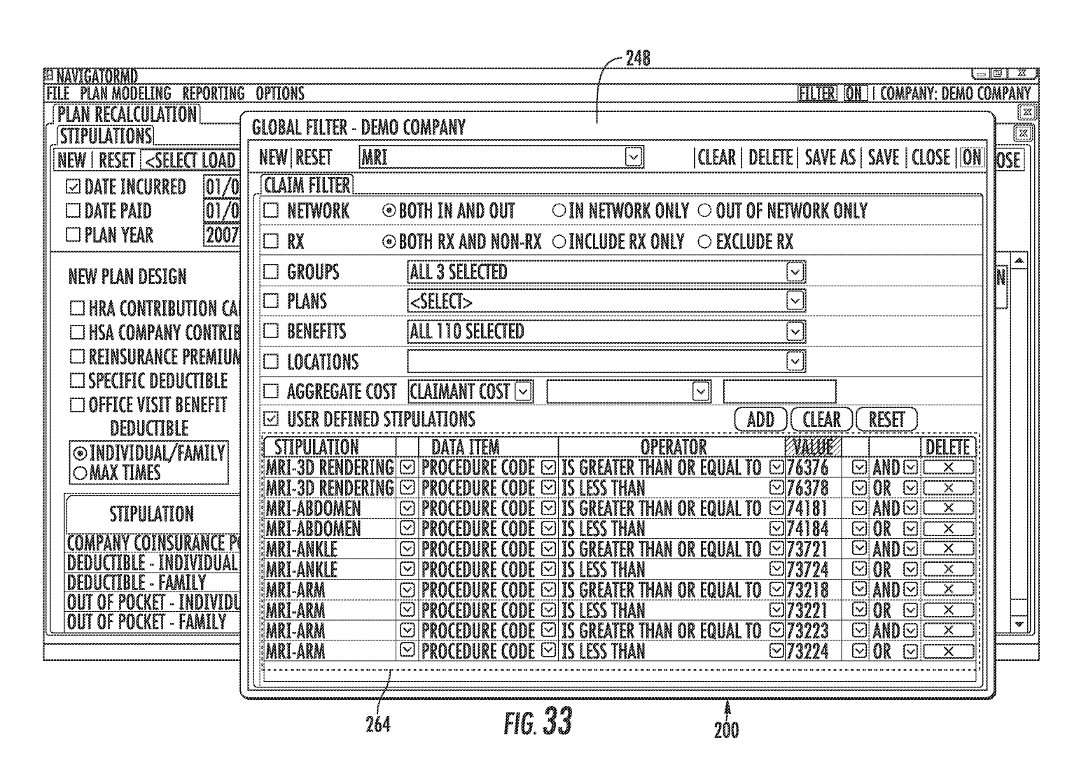

FIG. 32 is provided to illustrate that the user can create numerous different stipulations as a group 264, all of which constitute user defined filters. In FIG. 33, a highly technical user defined a group of stipulations 264 that is provided to illustrate that complex analysis of the data is possible with the global filter parameters selected in FIG. 33.

Having discussed the filtering capability in some detail, the illustration in FIGS. 2, 3 and 4 should be more meaningful. It would be appreciated that the report generator 122 of the present disclosure that provides reports on the healthcare data has equal access to the global filter 116 as does the plan analyzer 118 and the plan designer 120. This is indicated by the fact that the filter can be turned on or off when creating reports or analyzing or designing plans. Thus, once designed, a complex filter that is available to the report generator 122 may also be available to the plan designer 120 and/or the data analyzer 118 of the apparatus 100.

The seamless combination of a global filter 116 capable of providing subpopulations in combination with a plan designer 120, a data analyzer 118, and a report generator 122 creates an integrated apparatus 100 for health plan analysis and design. Furthermore, the ability to filter on selected parameters such as claims that do not create a unique subpopulation and apply those filters from within a health plan analysis program is also highly useful for designing, analyzing, and reporting estimated health plan costs and benefits.

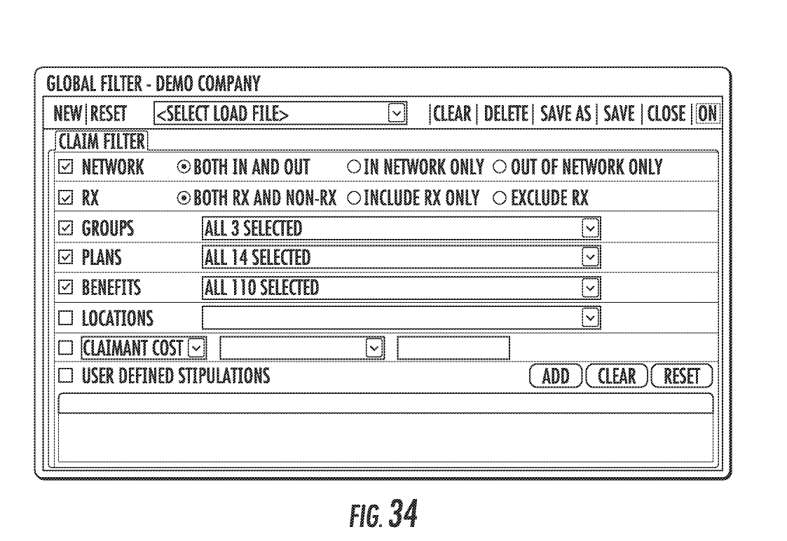

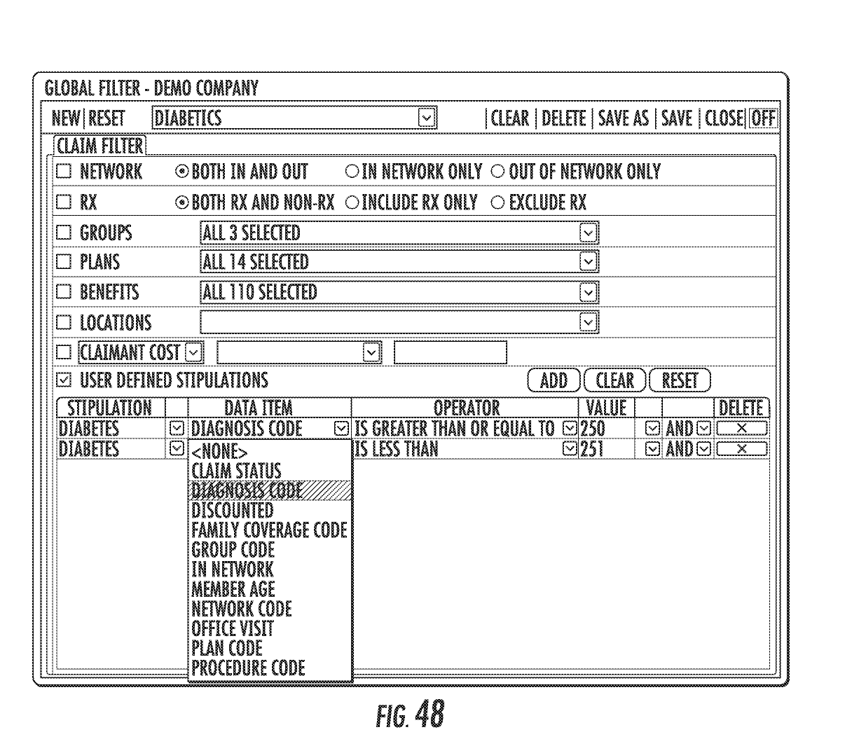

FIGS. 34-71 illustrate further and more detailed examples of the operation of the global filter 116 in combination with the report generator 122, the heath plan designer 120, and the health plan data analyzer 118, as accessed through the user interfaces of the program modules of the apparatus 100. The figures are substantially self-explanatory, as will be appreciated by a person of ordinary skill in the art, but are described in further detail below. However, the operation and interaction of the components of the data processor 102 are described in detail above, and need not be explicitly repeated in the subsequent examples. A person having ordinary skill in the art will appreciate and understand the examples described below in light of the more detailed previous examples.

Referring now to FIG. 34, the filter menu is again shown and as indicated by the “on” button in the far right corner, the filter is on. Both in-network and out-of-network claims, prescription and non-prescription claims, all three groups, all fourteen plans, and all 110 benefits have been selected.

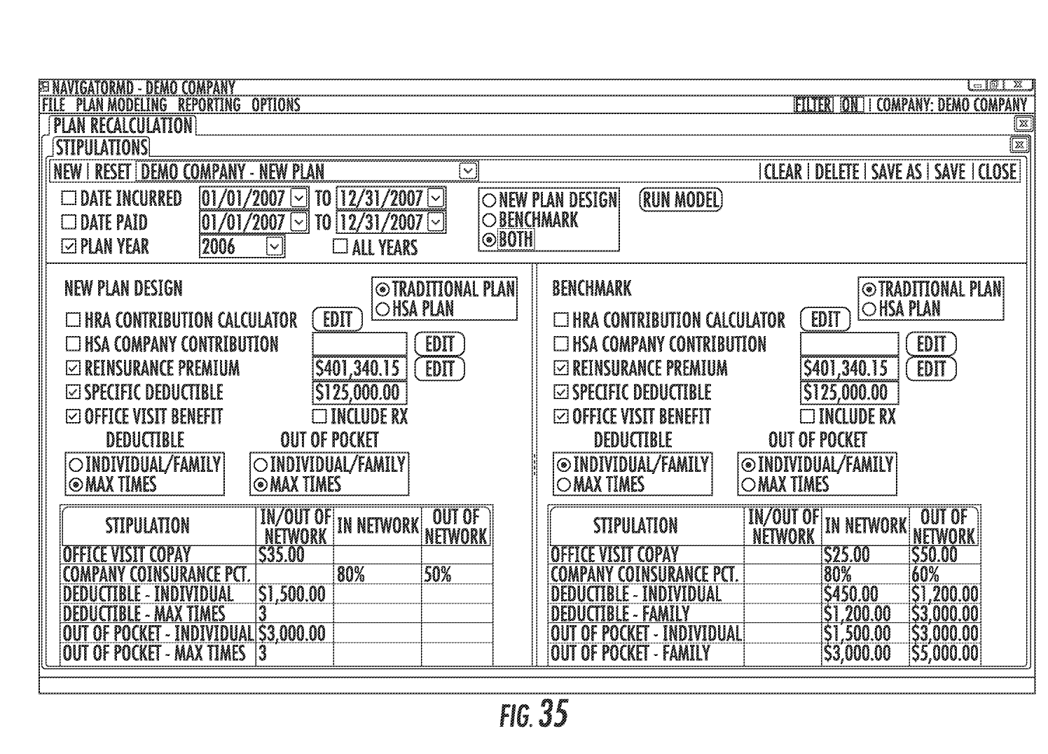

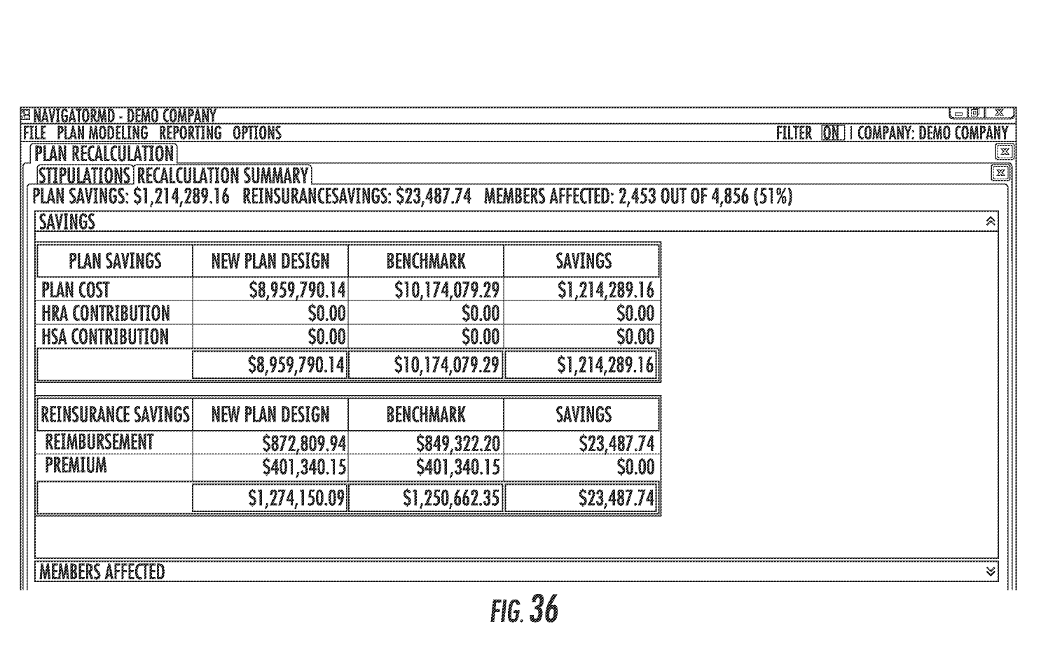

FIG. 35 shows the plan designer screen with a new plan design and a benchmark plan design operating with the filter on. The savings realized by the new plan as compared to the benchmark plan is shown in more detail shown in FIG. 36.

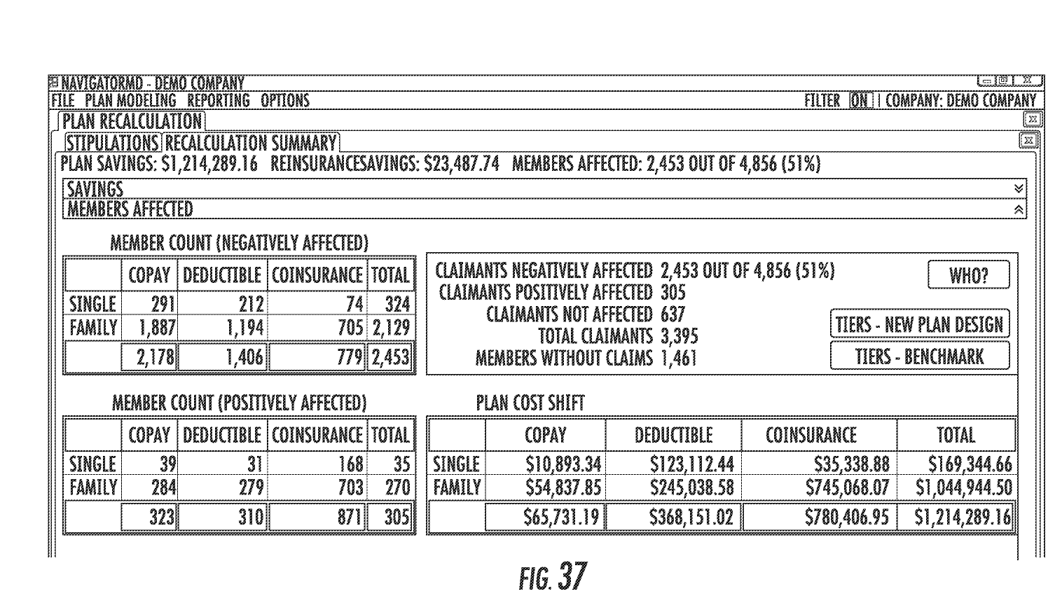

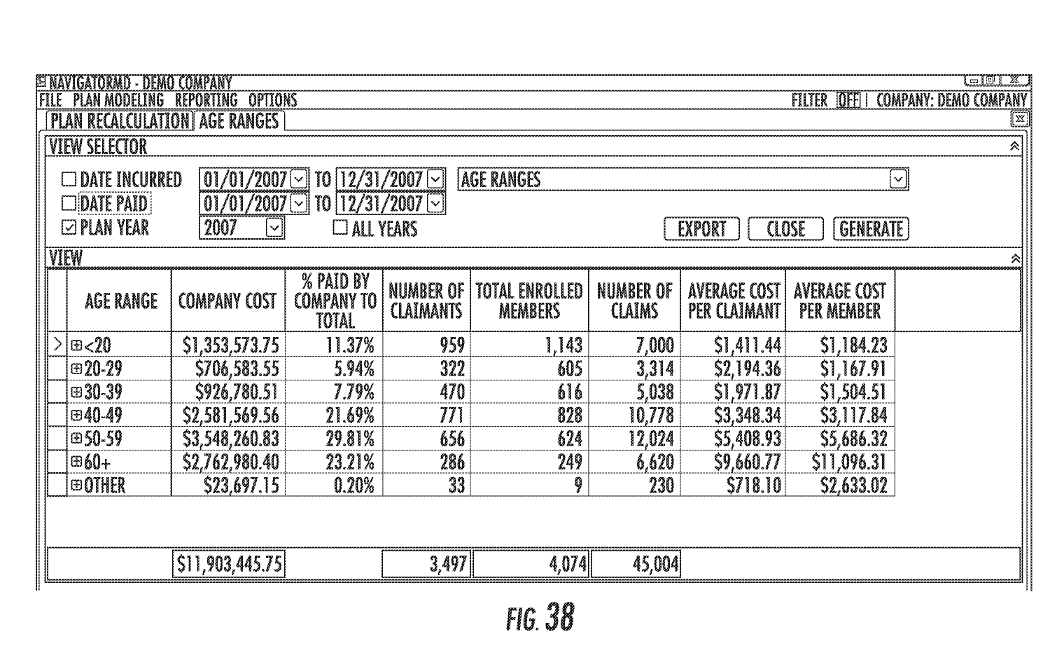

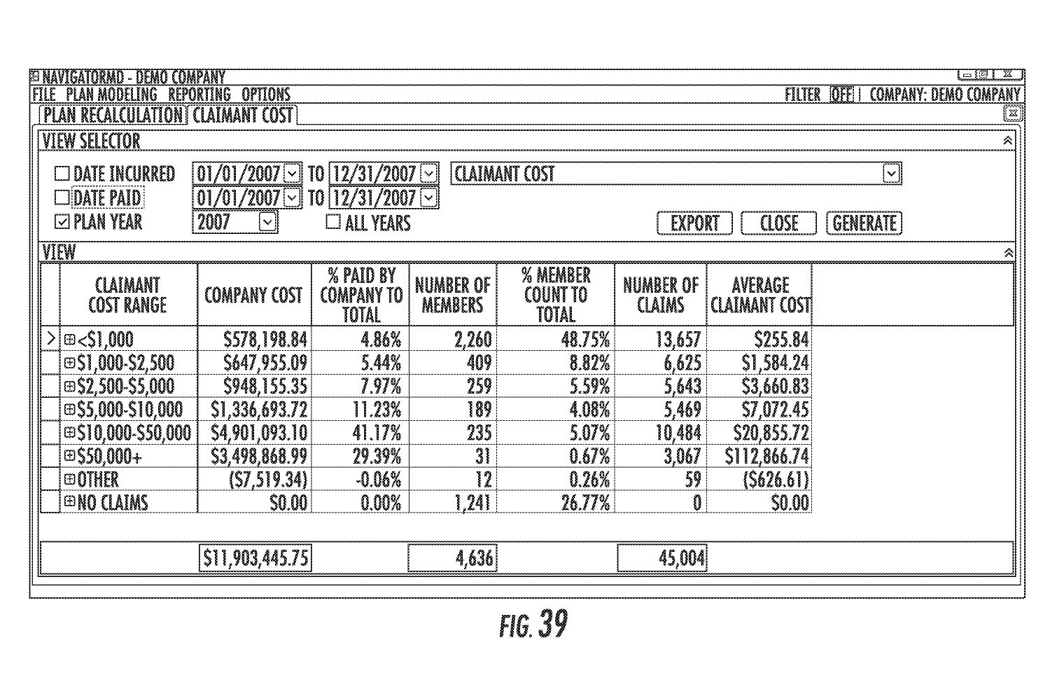

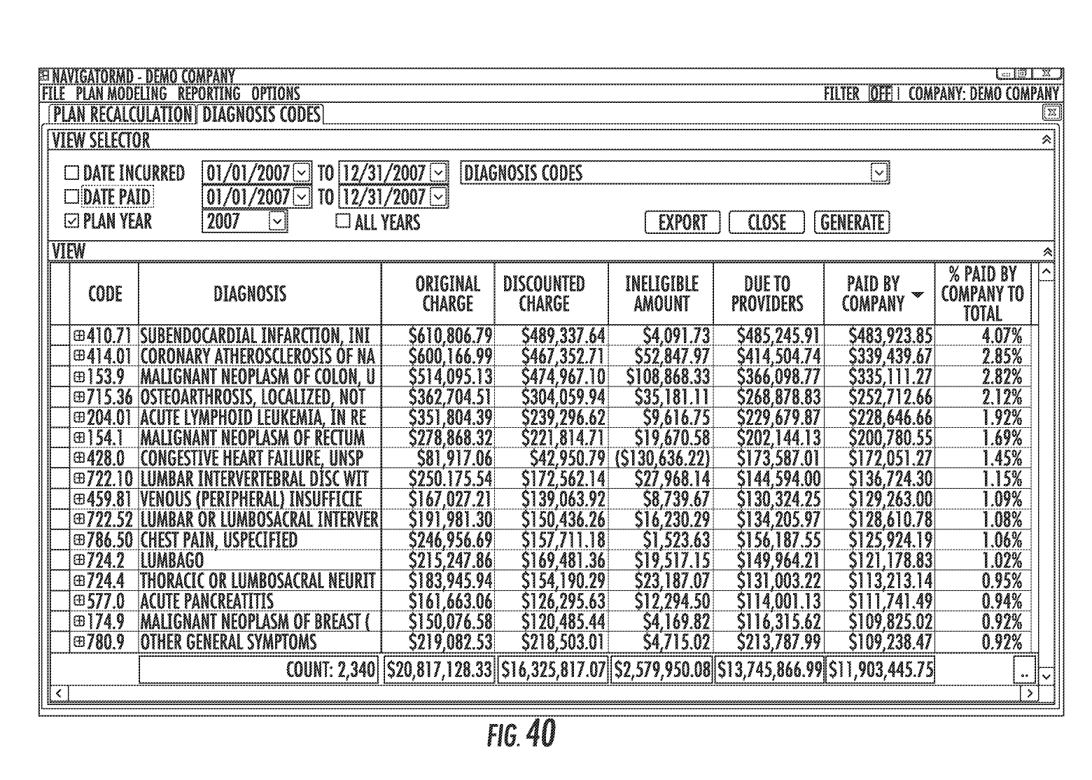

In FIG. 37, the members affected by the new plan as compared to the benchmark are shown in detail. In FIG. 38, an age range report is shown for the entire population. A claim size and claimant analysis is provided in FIG. 39, and a diagnosis view is shown in FIG. 40. In this case, heart problems constitute the first and second most costly claims for the company and malignant colon represents the third most costly diagnosis. All of the above information is provided by the plan designer with the filter turned on as described earlier.

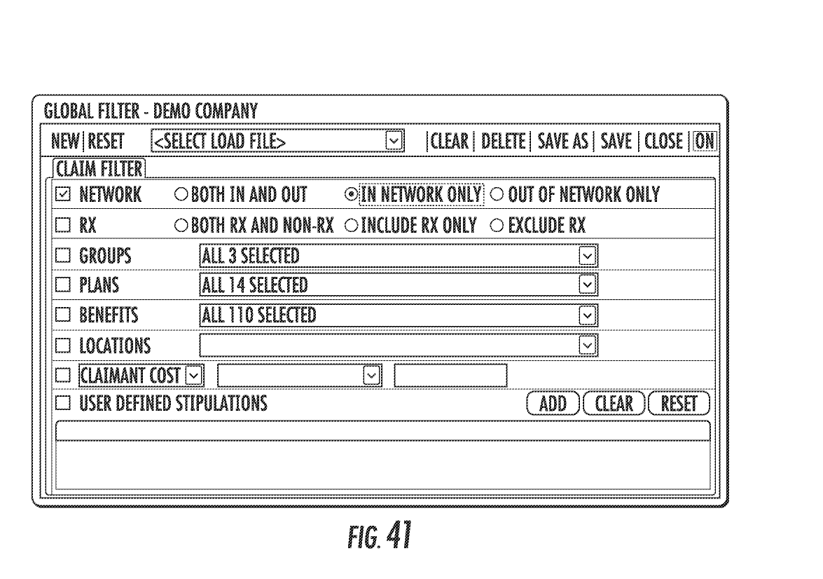

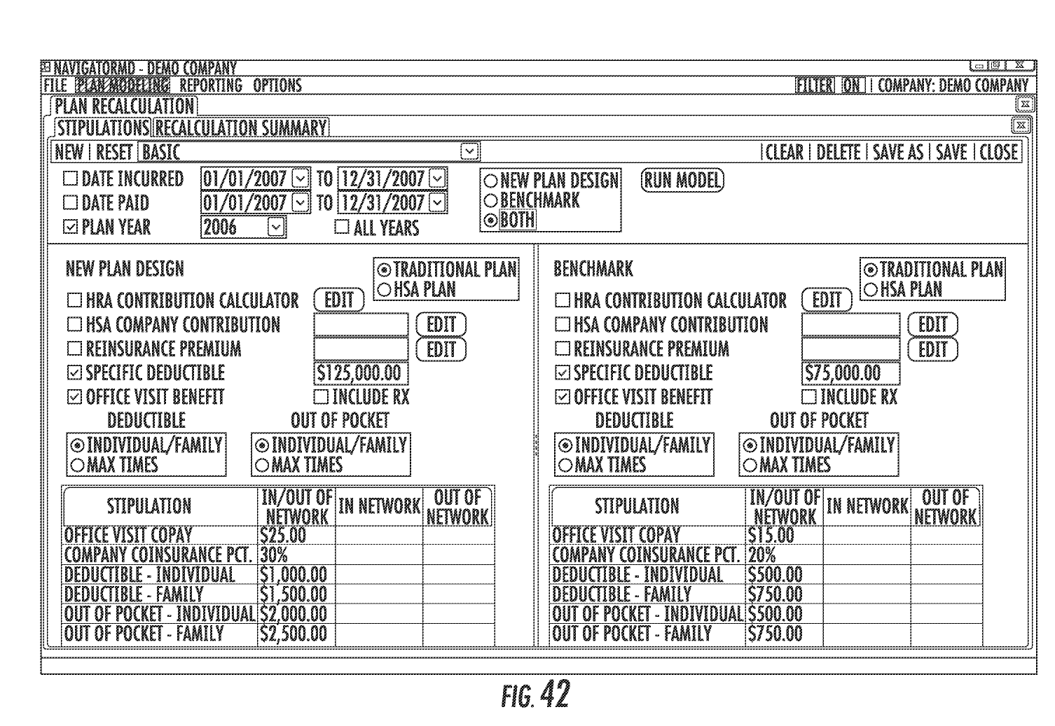

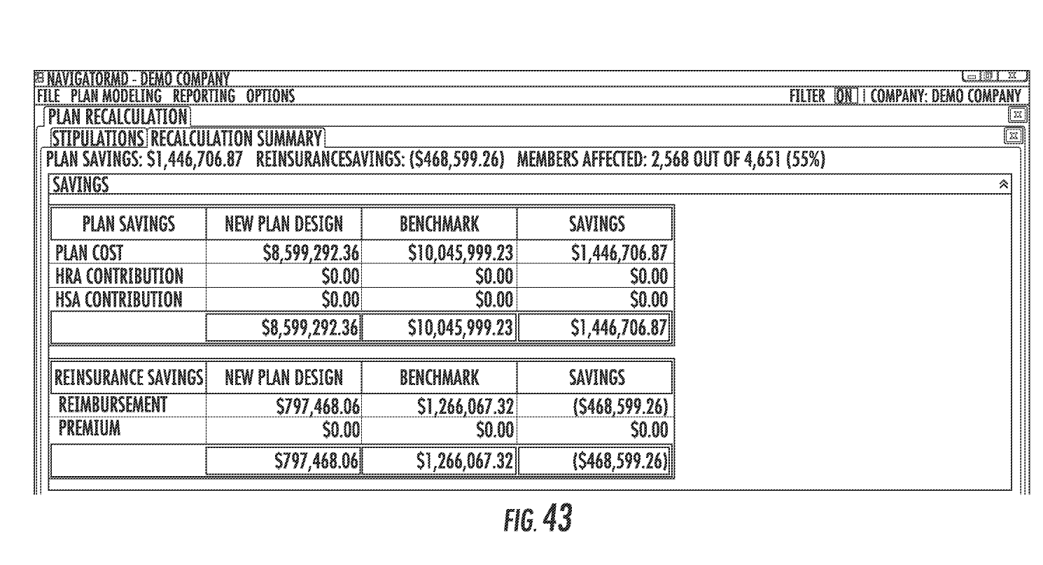

In FIG. 41, it is shown that the network filters have been changed and in-network claims only have been selected. Note that the filter is turned on but is different. In FIG. 42, the plan designer screen is again shown and in this case, it can be seen that the filter button is “on” indicating that the filter is being applied to the claims, in this case to select only in-network claims. It will be recalled that this type of filter does not create a unique subpopulation because individuals can have both in-network and out-of-network claims. Thus, this type of filter will have a special meaning when the effect on individual members is being analyzed. The savings after recalculation for in-network claims only is shown in FIG. 43. In this case, the plan saves almost $1.5 million dollars, but the added reinsurance cost is $468,599.26. 2,568 members out of 4,651 members are affected, but it will be recalled that these affected members may be both inside the data set being analyzed and outside the data set being analyzed.

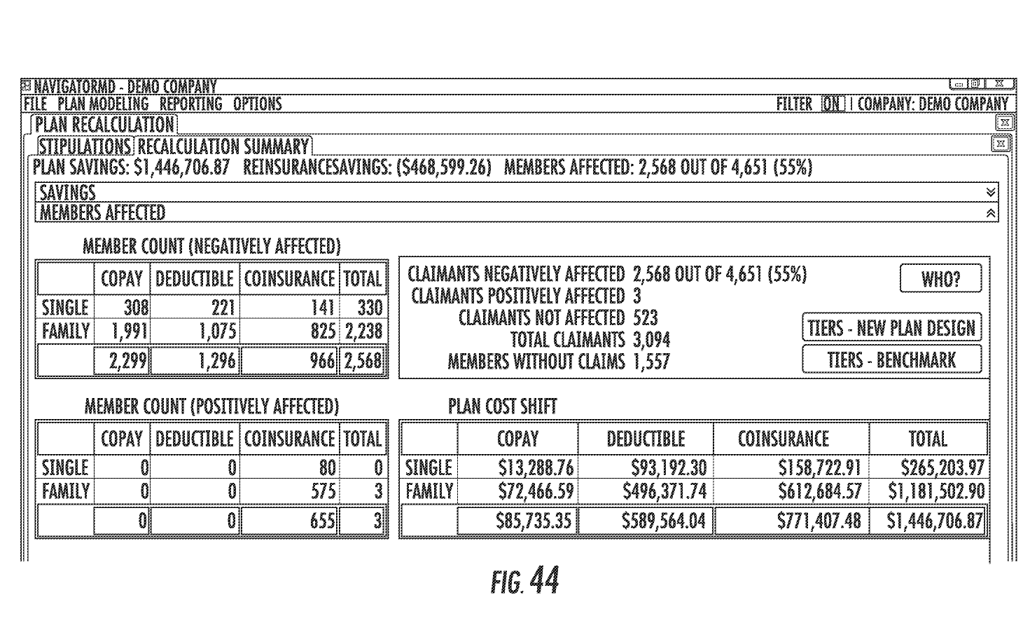

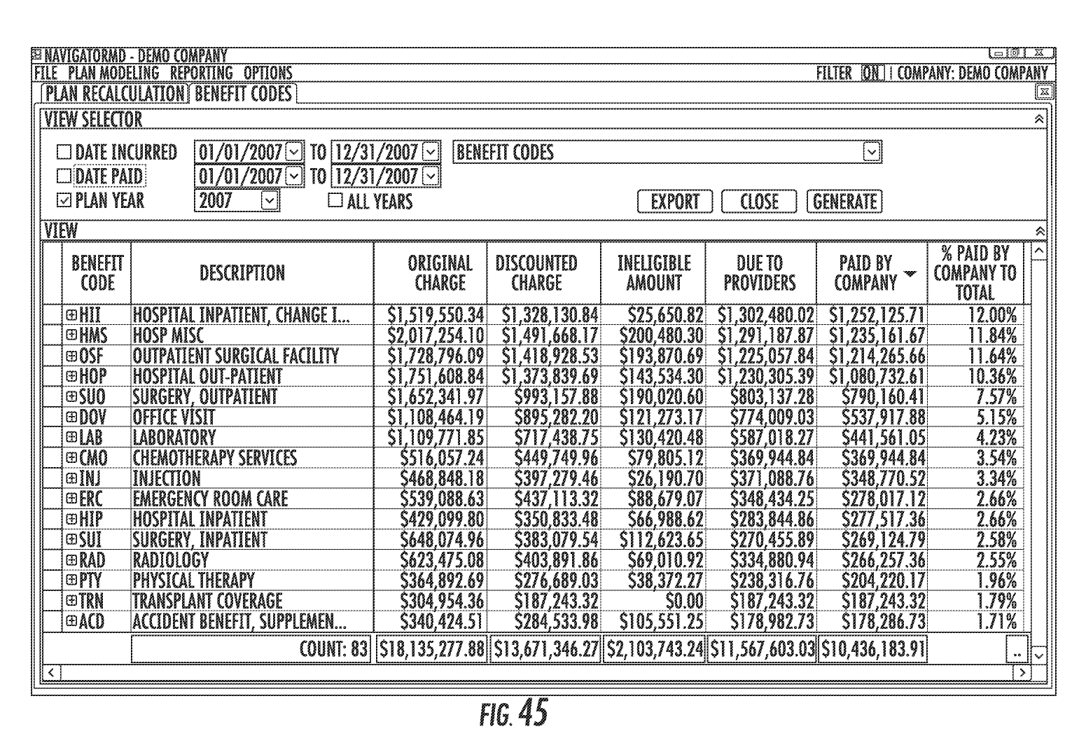

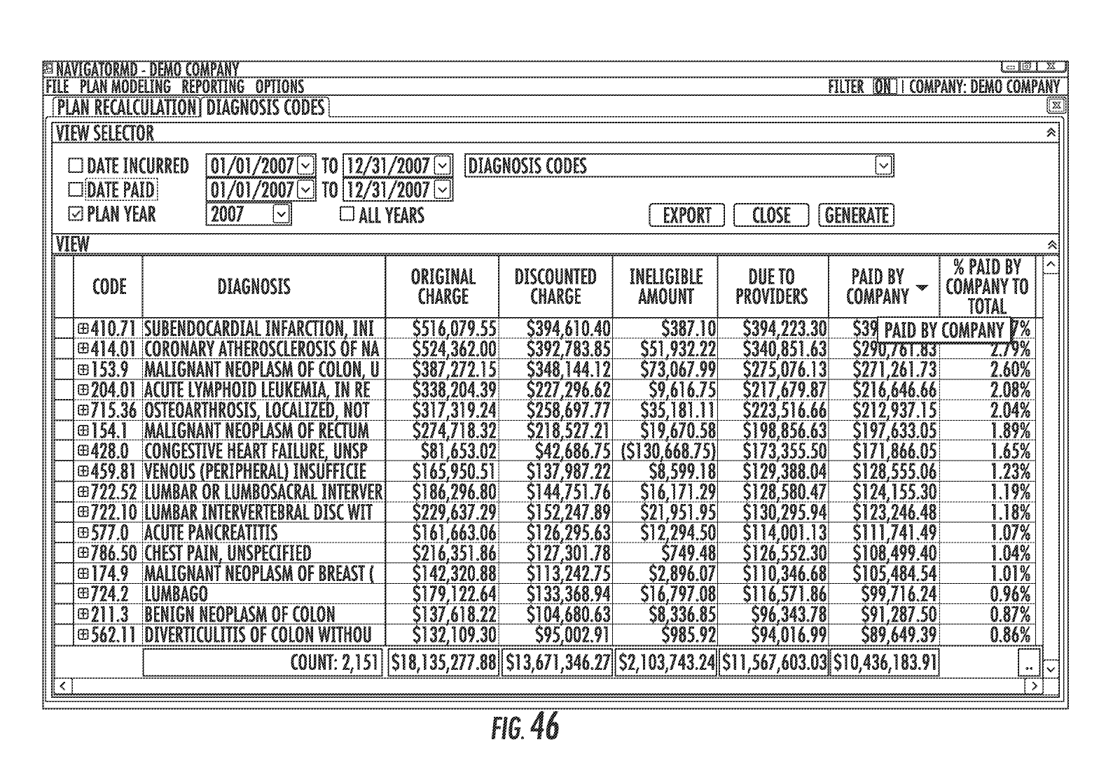

FIG. 44 provides further details of how the members may be affected, with respect to in network claims only. In FIG. 45, the output from the report generator 116 is shown based on benefit codes. Again, the filter is on and these claims represent claims only for in-network, which are health care resources that are within the insurance plan network. Typically, in-network claims are paid at a higher percentage than out of network claims. A report showing an analysis of diagnosis codes for in network claims is shown in FIG. 46.

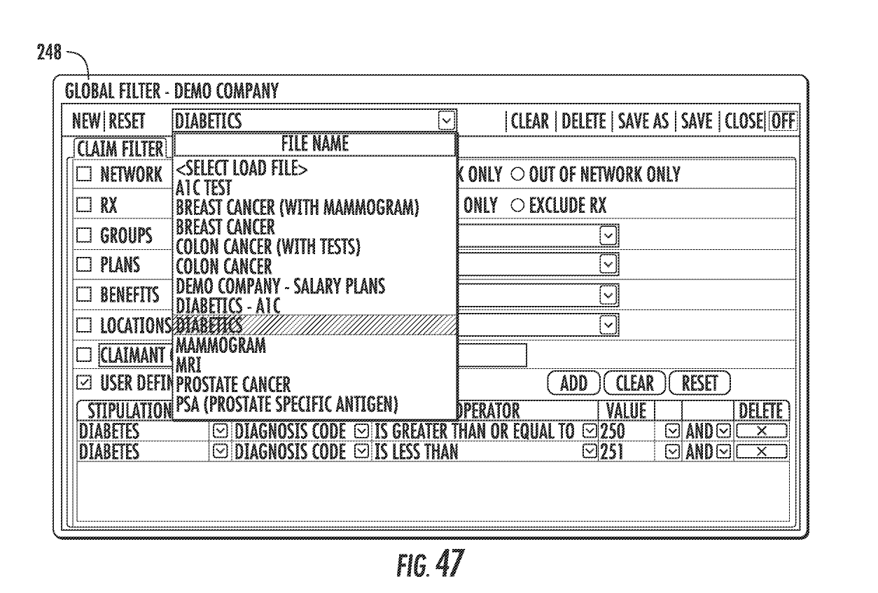

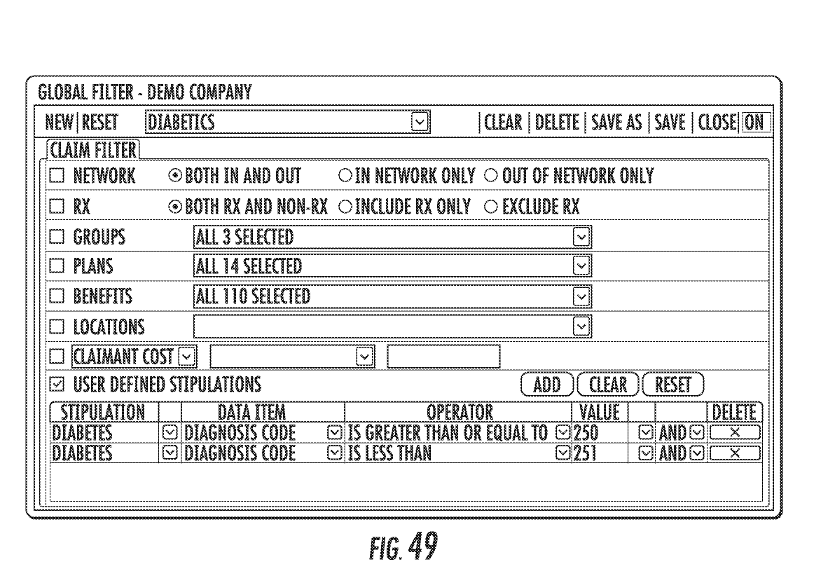

FIG. 47 illustrates the user going immediately back to the global filter menu 248 and selecting a different type of filter. In this case, a number of filters have been created in advance allowing the user to quickly select the type of filter that is desired. In this case, a diabetic filter is selected so that only diabetics are analyzed. It will be noted that the diabetics are defined by using the user defined stipulations and stipulating diagnosis codes greater than or equal to 250 or less than 251. Thus, only one code is being selected. However, that one code will extend to all non-integer codes greater than or equal to 250 and less than 251, as illustrated in FIG. 49. Thus, in this example, diabetics are defined as the subpopulation group.

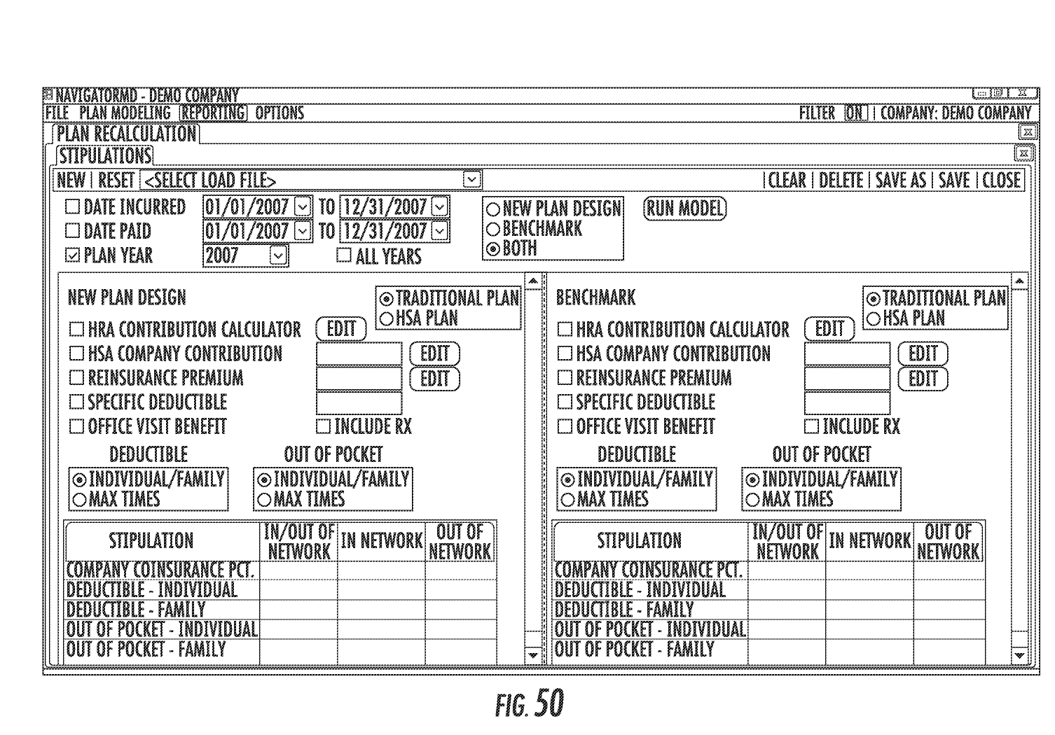

Referring to FIG. 50, the plan 120 designer has been re-opened and again it is noted that the filter is on, this time filtering such that only diabetic claims are shown.

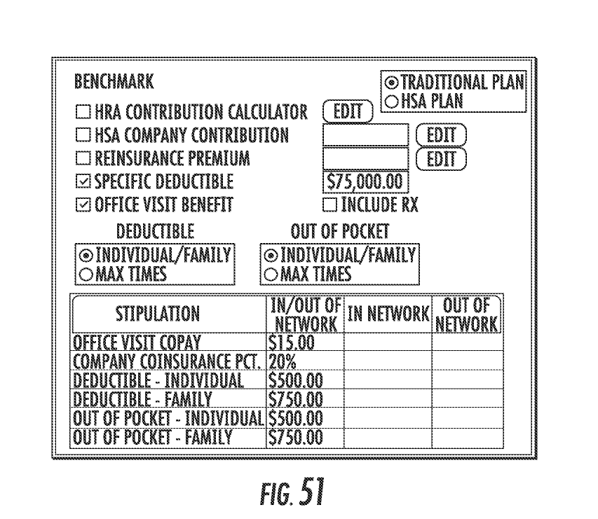

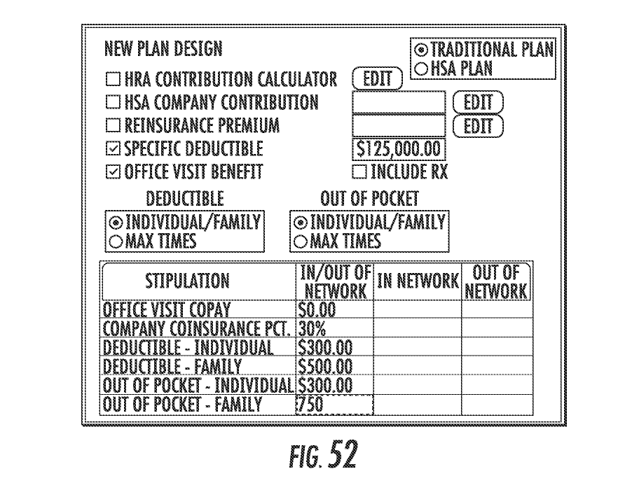

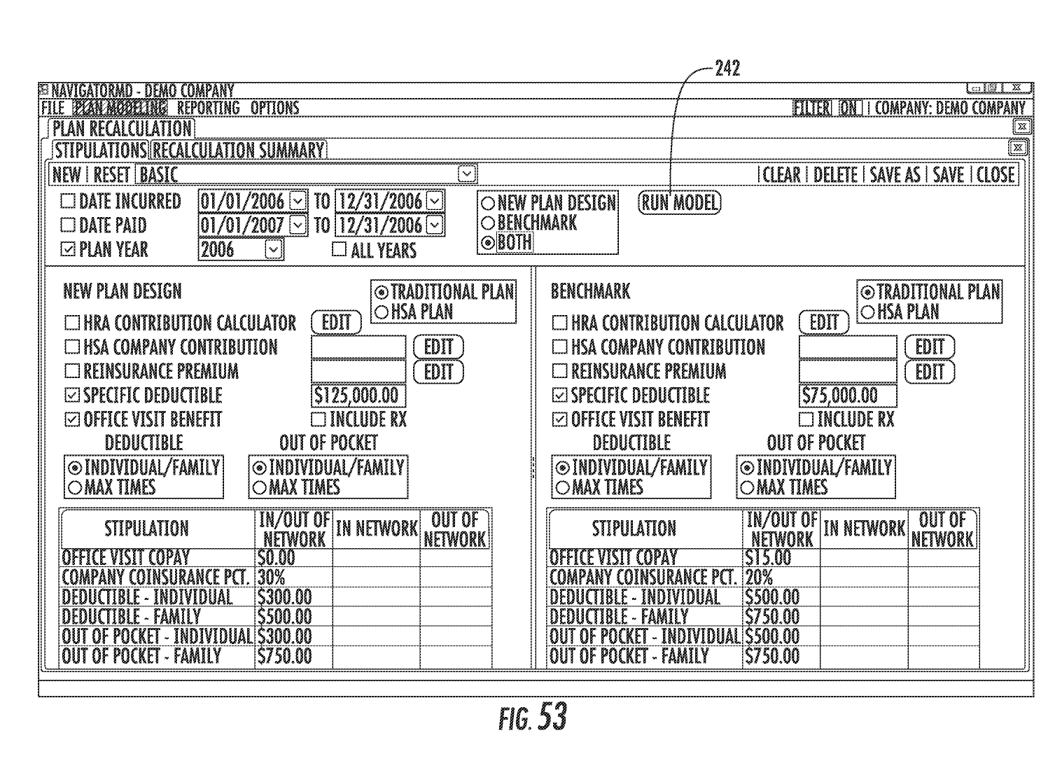

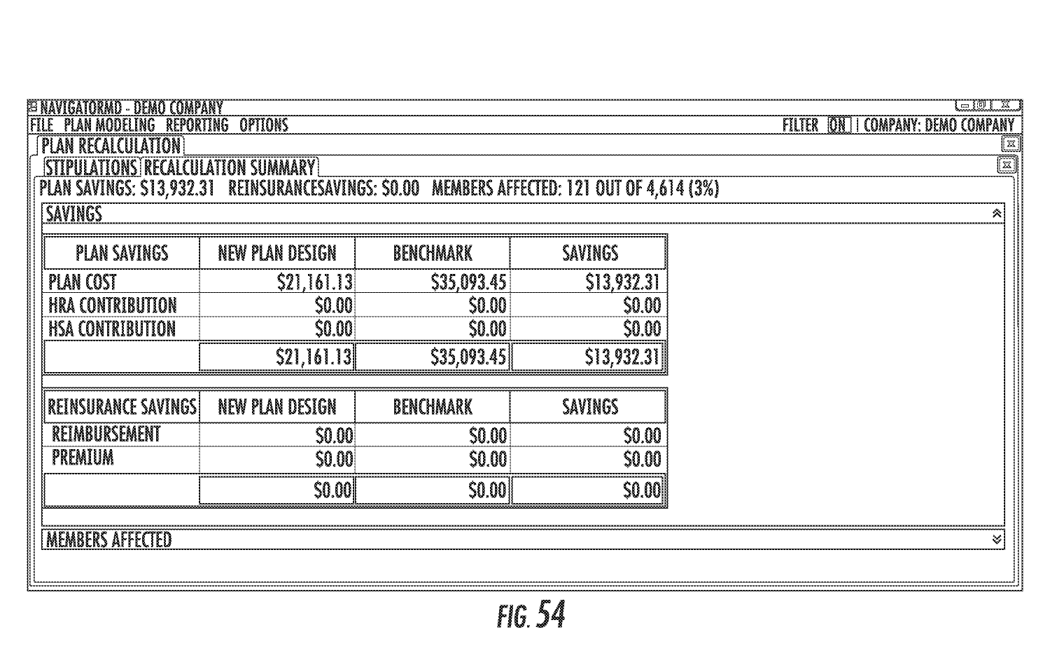

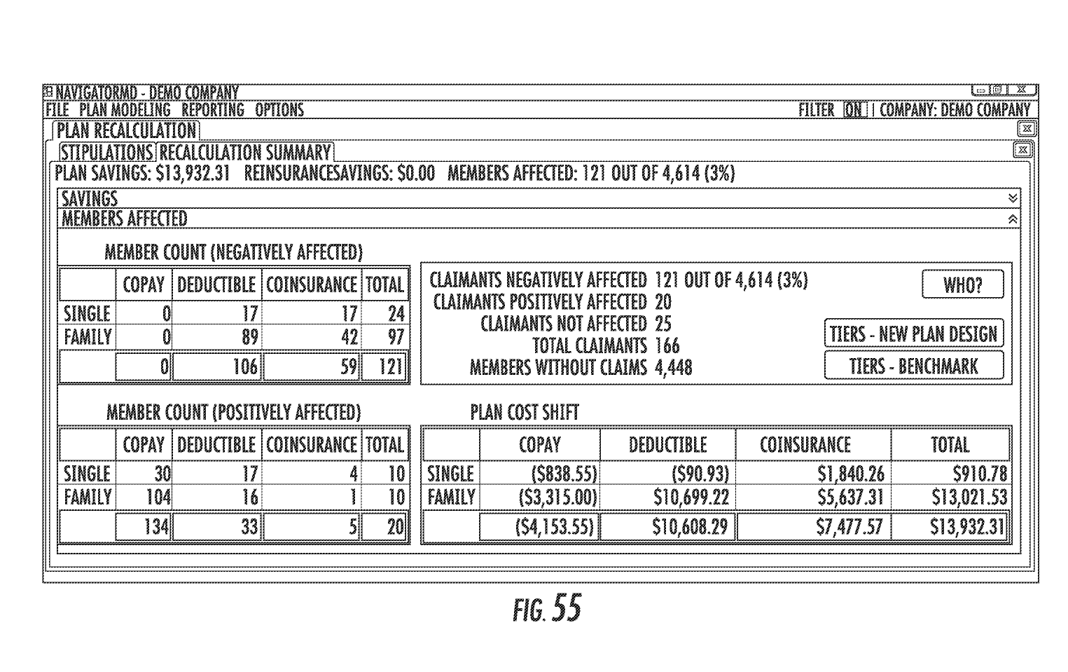

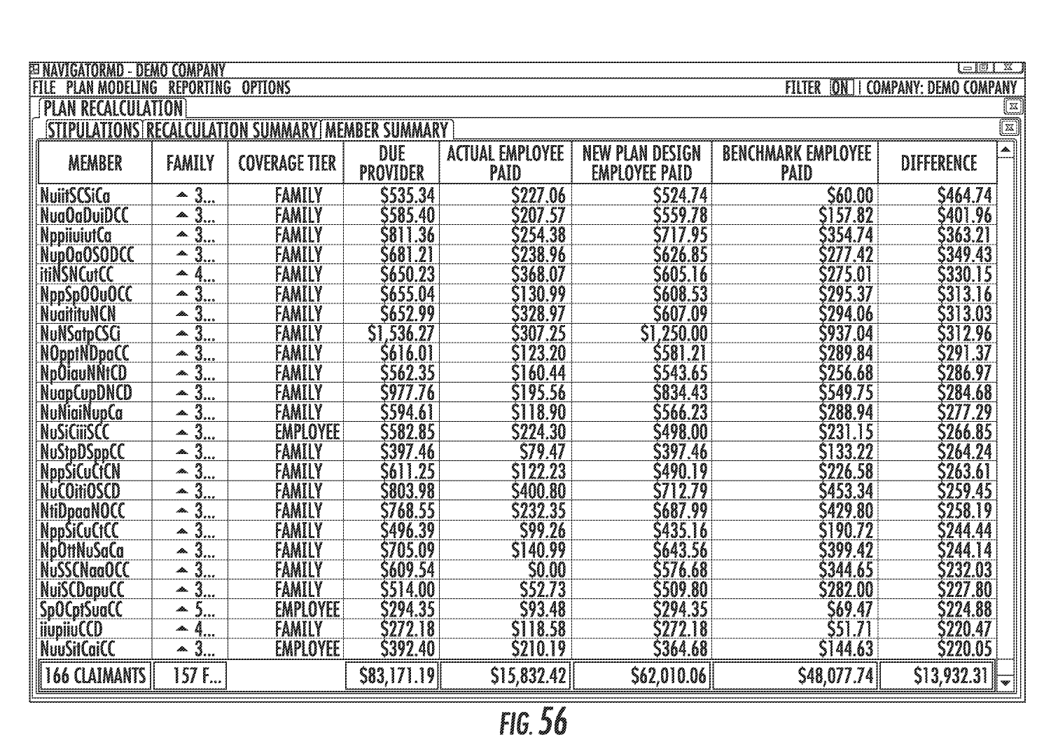

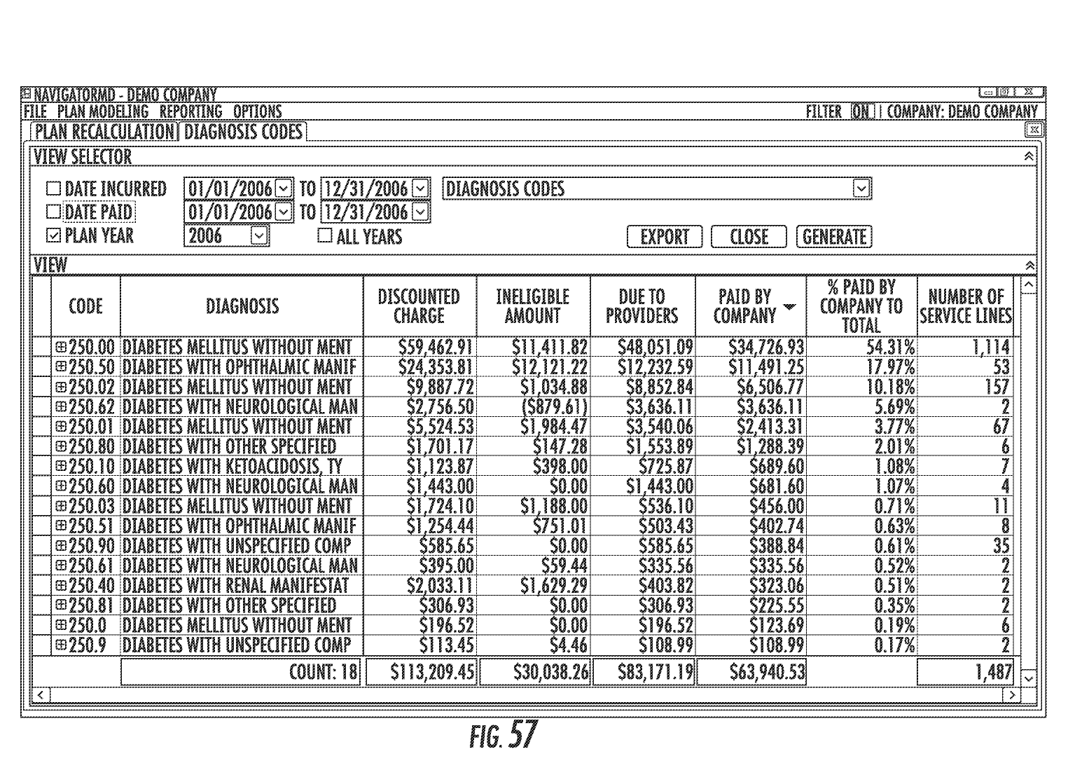

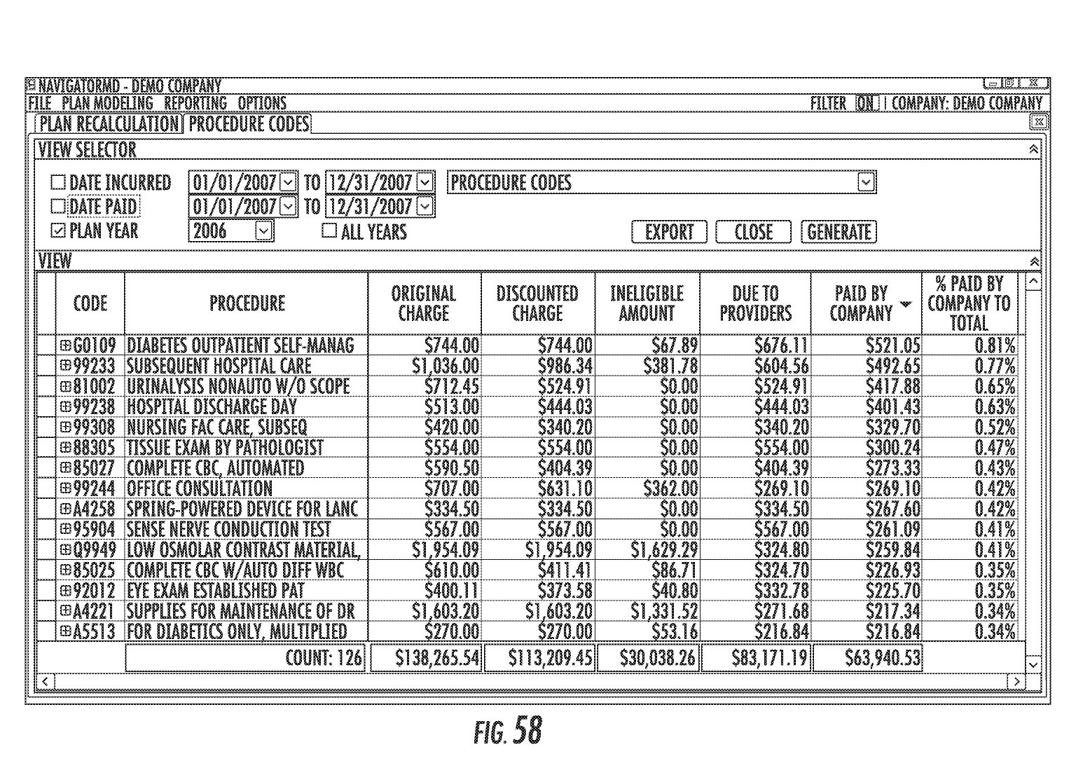

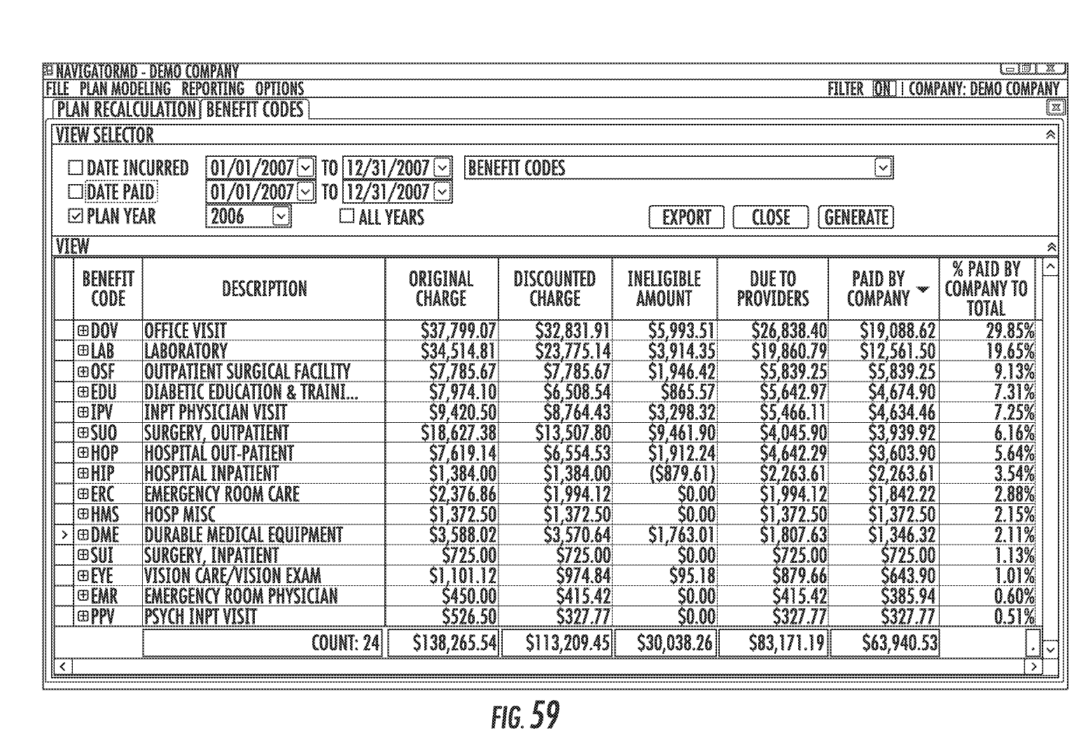

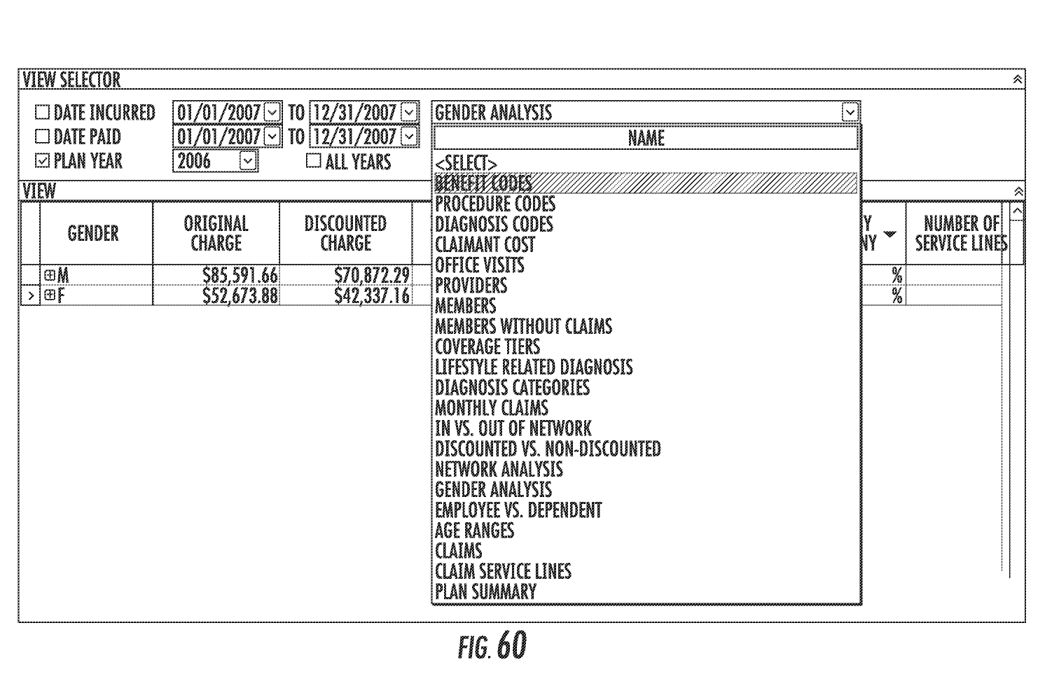

In FIG. 51, a close-up view is shown of the benchmark area of the plan designer 120 using a traditional plan design. In this example, the stipulations may be applied to both in and out of network charges. In FIG. 52, a new plan is shown. After the benchmark and new plan design parameters are selected as desired, the run model button 242 is activated as illustrated in FIG. 53. The data analyzer 118 receives filtered data from the global filter 116 and transmits the filtered data to the report generator 122, which formats and outputs a recalculation summary, as illustrated in FIG. 54. Again, the user may further analyze the data in the report by displaying the members affected screen as shown in FIG. 55, the member summary report as shown in FIG. 56, the diagnosis codes view as shown in FIG. 57, the procedure codes view as shown in FIG. 58, the benefits code view as shown in FIG. 59, and/or additional reports that may be generated with the filtered subgroup as shown in FIG. 60.

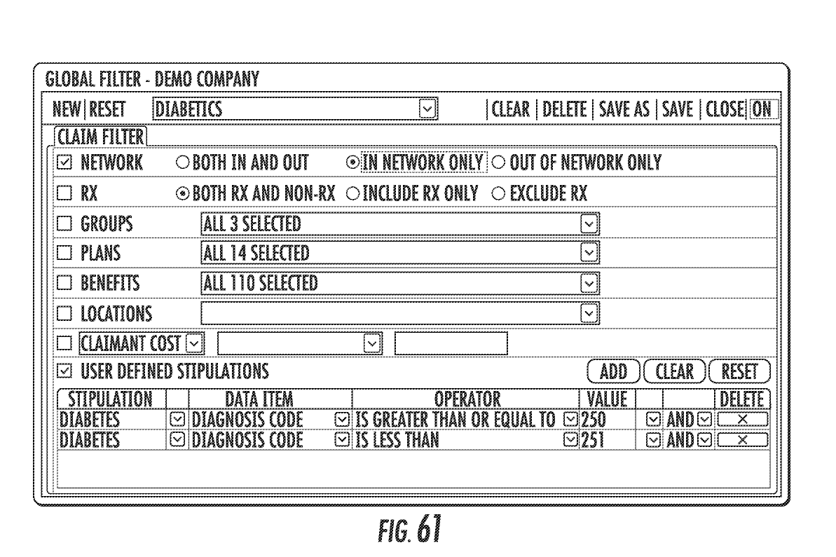

FIG. 61 is again showing the filter menu. In this case, two types of distinct filters are being applied. One type of filter, the diabetics filter is creating a unique subpopulation that includes only diabetics. Each member of the population is either a diabetic or is not a diabetic. Thus, the subpopulation of diabetics is unique. In addition, the filter has been set to choose only in network claims. This is a claim specific filter and does not create a unique set of members. Thus, two or more different types of filters may be applied to the overall health care data set to provide further detailed analysis.

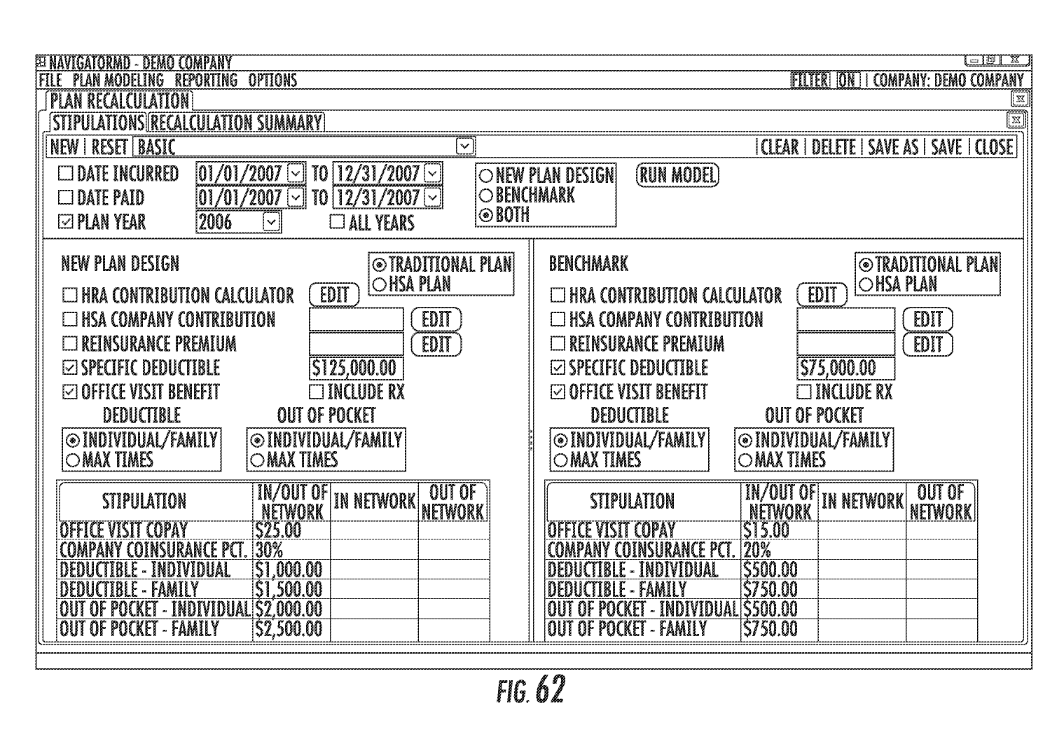

Returning to the plan designer interface shown in FIG. 62, the new plan design and the benchmark plan are prepared for analysis of the filtered data that was illustrated in FIG. 61.

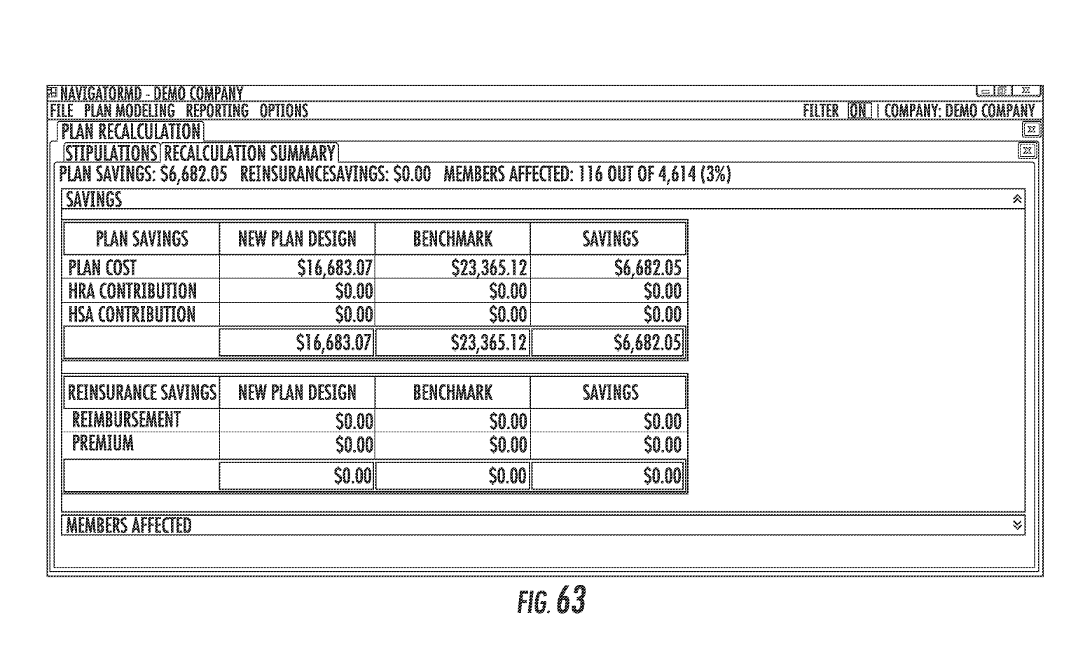

In FIG. 63, the output of the recalculation is shown and a plan savings among the diabetics in the network only is only $6,682.00 and the reinsurance has not been affected. Only 116 members are affected by this change, but it is recalled that this analysis only applies to in network claims.

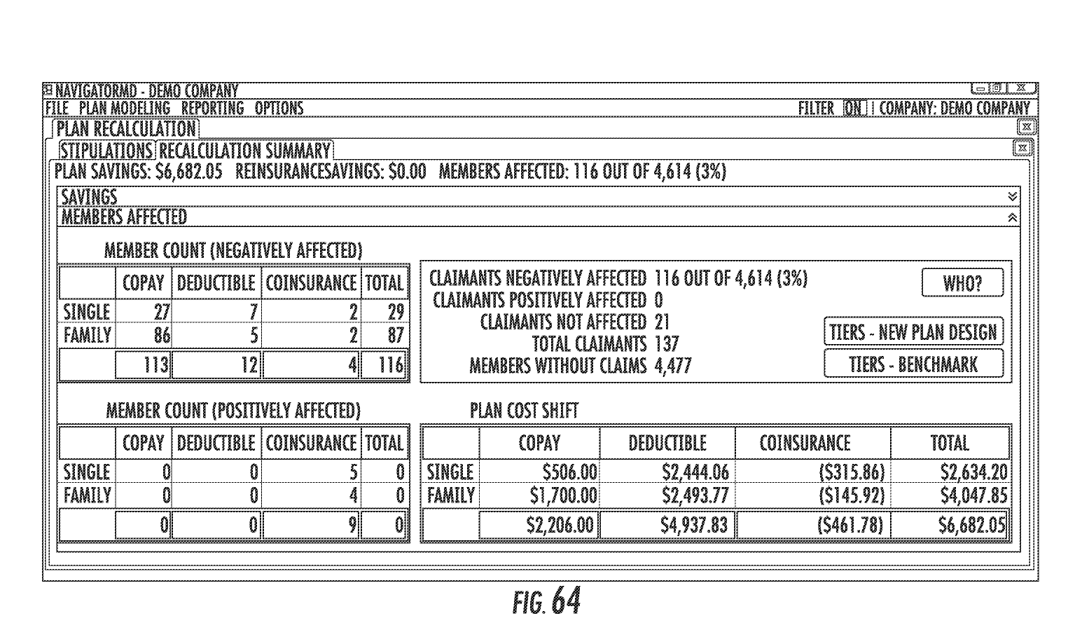

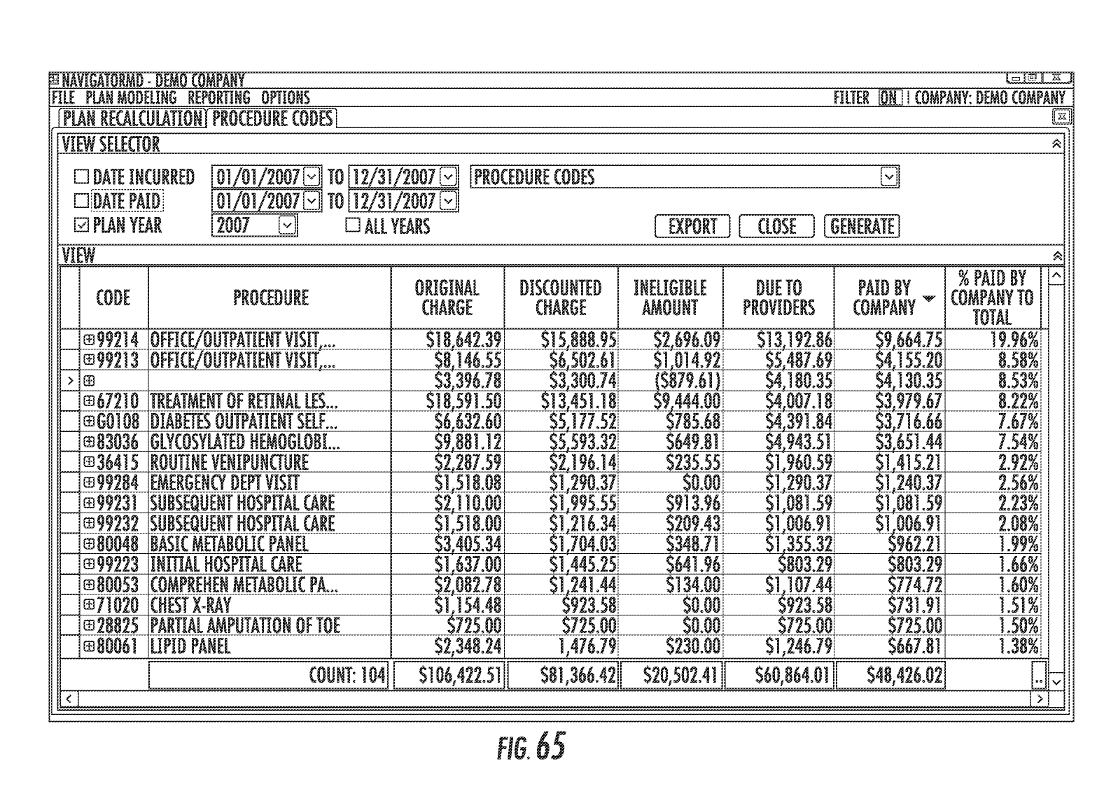

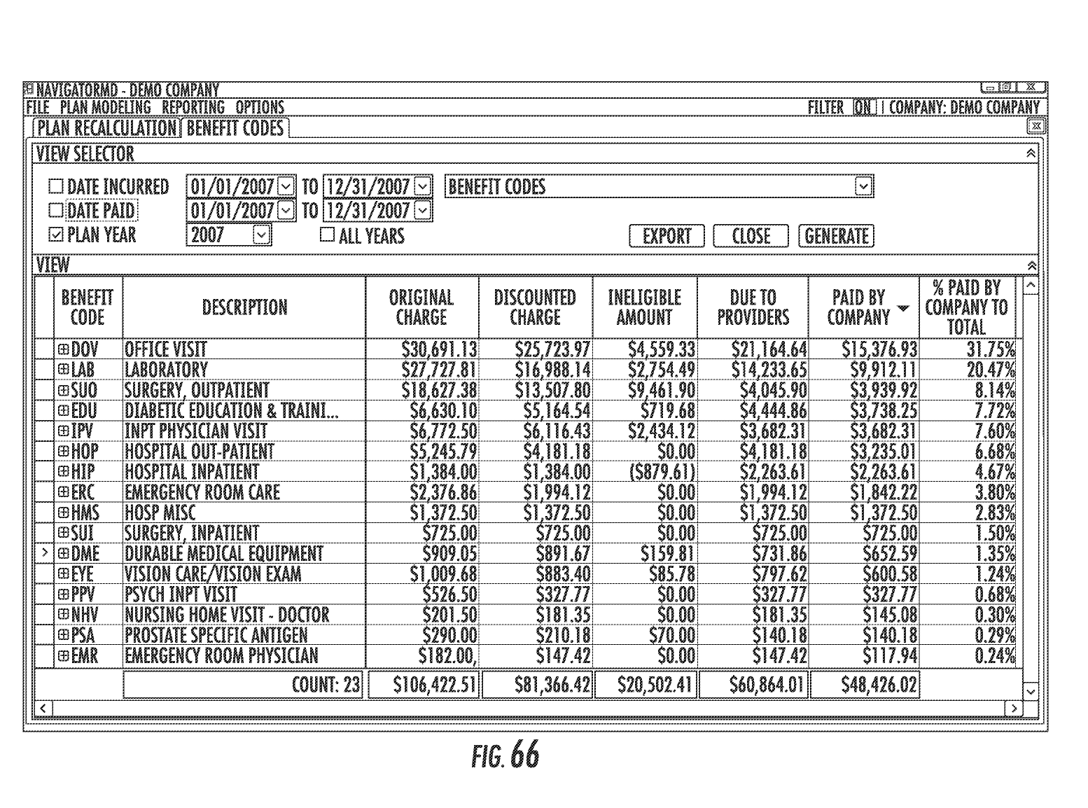

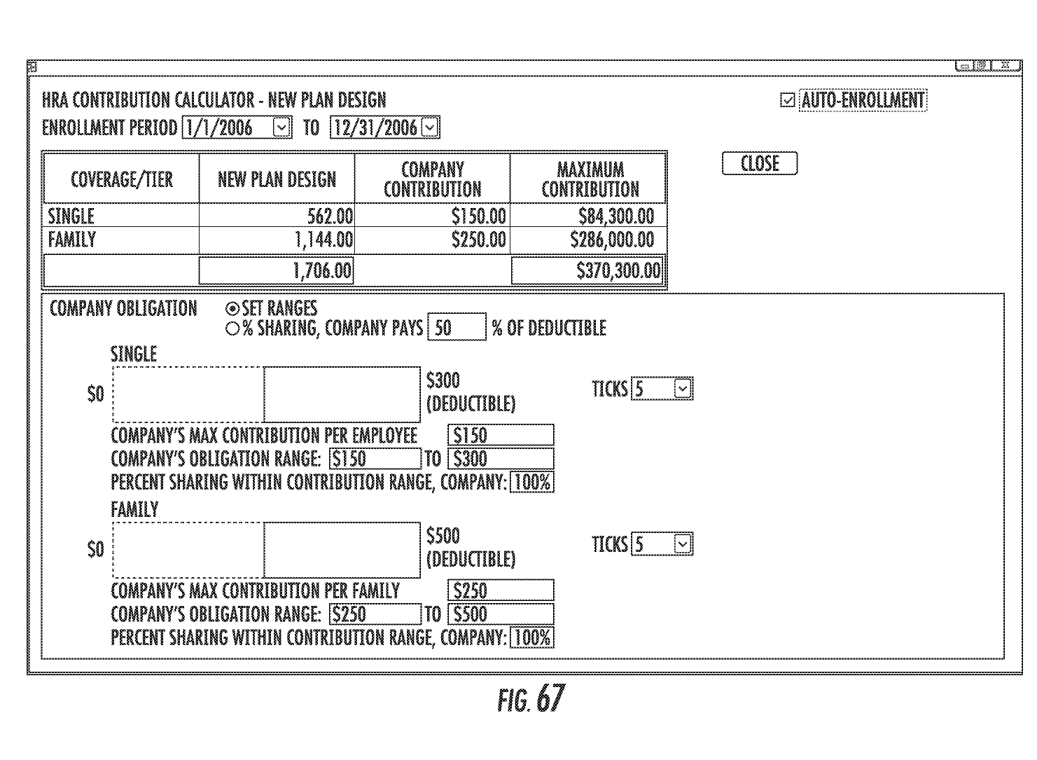

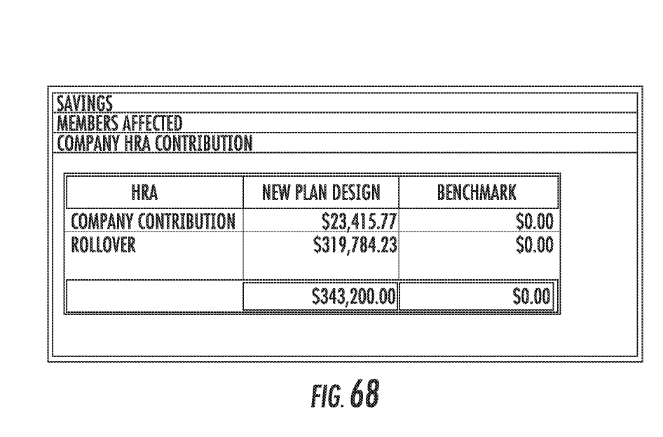

FIG. 64 illustrates a further analysis of the members affected and such analysis is available from the plan designer 120 via the data analyzer 118, as previously discussed. The procedure codes view may be illustrated as in FIG. 65, and the benefits codes view may be illustrated as in FIG. 66. FIG. 67 illustrates that the plan designer may also apply an HRA (Health Reimbursement Account) calculator to the subpopulation and when the plan is recalculated with the run model button, FIG. 68 illustrates that the results are added to the recalculation summary.

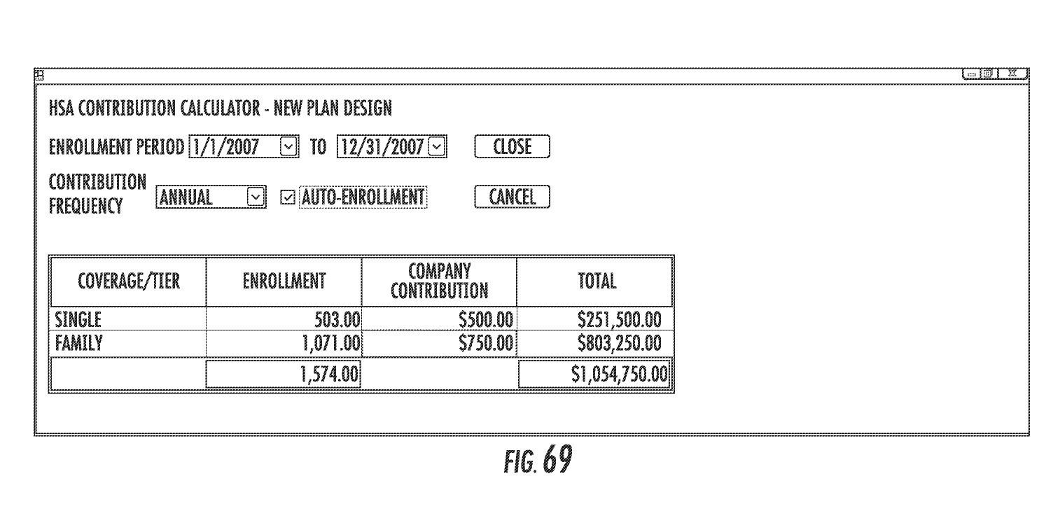

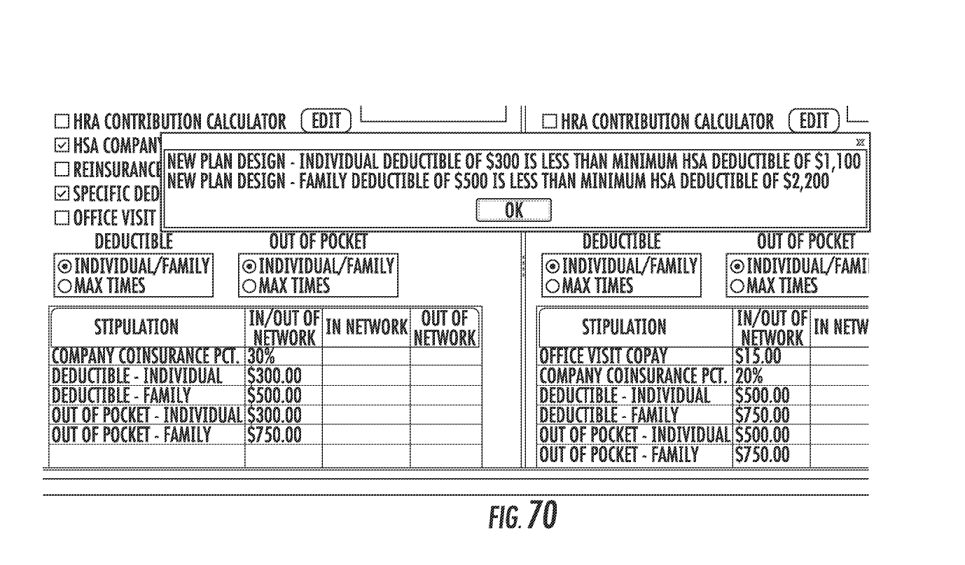

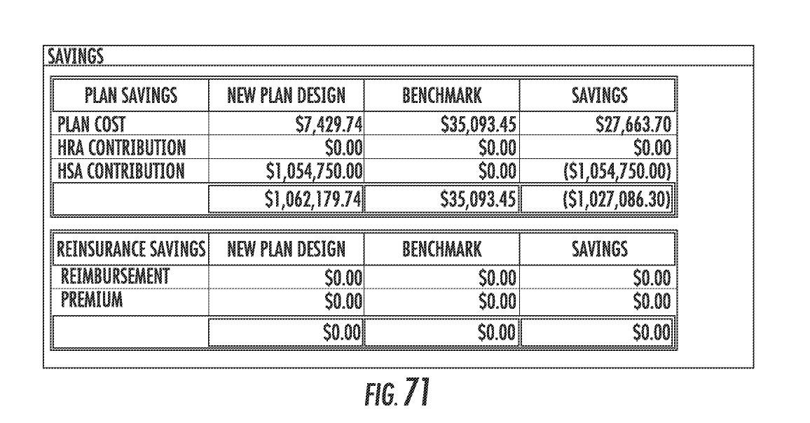

Likewise, as illustrated by FIG. 69, an HSA (Health Savings Account) contribution calculator may be accessed and used with the plan designer and as illustrated in FIG. 70, the user is warned if the plan parameters do not conform to federal HSA rules. In the plan designer, the costs for the HSA plan are automatically included in the plan recalculation summary by the data analyzer 118, as illustrated in FIG. 71. The global filters may optionally be applied to the HSA calculator and the HRA calculator in the same manner as the filter is applied to the other reporting options.

Member Filter

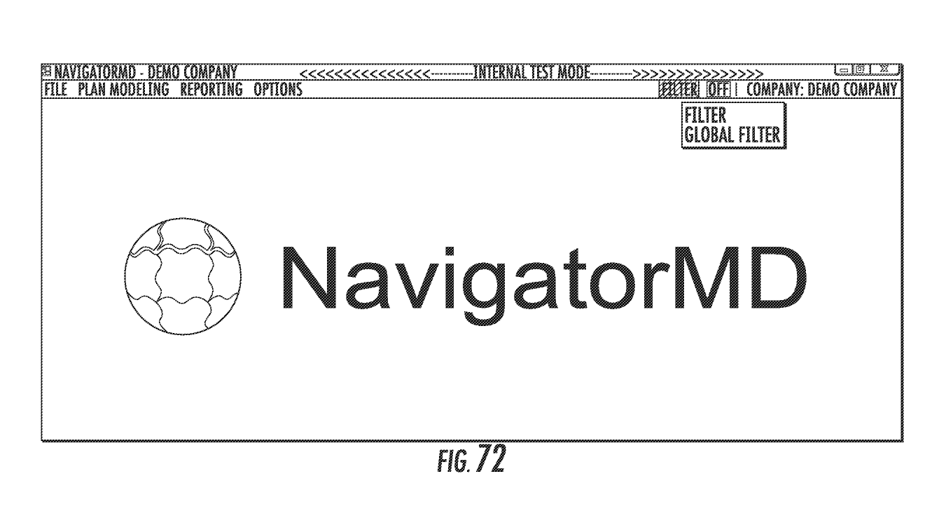

Referring now to FIG. 72 another embodiment or variation is shown in which a member filter is provided to work in combination with one or more other global filters 116 described herein. All global filters 116 are capable of operating in conjunction with the data analyzer 118 in a pure analysis role where data is analyzed in the present. The filters may also be used in a plan designer as illustrated herein.

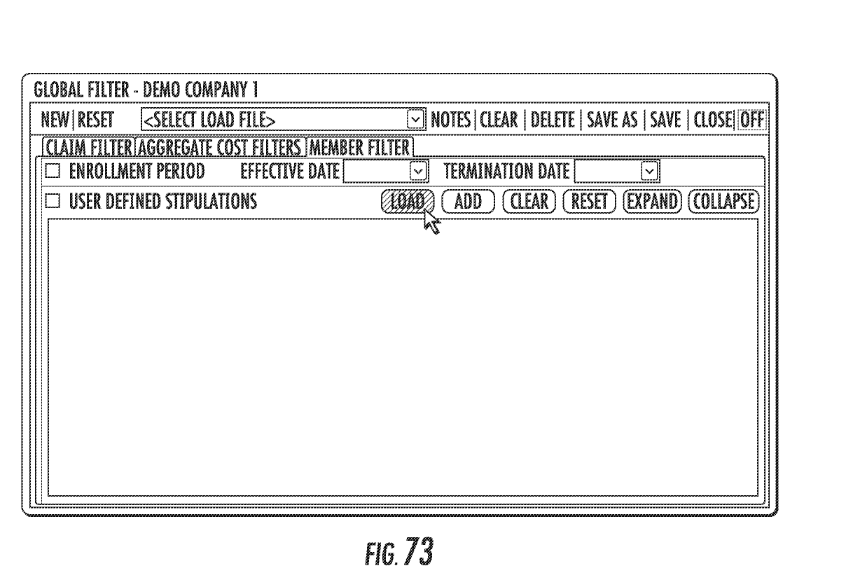

In FIG. 72 the main screen of NavigatorMD is shown with the global filter button highlighted. The desired filter may be selected by clicking on “Filter”, which calls up FIG. 73, in this example a member filter section of the global filter module 118.

When the global filter is selected, the screen of FIG. 73 gives the user a choice of a claim filter, an aggregate cost filter, or a member filter. The user may select the desired filter or filters by clicking on the tab in FIG. 73 bearing the name of the desired filter(s). FIG. 73 shows the screen after user selection of the tab labeled “member filter.”

The member filter may filter sub-populations based on user defined or pre-defined stipulations. These subpopulations accessible by the data analyzer 118, report generator 122, and health plan designer 120 components of the apparatus 100, which means that both reports and health plan designs may use the filters seamlessly. Once one or more filters have been selected and/or created, the filters may remain unchanged until the user alters the parameters or turns off the apparatus 100.

The report generator 116 may then generate one or more reports based on at least a portion of the filtered and analyzed data, and immediately before or after the generation of the report a plan design may be generated using the same filters to generate filtered plan data for analysis and reporting.

The enrollment period feature of the member filter allows the user to filter on members who were enrolled contiguously between two time periods. The Enrollment Period filter may be activated by checking the box labeled “Enrollment Period” in FIG. 73 and the user may input dates into the boxes labeled “Effective Date” (which is the date that a participant entered the health benefits program) and the box labeled “Termination Date” (which is that date that the participant left the program).

The user may also create user defined stipulations for a filter that may be activated by checking the box so labeled. This filter allows the user to select fields from member centric databases (claims, enrollment, pharmacy, biometric, etc) and test for the value of these fields using operators (for example: =, >, <, <=, >=, in, not in). These fields may be encapsulated using AND and OR statements along with parentheses for encapsulation of multiple entries within a single stipulation.

Each defined stipulation may be monitored for number of occurrences using numerical operators. These occurrences may also be monitored within a date range as defined by the user.

FIG. 73 illustrates a ‘Load’ button that, upon activation, allows the user to access member filters that are pre-defined by NavigatorMD or have been manually defined and saved on the data storage device 110 by the user.

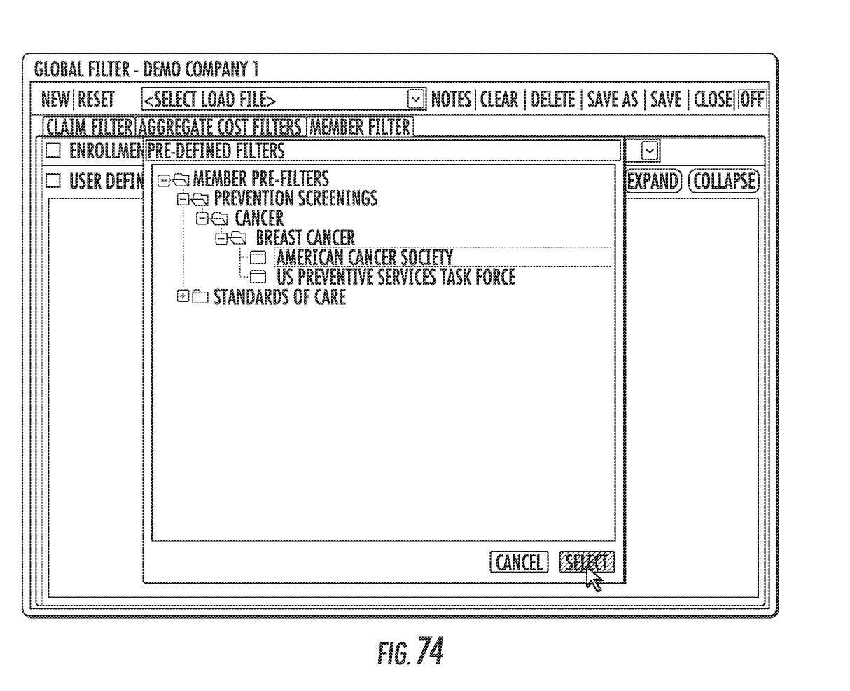

In response to activating the “Load” button, the pre-defined filters screen is illustrated in FIG. 74. Members may be filtered based on their condition, diagnosis, procedures performed on the patient, or other desired parameters. For example, in FIG. 74 a breast cancer filter is loaded from the pre-defined filters screen.

NavigatorMD's member filter contains ‘pre-defined filters’ that have been pre-programmed by NavigatorMD staff. These filters contain prevention standards and standards of care measurements and are useful to measure gaps in care. For example for a particular disease, a particular standard of care may require that the patient be screened routinely using specified medical test(s), or the standard of care may require that the patient take a certain medication. Multiple standards of care and prevention standards have been entered into the program and may be used as rules. Thus a patient's record can be compared to the standards to determine whether the patient's care is compliant with the standards. In other words, the standards may be used to see if the patient is treating himself properly and if he is receiving the proper treatment from health care professionals. Stated yet another way, a record of care for many patients may be filtered using these standards to identify patients who are and are not in compliance with the standards of care.

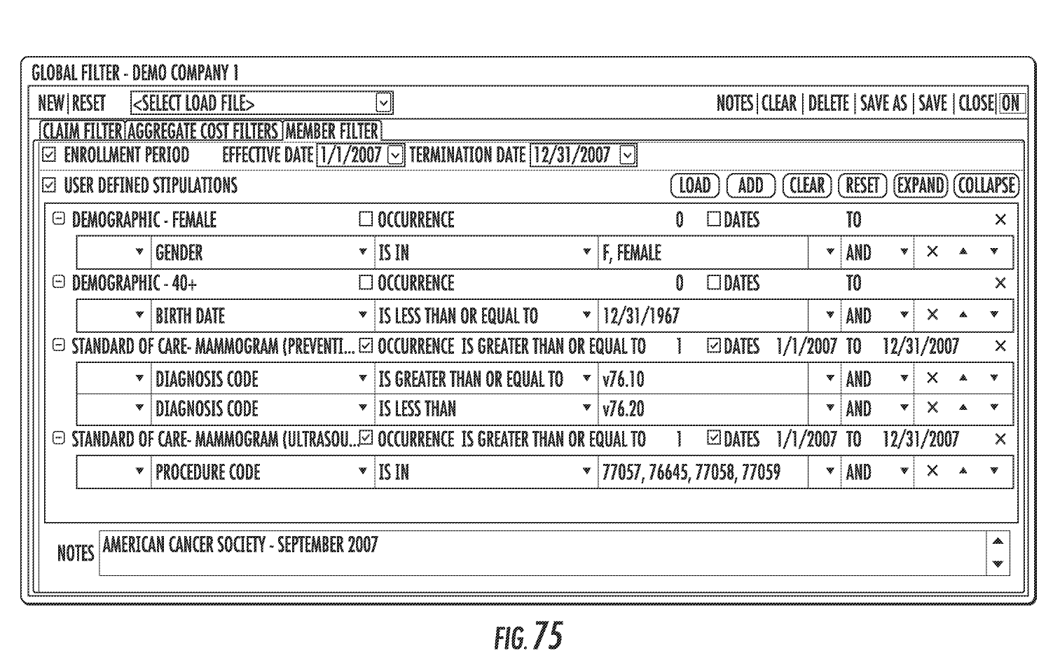

The filters may optionally be contained in a hierarchy of folders stored on the data storage device 110, and may be loaded by a user by choosing the desired pre-set filter and clicking on the ‘select’ button. This window (FIG. 74) closes after the pre-set filter is selected and the pre-defined filter is displayed, as shown in the screen of FIG. 75.

In FIG. 75 a pre-defined filter is loaded with enrollment period dates entered to determine which patients are filtered in and out. In this example, the filter is set for compliant members and looks for members who are compliant with a standard for mammograms. In this example, the filter will only show members enrolled the entire year of 2007. Four stipulations are defined:
1. Females only
2. Born before Dec. 31, 1967
3. Had at least one screening mammogram claim (must be based on AMA ICD-9 code) between Jan. 1, 2007 and Dec. 31, 2007
4. Had at least one screening mammogram claim (must be based on AMA CPT4 code) between Jan. 1, 2007 and Dec. 31, 2007

If a member meets all four criteria, they are filtered into a sub-population of members. The filter can now be closed (clicking the “Close” button) which allows the filtered data to be provided to the data analyzer 118, plan designer 120, and/or the report generator 116 for purposes of health plan design, analysis, and reporting.

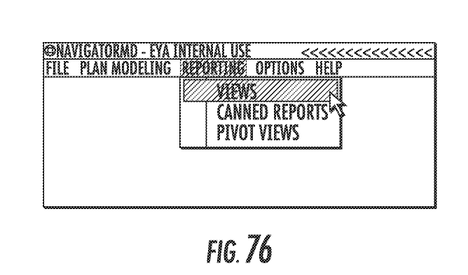

FIG. 76 illustrates navigation to a member view, which may also be regarded as a type of report.

With the activated filter from FIG. 75, the user may now access a report of the filtered results from the view section within NavigatorMD by clicking on the “Views” button in the “Reporting” drop down menu as shown in FIG. 76.

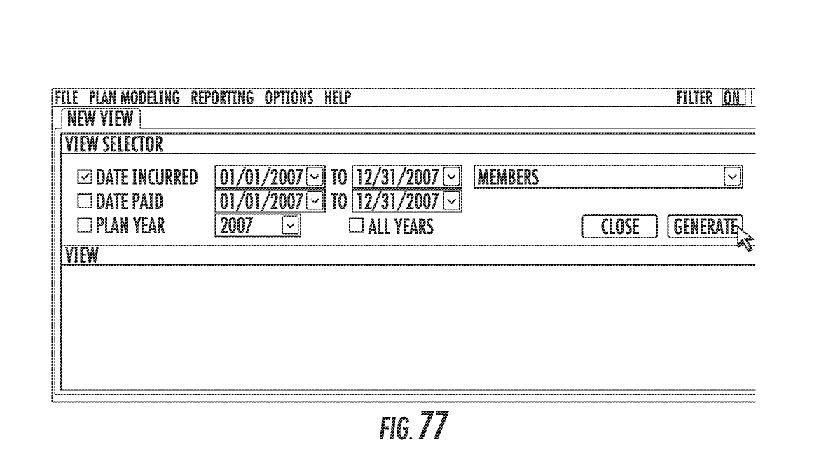

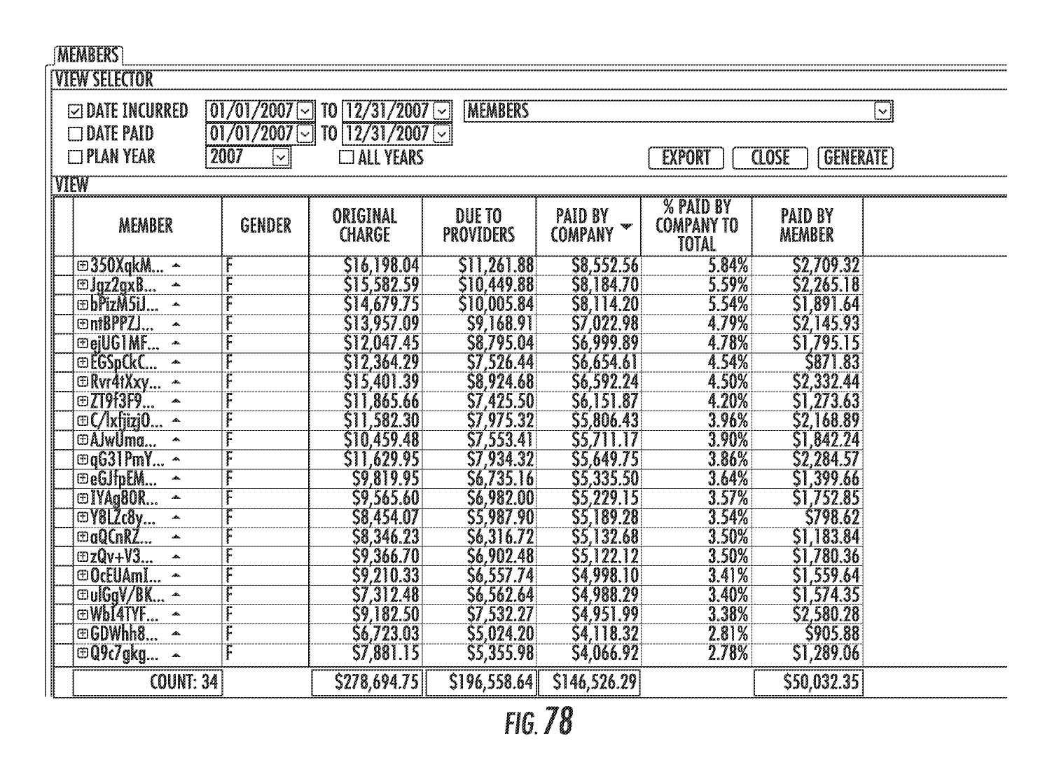

As shown in FIG. 77, a date range for a member view may be selected prior to generation of the view. Selecting “Views” in FIG. 76 brings up the window shown in FIG. 77, which is the home screen of the view section. The user has selected claims incurred in 2007 using the “Members” aggregate report which was selected using the selection box that contains “Member”. Once the criteria for the filter have been selected, the report is generated and displayed by clicking on the ‘generate’ button. FIG. 78 is thus created in this example.

FIG. 78 shows a member report indicating the compliant members based on the selected filters.

This window, FIG. 78, is a list of members with the defined claims (the claims for the members indicating compliance in mammogram screenings) incurred in 2007. The filter previously defined in FIG. 75 is currently active and provides a report on the subpopulation defined in the stipulations.

This report shows claim costs incurred for 34 females, born before Dec. 31, 2007 that had prevention mammogram screening in 2007. They also were enrolled for the entire year of 2007.

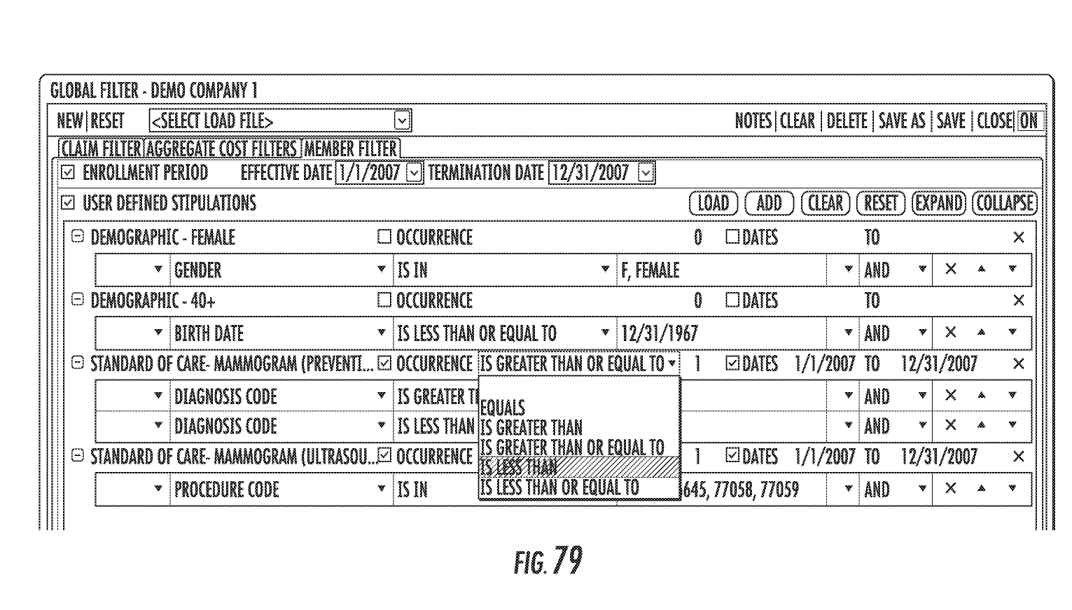

In a similar manner to that described above, the filter can be changed by the user to find non-compliant members based on the same criteria. FIG. 79 shows the user navigating back into the filter from FIG. 75 and reversing the operators to capture non-compliant health plan members manually. This operation could also be performed by selecting a predefined filter for non-compliant breast cancer patients. In this illustration, the user is changing the occurrence operator on the mammogram diagnosis code. The occurrence for mammogram screenings has been changed from “is greater than or equal to” to “is less than”. The procedure and diagnosis codes, which indicates mammograms and other standards, remains the same. Accordingly, the filter will identify health plan members that did not get the mammogram screening in the defined period of time, and may transmit the filtered data to the data analyzer 118.

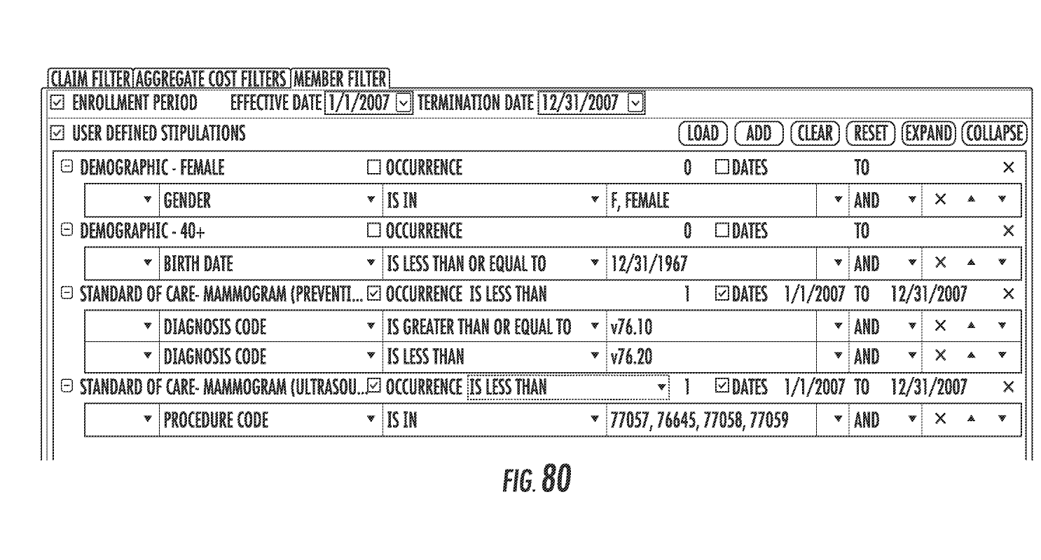

FIG. 80 shows a completed filter for members without a mammogram in the defined period with a reversal of the operators. The ‘is greater than or equal to’ 1 has been changed to ‘is less than’ 1. This FIG. 80 now shows only female members, born before Dec. 31, 1967 that did not have the specified mammogram screenings in 2007.

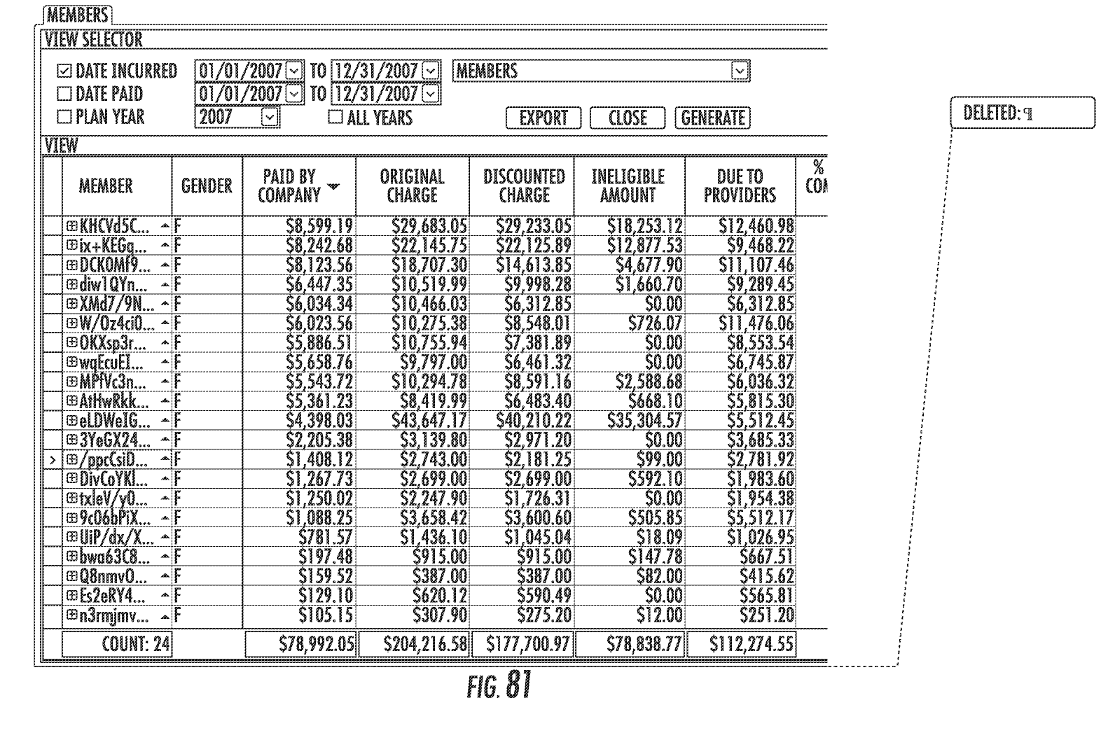

FIG. 81 shows the user going back into the views and re-generating the member view with the filter “on” that was generated manually. This is a list (with claims for the members indicating non-compliance in mammogram screenings) with claims incurred in 2007. The filter in FIG. 80 is currently active and showing the subpopulation defined in the stipulations of FIG. 80. This report shows 24 females with breast cancer, born before Dec. 31, 2007 that did not have a prevention mammogram screening in 2007. They also were enrolled for the entire year of 2007.

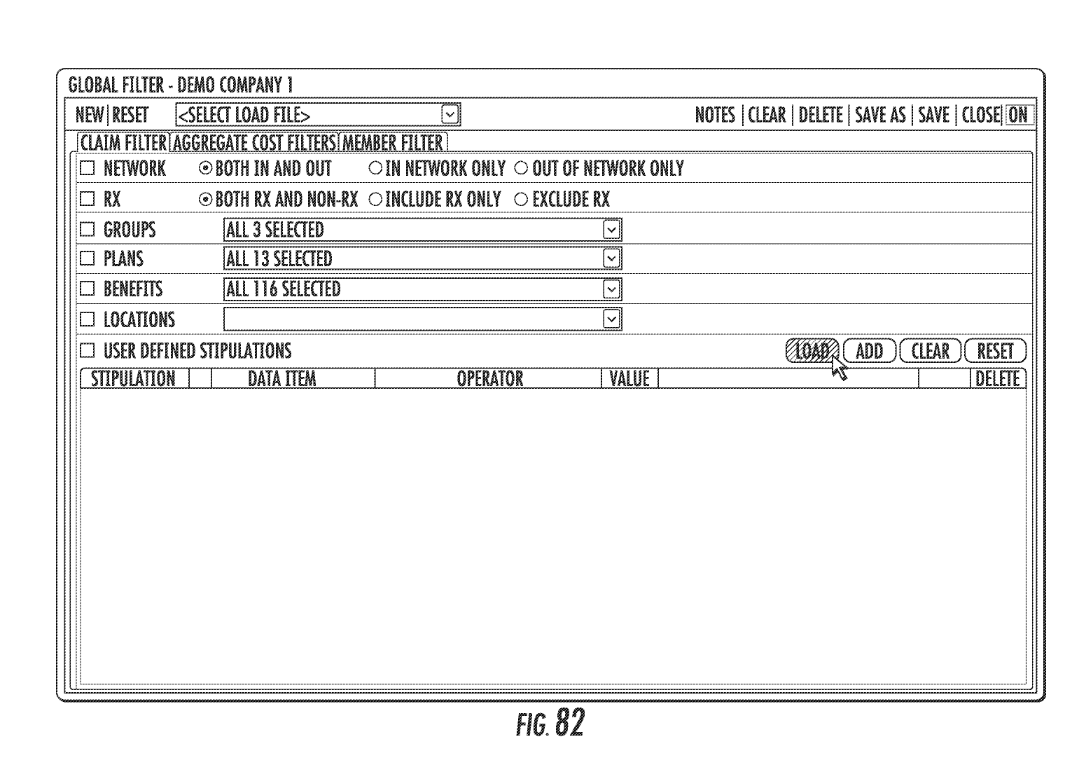

Other filters may also be turned on while a member filter is on. For example, referring to FIG. 82, the claim filter portion of the global filter 118 may be accessed by clicking on the “claim filter” tab shown in FIG. 73. This screen may allow the user to further filter individual claims from a desired member sub-population. The program includes numerous preset claim filter parameters, but as before, the user may also manually set the claim filter parameters.

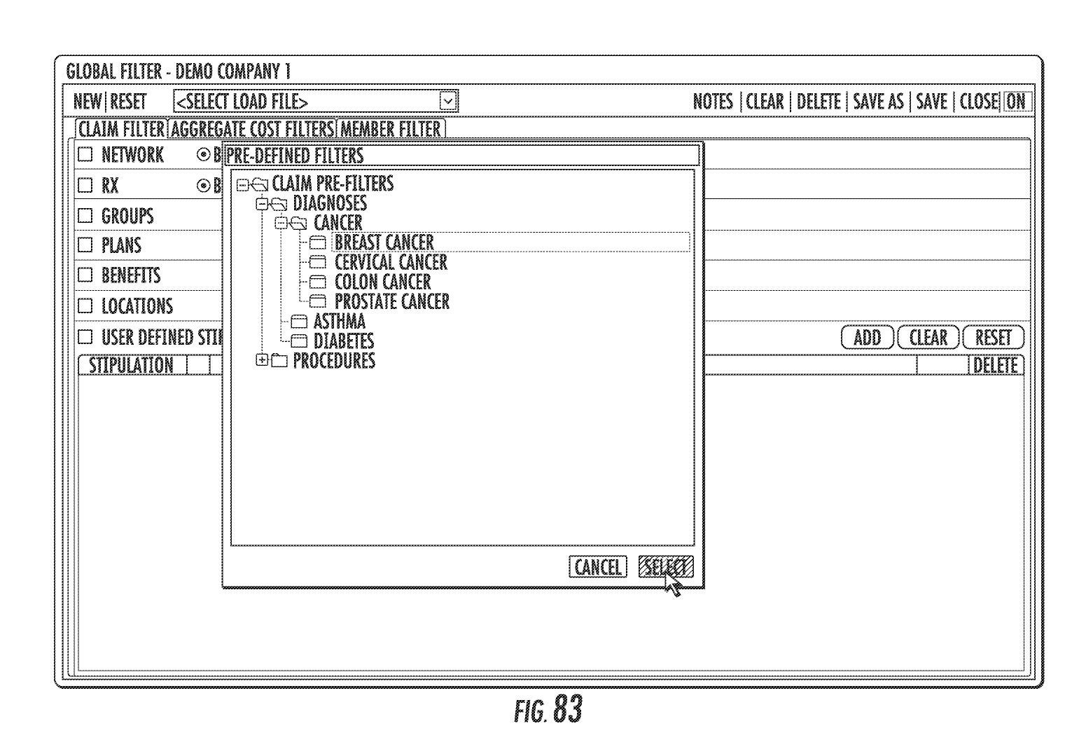

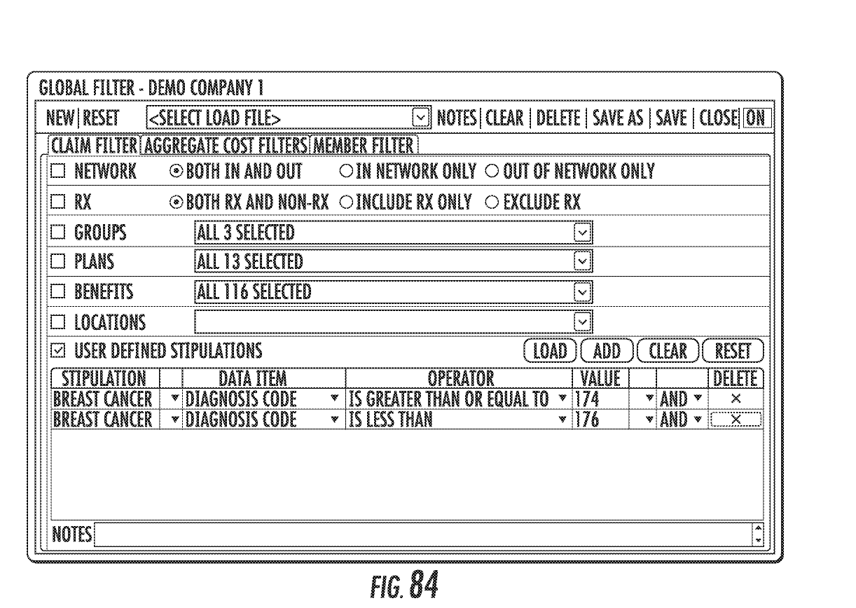

Once the claim filter parameters are set, the user can click ‘Load’ to load pre-set claim filters designed by NavigatorMD, which causes a list of pre-defined filters to pop up as shown in FIG. 83. The pop-up screen labeled “pre-defined filters” in FIG. 83 is an example of some of the pre-set claim filters within NavigatorMD. The user has selected breast cancer claims and clicking on the ‘Select’ button will load the pre-set claim filter, which generates the screen shown in FIG. 84.

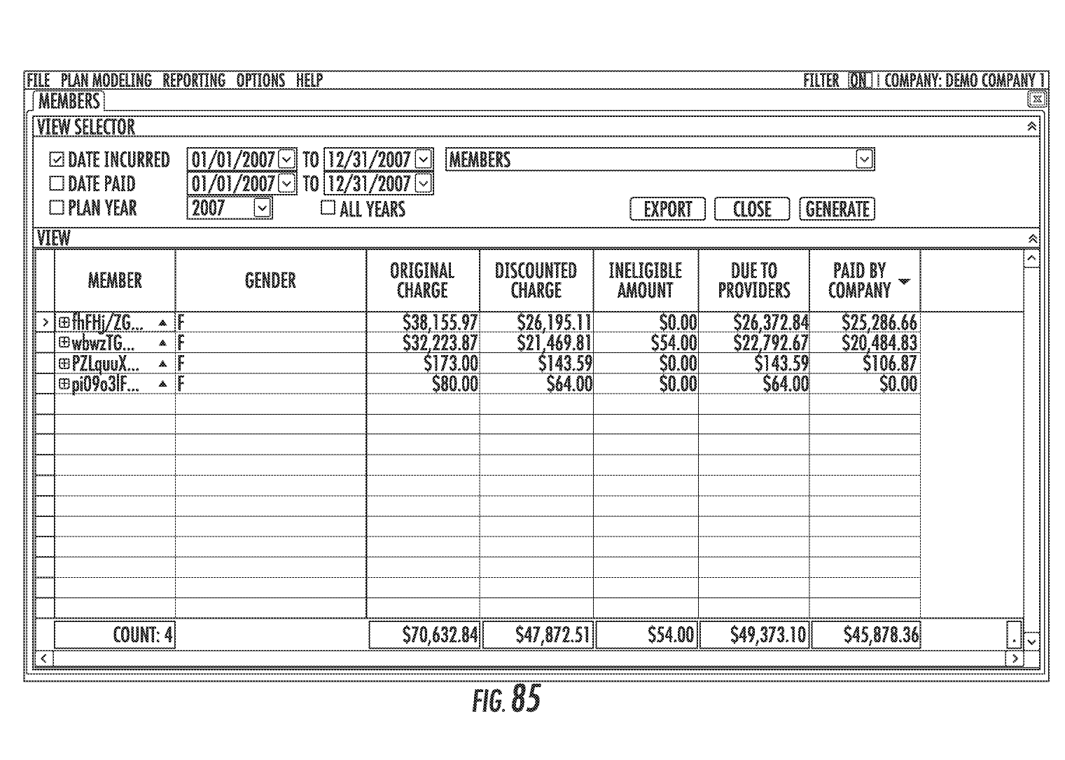

The claim filter shown in FIG. 84 has breast cancer claims loaded. The member filter in FIG. 75 is loaded as well only passing through compliant females over age 40. To advance from screen 84, the user activates the “Close” button which generates a report showing the claim and member filters running in synchronization (simultaneously), as shown in FIG. 85. With the member filter and claim filters loaded with the stipulations defined in FIG. 75 and FIG. 84, the desired member report (FIG. 85) for 2007 is showing:

Breast cancer-related claims AND:
1. Females only
2. Born before Dec. 31, 1967
3. Had at least one screening mammogram claim (based on AMA ICD-9 code) between Jan. 1, 2007 and Dec. 31, 2007
4. Had at least one screening mammogram claim (based on AMA CPT4 code) between Jan. 1, 2007 and Dec. 31, 2007

These are mammogram-compliant breast cancer patients limited to those have the correct member and claim parameters.

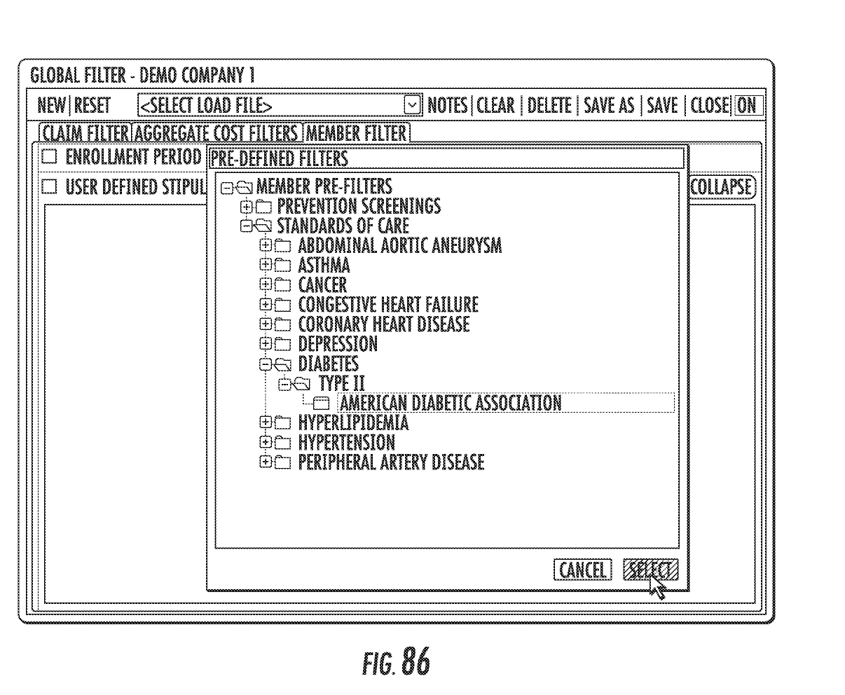

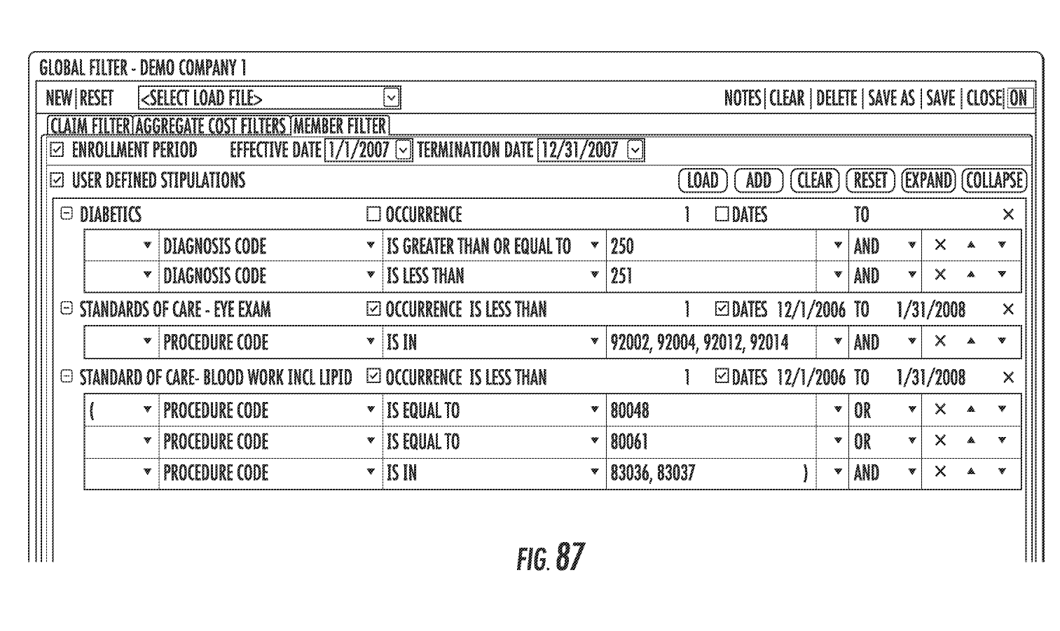

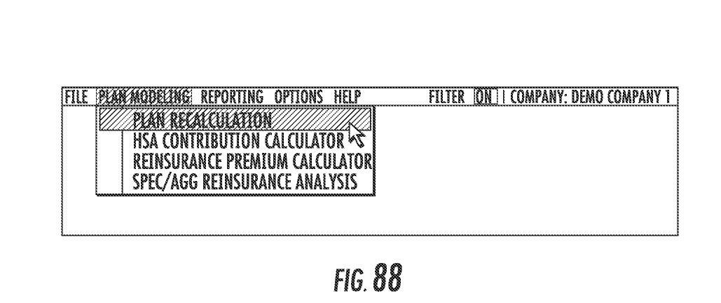

FIG. 86 is a further illustration of filter operation and in this case shows a diabetic pre-filter selection. By selecting “Close” in FIG. 85, the user may return to the screen shown in FIGS. 73 and 88. In FIG. 88, the user has selected the member filter tab and is set to select a pre-loaded member filter. This is the member filter pre-load screen for standards of care. The American Diabetic Association Type II Diabetes standard of care is also selected. The pre-defined filter may be selected by clicking on “American Diabetic Association” once and then clicking “select” or by double clicking on “American Diabetic Association, which will cause the screen of FIG. 87 to appear.

FIG. 87 shows the diabetic standard of care filter loaded and adjusted for non-compliant members for plan design incentives. The user may now design a health plan around the specified subpopulation group, namely, non-compliant members who have been diagnosed as diabetic. This example is not necessarily a practical example but it does show the flexibility and versatility of using these multiple types of filters to generate reports on populations and to also see the consequences of plan changes on a particular population of members. Once the user has verified the parameters of the filter using the screen of FIG. 87, this screen may be closed and the user may navigate back to the home screen shown in FIG. 88 for accessing the plan designer 120 via the design menu 206b.

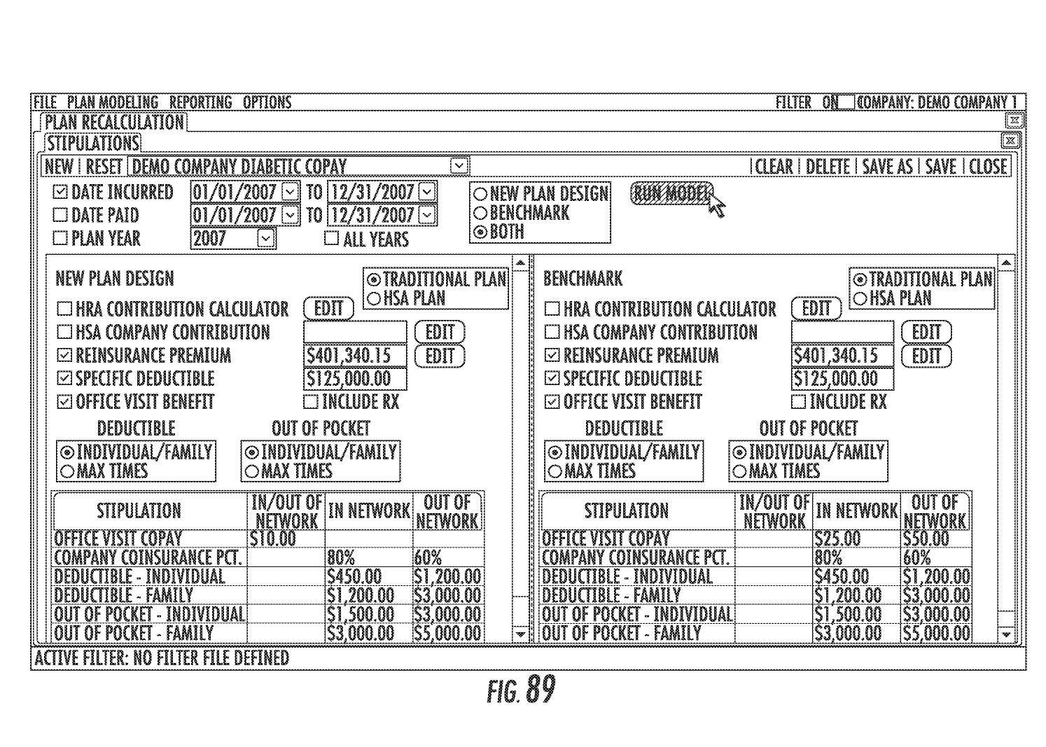

FIG. 88 shows the user selecting the “Plan Recalculation” button of the plan designer with the diabetic filterer activated (on). Note that the word “on” appears beside the word “filter” in the top band of the window in FIG. 88. When the “Plan Recalculation” button is clicked, the screen of FIG. 89 appears showing a plan design screen with non-compliant diabetic population filter.

Thus FIG. 89 illustrates NavigatorMD's plan recalculation tool using the filters. The benchmark is displayed in the lower left box and it shows the plan design in 2007 and the New Plan Design in the lower right box shows the new plan created by the user for the non-compliant diabetics as defined in FIG. 87. Notice the office visit co-pay shown in the first line of the lower left white box is adjusted to $10.00 to encourage doctor supervision in the new plan. The co-pay was previously $25.00 under the benchmark plan as indicated on the first line of the white box in the lower right portion of the screen shot of FIG. 89.

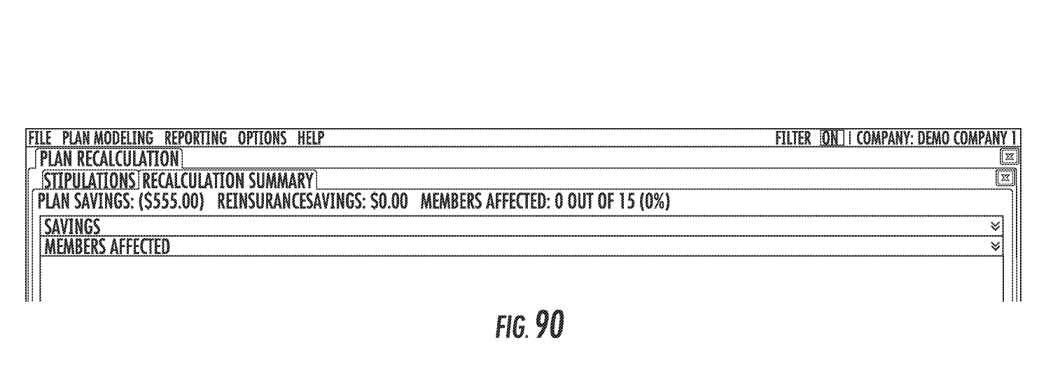

FIG. 90 shows the results after the run model button has been activated by the user. In this example, the program projects the plan costs for reducing the co-pay for the compliant diabetics to be $555. Again, this is a simple and unrealistic example, but it does show the range of options available to a user.

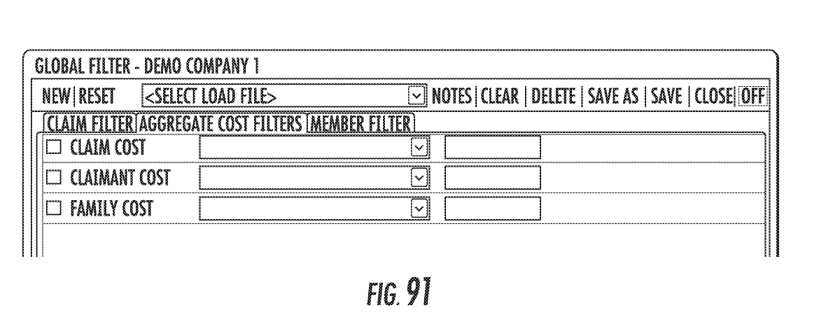

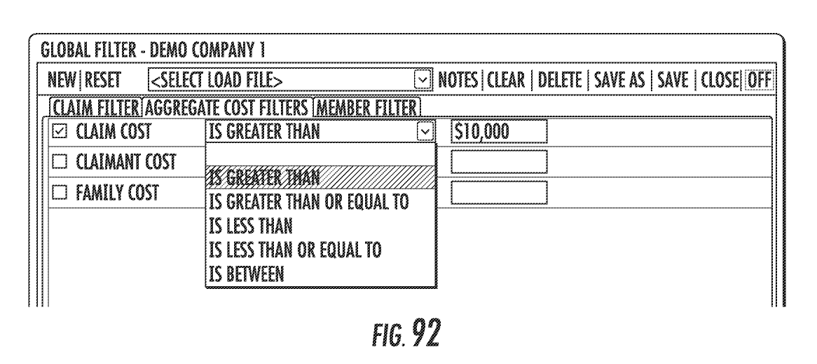

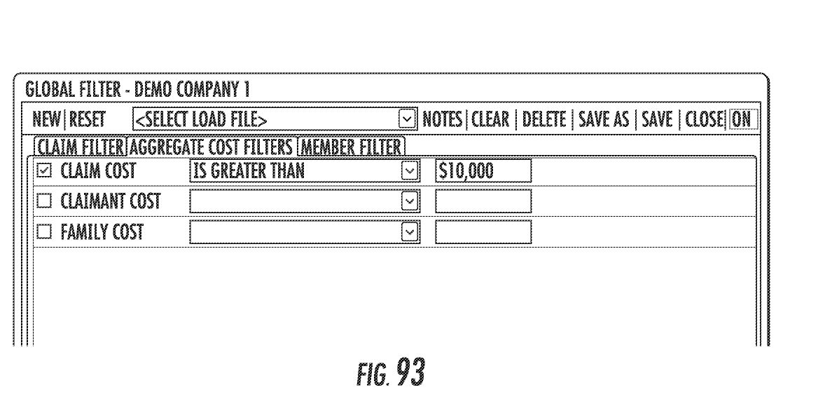

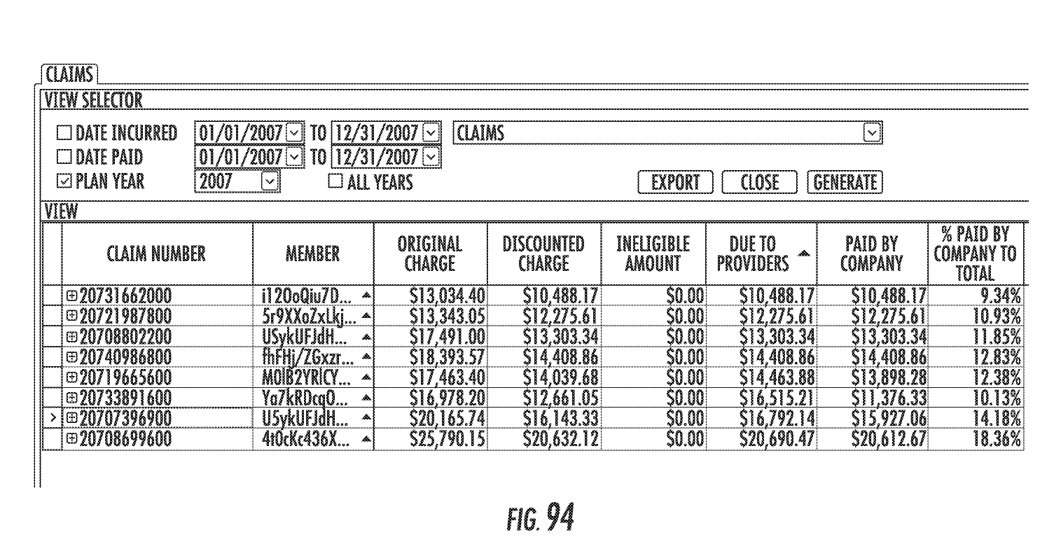

It will be appreciated that the claims filters and the member filters can be operated simultaneously with other filters as well, such as aggregate filters. FIGS. 91 through 97 briefly illustrate the operation of the member filter in cooperation with an aggregate cost filter. In FIG. 91 the aggregate filter screen is shown with aggregate filter options available for selection by the user. In the next screen the claim cost aggregate cost filter is activated with drop down operators as listed in FIG. 92. The member filter has already been set as desired. The claim cost aggregate cost filter activated in FIG. 93 requires an aggregate claim to be greater than $10,000. Thus, the claims report shown in FIG. 94 presents all claims greater than $10,000 for the defined member population.

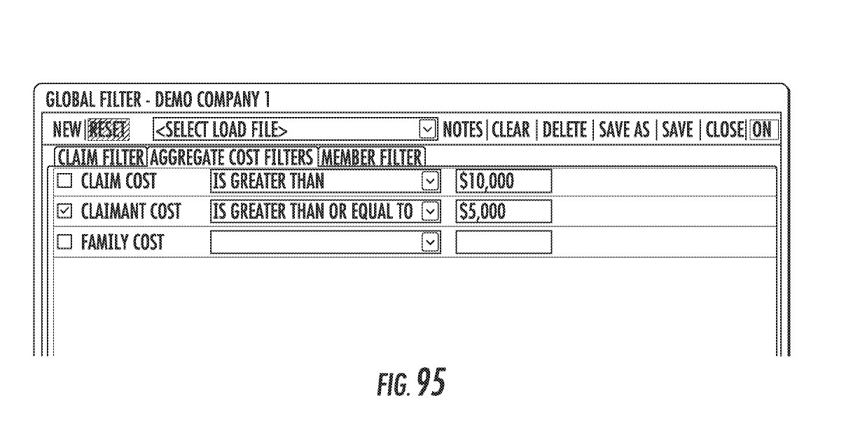

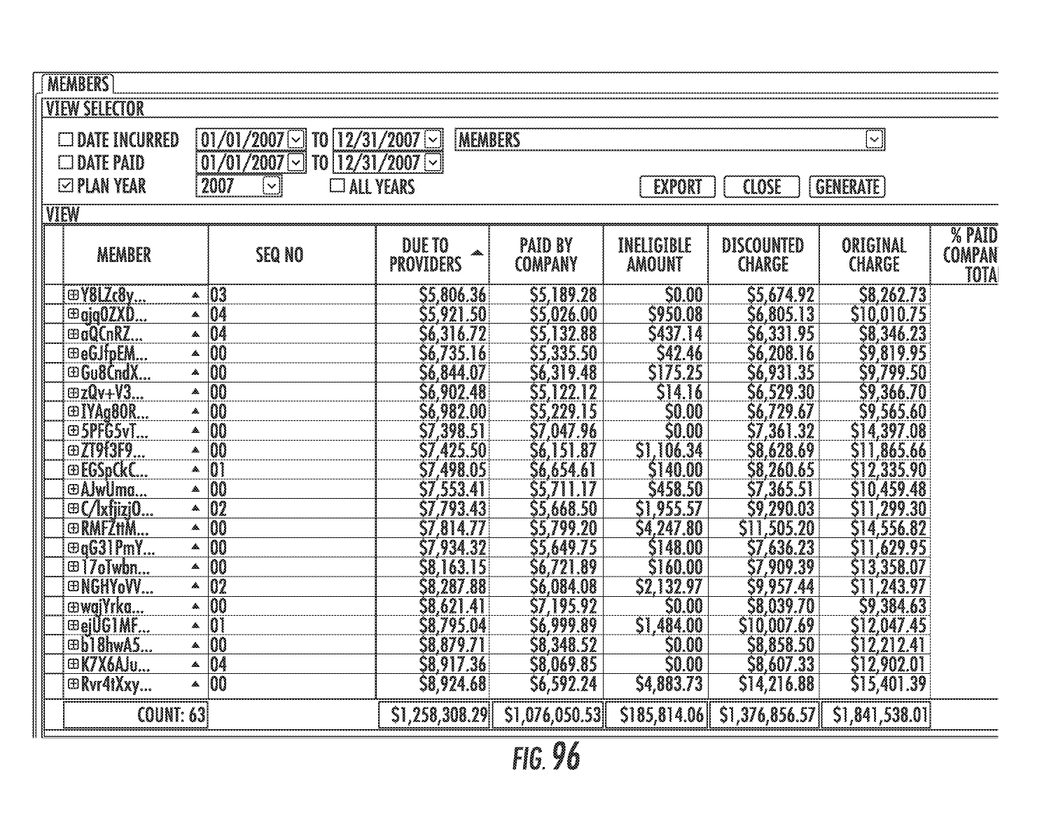

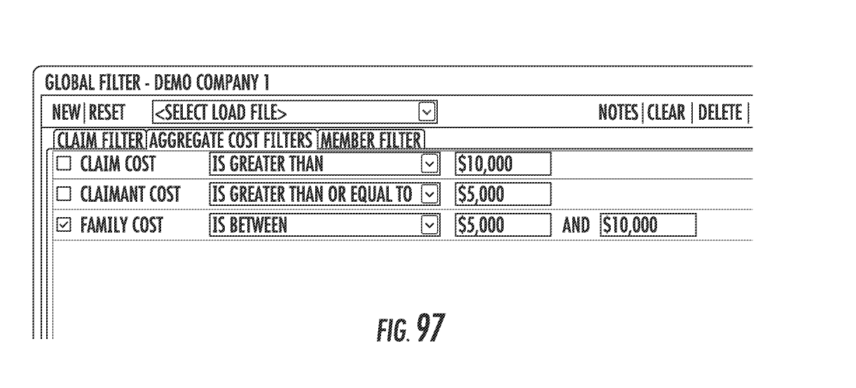

Returning to the main screen for filter selection, FIG. 95 illustrates an example where the claimant cost aggregate cost filter is activated to require the aggregate claimant cost to be equal to or greater than $5000. Thus, the report generated from such filter as shown in FIG. 96 presents situations where claimant's cost is equal to or over $5,000, again, for a defined population of members as set using the member filter. Another aggregate cost filter, the family cost aggregate cost filter is activated in FIG. 97 and illustrates yet another aggregate filter that can be used alone or in combination with member filters and claim filters.

Having described a preferred embodiment, it will be understood that this embodiment is an example and is not intended to limit the scope of the invention. This invention is capable of numerous changes, variations and functional differences without departing from the spirit of the invention.

As a further example of the present disclosure, a computer readable and executable example of the present program modules is submitted on CD-ROM herewith, and incorporated by reference herein.

The foregoing embodiments are susceptible to considerable variation in practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part hereof under the doctrine of equivalents.

What is claimed is:

1. An apparatus for analyzing digital health care data and designing and testing health care plans and generating reports based on the digital health care data, comprising:
a digital data processor comprising at least one processor, at least one display device, at least one input device, at least one data storage device, and computer memory;
digital data stored on a computer readable media, the data being accessed by the data storage device and transmitted between the data processor and the data storage device, wherein the data comprises:
at least one health care data set comprising a member population and including at least patient identification information and corresponding health care diagnoses, health care services for each patient, payments by the plan for health care services for each patient and payments by each patient for health care services,
one or more health care plans each health care plan having operating parameters including at least (1) coverage definitions defining conditions that are covered by the health care plan, (2) benefits definitions defining treatments that are provided under the health care plan, and (3) co-pay and deductible amounts, if any, defining payments that must be made by the person covered by a health care plan,
an input device for receiving user input;
a global filter implemented in the data processor for filtering the health care data set in response to a filter-on command, said filtering being based on filtering stipulations input by a user via the input device to produce a data sub-set that includes at least a portion of the health care data set, which may comprise a health care data subset;
a healthcare data analyzer integrated with the global filter and implemented in the data processor for transmitting data to and communicating with at least one global filter and a report generator for generating reports in response to a report command, the reports being based on the data-set and providing information as to the health care received by the entire population covered by the health care plan including cost information, and for generating reports based on at least a portion of the data set, the reports thereby providing information as to the health care provided to a sub-set of the member population including cost information;
a health plan designer integrated with the global filter and implemented in the data processor, the plan designer being responsive to user inputs to produce hypothetical health care plan data provided by a hypothetical company, the hypothetical health care plan data having at least coverage definitions, co-pay amounts and deductible definitions, the plan designer being operable:
to transmit the hypothetical health care plan data to the health care data analyzer, wherein the analyzer may optionally apply one or more filters and the analyzer may further transmit the health care plan data to the report generator, wherein the report generator generates a report based on the filtered and analyzed data, wherein the report indicates the health care services that would have been covered in the entire population by the hypothetical health care plan and the cost of health care services to the patients and the hypothetical company; and
to transmit the health care plan data to the health care data analyzer, wherein the health care data analyzer analyzes a sub-set of the member population provided by the global filter, and transmits the analyzed data to the report generator, wherein the report generator generates a report based on the data sub-set, and wherein the report indicates health care services that would have been covered within the data subset and an estimated cost of health care service to the patients and to the hypothetical company.

2. The apparatus of claim 1, wherein the global filter is selected from the group consisting of a global filter module configured to operate on the data and generate a subset of data corresponding to a unique sub-population of the population, a global filter module configured to operate on the data to generate a subset corresponding to a unique subset of claims, but not necessarily corresponding to a unique sub-population of the population, and combinations thereof.

3. The apparatus of claim 1, further comprising a calculator implemented in the data processor, wherein the calculator is selected from the group consisting of an HSA calculator, an HRA calculator, and combinations thereof, and wherein the global filter module is selectively applied by the user to the HSA or the HRA calculator.

4. The apparatus of claim 1, wherein the global filter further comprises a member filter, wherein the member filter filters a subset of data corresponding to a sub-population based on one or more commands input by a user.

5. The apparatus of claim 1, wherein the user input received through the input device comprises filtering stipulations, filtering parameters, plan modification commands, filtering commands, report commands, and activation commands.
